(19) United States
(12) Patent Application Publication
(10) Pub. No.: US 2013/0317965 A1
(43) Pub. Date: Nov. 28, 2013

(54) NEGOTIATION BLUEPRINT PREPARATION SYSTEM AND METHOD

(71) Applicants: Brian Dietmeyer, Chicago, IL (US); David Knopfler, Grandy, NC (US); Zahir Palanpur, Smryna, GA (US)

(72) Inventors: Brian Dietmeyer, Chicago, IL (US); David Knopfler, Grandy, NC (US); Zahir Palanpur, Smryna, GA (US)

(21) Appl. No.: 13/888,342

(22) Filed: May 6, 2013

Related U.S. Application Data
(60) Provisional application No. 61/643,365, filed on May 7, 2012.

(51) Int. Cl. G06Q 50/18; G06Q 40/04

(52) U.S. Cl. CPC G06Q 50/188; G06Q 40/04
USPC 705/37

(57) ABSTRACT

The present invention is directed to a computer-implemented system and method for constructing a negotiation blueprint for a business negotiation. The system and method is designed to facilitate the organized and consistent execution of the process by a single individual or team of individuals working on the negotiation. The method can be organized into two phases: analysis; and execution. The analysis consists of a structured review of the situation surrounding the negotiation from the perspective of each party or counterpart while the execution provides negotiators a structured means of presenting alternatives to the counterpart. The system is preferably a computer based program available over a network that facilitates the execution of the business method by presenting data related to typical negotiations of the type the user is executing.

### CROSS REFERENCE TO RELATED APPLICATIONS

This application claims priority to U.S. Provisional Application Ser. No. 61/643,365 filed on May 7, 2012.

### TECHNICAL FIELD OF THE INVENTION

This invention relates generally to a system and method for constructing a negotiation blueprint for a negotiation. The system and method preferably utilizes a computer system and network to facilitate its use by sales or buying professionals.

### BACKGROUND OF THE INVENTION

Negotiation may be described as a dialogue between two or more people or parties intending to produce an agreement upon courses of action, often involving bargaining for an individual or collective advantage by the end of the dialogue. Negotiation processes commonly occurs within business, non-profit organizations, government branches, legal proceedings, among nations and in personal situations such as marriage, divorce, parenting, and everyday life.

The occurrence of negotiation between businesses, i.e., “business-to-business” or “B2B,” often relates to the sales and purchase of goods and services between such businesses. For example, an automobile manufacturer may negotiate with a seller or supplier for the purchase of tires, windscreens, rubber hoses, and numerous other components for its vehicles. The advantage often sought by the seller during any such negotiation is a lack of price concessions over prices paid for the components subject to the underlying purchase.

Unfortunately, although negotiation processes have long been present in the business world, these processes have also long been considered to be “random” or “unpredictable” events. Such random or unpredictable negotiation processes often involve long lists of tactics, tricks, countermeasures, memorized scripts, interpretation of body language, recognition of bluffing techniques and other random methods—all seeking to gain some type of advantage or concession during negotiations.

However, disadvantages exist in that the aforementioned “random” negotiation methods cannot be scaled to large sales or buying forces, nor standardized to apply to varied business objectives. From a sales point of view, these disadvantages are amplified by recent economic events that have occurred both in the U.S and throughout the world. Rising gasoline prices, failings of financial systems, governmental tax increases and numerous other factors have resulted in an expectation and demand by B2B buyers of across-the-board price decreases for the goods or services that they purchase in an effort to remain competitive in an uncertain economy.

As a result, sales professionals are seeing an increase in the presence of “professional buyers,” such as procurement officers and senior sourcing executives, during sales negotiations. Sales professionals are also experiencing an increased price focus during such negotiations, along with added commoditization pressure (i.e., an assumption that everything being sold is essentially the same) in support of the increased price focus.

In response to the aforementioned price and commoditization pressures, sales professionals are also seeing an increase in irrational competitive behavior, such as sales competitors drastically lowering prices and/or giving away services. Thus, the utilization of a random or unpredictable negotiation strategy drives irrational market behaviors and sparks pricing and giveaway wars, ultimately lowering margins for everyone.

Furthermore, additional disadvantages exist due to the lack of availability to sales and buying professionals of computer-implemented and internet-available, analytical tools used to systemize and maximize negotiation strategy beyond that of the aforementioned “unpredictable” or “random” strategies. Such disadvantages include: a lack of the ready availability of any systemized negotiation preparation for sales or buying professionals located in various geographic regions; a lack of a database facilitating the standardization and classification of various types of negotiation information; and a lack of a transformation of the various types of negotiation information into a cogent, negotiation strategy.

Thus, what is needed is a systemized negotiation preparation procedure to replace the random or unpredictable events that commonly occur during business negotiation. The systemized negotiation preparation procedure should be computer-implemented and internet available to facilitate its ready availability to numerous professionals in varied geographical regions, to facilitate the standardization and classification of various types of negotiation information, and to transform such information into a cogent negotiation strategy. The present invention thus provides these and additional advantages.

### SUMMARY OF THE INVENTION

The present invention is directed to a computer-implemented system and method for constructing a negotiation blueprint for a business negotiation. The system and method is designed to facilitate the organized and consistent execution of the process by a single individual or team of individuals working on the negotiation.

The method can be organized into two phases: analysis; and execution. The analysis consists of a structured review of the situation surrounding the negotiation from the perspective of each party or counterpart (i.e., buyer or seller), the understanding in detail of the implications on each party failing to reach agreement, and the critical terms of the agreement if it is reached. The execution phase provides negotiators a structured means of presenting alternatives to the counterpart of the negotiation to facilitate agreement.

The system is preferably a computer based program available over a network that facilitates the execution of the business method by presenting data related to typical negotiations of the type the user is executing. The user can customize, organize and communicate the information in a manner consistent with the method. Output from the system can be used to plan the negotiation interactions with the counterpart, and to communicate information directly to the counterpart. To better understand the computer implemented system and method, a brief discussion of an underlying negotiation process is in order.

In one embodiment of the invention, the computer implemented method for constructing a negotiation blueprint through a computer network comprises a plurality of steps. A computer processing means and computer readable media is provided, with the processing means preferably coupled to a network interface. Access to a master account is provided allowing an input of negotiation information within the master account, with the information stored on the computer readable media and comprising at least CNA analysis information and trades analysis information. The information is compiled with the processing means to establish metadata providing data selection and input parameters of the negotiation blueprint for at least one user account. Access to the at least one user account is further provided allowing an input of negotiation data comprising at least further CNA analysis information, trades analysis information and multiple equal offers information within the data selection and input parameters of the at least one user account, with the data stored on the computer readable media. The data and metadata is compiled with the processing means to create the negotiation blueprint, which is displayed to at least one user.

In another embodiment of the invention, the system for creating a negotiation blueprint online comprises a processor, a computer readable memory coupled to the processor, and a network interface coupled to the processor. Software is stored on the computer readable memory and executed by the processor. The software comprises a means for establishing an online master account and a means for receiving an input of negotiation information within the master account, with the information stored on the computer readable memory and comprising at least CNA analysis information and trades analysis information. The software also comprises a means for compiling the information with the processor to establish metadata providing data selection and input parameters of the negotiation blueprint for at least one user account, and a means for providing access to the at least one user account. A means for receiving an input of negotiation data is also provided, with such data comprising at least further CNA analysis information, trades analysis information and multiple equal offers information within the data selection and input parameters of the at least one user account, with the data stored on the computer readable media. The software further comprises a means for compiling the data and metadata with the processor to create the negotiation blueprint, and a means for transmitting the negotiation blueprint to at least one user.

In another embodiment of the invention, a computer software product includes a non-transitory computer readable storage medium readable by a processor. The medium has stored thereon a set of instructions for creating a negotiation blueprint over a computer network. These instructions comprise a plurality of instructions. A first sequence of instructions which, when executed by the processor, causes the processor to establish an online master account and at least one user account. A second sequence of instructions which, when executed by the processor, causes the processor to receive an input of negotiation information within the master account, with the information comprising at least CNA analysis information and trades analysis information. A third sequence of instructions which, when executed by the processor, causes the processor to store the negotiation information on a server accessible by the online master account and user account. A fourth sequence of instructions which, when executed by the processor, causes the processor to compile the negotiation information of the master account to establish metadata providing data selection and input parameters of the negotiation blueprint for the at least one user account. A fifth sequence of instructions which, when executed by the processor, causes the processor to receive an input of negotiation data within the user account comprising at least further CNA analysis information, trades analysis information and multiple equal offers information within the data selection and input parameters of the at least one user account. A sixth sequence of instructions which, when executed by the processor, causes the processor to store the negotiation data on the server accessible by the online master account and online user account. A seventh sequence of instructions which, when executed by the processor, causes the processor to compile the data and metadata to create the negotiation blueprint. An eighth sequence of instructions is also provided which, when executed by the processor, causes the processor to transmit the negotiation blueprint to the at least one user.

### BRIEF DESCRIPTION OF THE DRAWINGS

FIG. 1 is a schematic timeline illustrating one embodiment of a negotiation process;

FIG. 2 is a flow chart illustrating the exemplary components of a computer system underlying the present invention;

FIG. 3 is a Ganes/Sarson data flow diagram illustrating the underlying components of a master account;

FIG. 4 is a screen shot illustrating a blueprint management interface screen for entering editing and sharing account information relating to the negotiation blueprint;

FIG. 5 is a screen shot illustrating a supplemental interface screen for entering the account information of the interface screen of FIG. 4;

FIG. 6 is a screen shot illustrating a supplemental interface screen for editing the account information of the interface screen of FIG. 4;

FIG. 7 is a screen shot illustrating a supplemental interface screen for sharing the account information of the interface screen of FIG. 4;

FIG. 8 is a data structure illustrating the information underlying the “CNA our side information” of FIG. 3;

FIG. 9 is a screen shot illustrating an interface screen for entering a category for the “CNA our side information” of FIGS. 3 and 8;

FIG. 10 is a screen shot illustrating an interface screen for entering an impact for the “CNA our side information” of FIGS. 3 and 8;

FIG. 11 is a screen shot illustrating an interface screen for editing a category for the “CNA our side information” of FIGS. 3 and 8;

FIG. 12 is a screen shot illustrating an interface screen for editing an impact for the “CNA our side information” of FIGS. 3 and 8;

FIG. 13 is a data structure illustrating the information underlying the “CNA their side information” of FIG. 3;

FIG. 14 is a screen shot illustrating an interface screen for entering a stakeholder for the “CNA their side information” of FIGS. 3 and 13;

FIG. 15 is a screen shot illustrating an interface screen for entering a criteria for the “CNA their side information” of FIGS. 3 and 13;

FIG. 16 is a screen shot illustrating an interface screen for entering a customer alternative for the “CNA their side information” of FIGS. 3 and 13;

FIG. 17 is a screen shot illustrating an interface screen for editing a stakeholder for the “CNA their side information” of FIGS. 3 and 13;

FIG. 18 is a screen shot illustrating an interface screen for editing a criteria for the “CNA their side information” of FIGS. 3 and 13;

FIG. 19 is a screen shot illustrating an interface screen for editing a customer alternative for the “CNA their side information” of FIGS. 3 and 13;

FIG. 20 is a data structure illustrating the information underlying the “trades” of FIG. 3;

FIG. 21 is a screen shot illustrating an interface screen for entering a trade type for the “trades” of FIGS. 3 and 20;

FIG. 22 is a screen shot illustrating an interface screen for entering a trade for the “trades” of FIGS. 3 and 20 and including an enforcement provision;

FIG. 22a is a screen shot for adding a unit to the to the “add” trades interface screen of FIG. 22;

FIG. 23 is a screen shot illustrating an interface screen for entering a solution type for the “trades” of FIGS. 3 and 20;

FIG. 24 is a screen shot illustrating an interface screen for editing a trade type for the “trades” of FIGS. 3 and 20;

FIG. 25 is a screen shot illustrating an interface screen for editing a trade for the “trades” of FIGS. 3 and 20;

FIG. 26 is a screen shot illustrating an interface screen for editing a solution type for the “trades” of FIGS. 3 and 20;

FIG. 27 is a data structure illustrating the information underlying the “Notes” of FIG. 3;

FIG. 28 is a screen shot illustrating an interface screen for entering custom data for the “Notes” of FIGS. 3 and 27;

FIG. 29 is a Ganes/Sarson data flow diagram illustrating the underlying components of a user account;

FIG. 30 is a screen shot illustrating an interface screen for populating or editing the “cover” of FIG. 29;

FIG. 31 is a screen shot illustrating an interface screen for populating the “CNA our side” and “CNA their side” of FIG. 29;

FIG. 32 is a screen shot illustrating a supplemental interface screen for populating the “CNA our side” interface screen of FIG. 31;

FIG. 33 is a screen shot illustrating a supplemental interface screen for populating the “CNA their side” interface screen of FIG. 31;

FIG. 34 is a screen shot illustrating an interface screen for populating the “trades” of FIG. 29;

FIG. 35 is a screen shot illustrating a supplemental interface screen for populating the “trades our side” interface screen of FIG. 34;

FIG. 36 is a screen shot illustrating a supplemental interface screen for populating the “trades their side” interface screen of FIG. 34;

FIG. 37 is a screen shot illustrating an interface screen for populating the “MEOs” of FIG. 29;

FIG. 38 is a screen shot illustrating a supplemental interface screen for populating the “basic column” of the interface screen of FIG. 37;

FIG. 39 is a screen shot illustrating a supplemental interface screen for populating the “intermediate column” of the interface screen of FIG. 37;

FIG. 40 is a screen shot illustrating a supplemental interface screen for populating the “premium column” of the interface screen of FIG. 37;

FIG. 40a is a screen shot illustrating an interface screen for populating “notes” for the Blueprint;

FIG. 41 is a screen shot illustrating a blueprint reports export interface screen;

FIG. 42 illustrates a sample dashboard or accounts report;

FIG. 43 is a screen shot illustrating an interface screen for generating a “region” specific dashboard report;

FIG. 44 is a screen shot illustrating an interface screen for generating an “area” specific dashboard report;

FIG. 45 is a screen shot illustrating an interface screen for generating a “report to” specific dashboard report;

FIG. 46 is a screen shot illustrating an interface screen for generating an “account” specific dashboard report;

FIG. 47 illustrates a sample CNA their side report.

FIG. 48 is a screen shot illustrating an interface screen for generating a “solution type” CNA their side report;

FIG. 49 is a screen shot illustrating an interface screen for generating a “customer alternative” CNA their side report;

FIG. 50 is a screen shot illustrating a supplemental interface screen for selecting one or more “values” relating to each of the CNA their side report interface screens of FIGS. 49 and 50;

FIG. 51 illustrates a sample CNA our side report;

FIG. 52 is a screen shot illustrating an interface screen for generating a “category” CNA our side report;

FIG. 53 illustrates a sample trades their side report;

FIG. 54 is a screen shot illustrating an interface screen for generating a “solution type” trades their side report;

FIG. 55 is a screen shot illustrating an interface screen for generating a “customer alternative” trades their side report;

FIG. 56 is a screen shot illustrating a supplemental interface screen for selecting one or more “trade types” relating to each of the trades their side report interface screens of FIGS. 54 and 55;

FIG. 57 illustrates a sample trades our side report;

FIG. 58 is a screen shot illustrating an interface screen for generating a “solution type” trades our side report;

FIG. 59 is a screen shot illustrating an interface screen for generating a “customer alternative” trades our side report;

FIG. 60 is a screen shot illustrating a supplemental interface screen for selecting one or more “trade types” relating to each of the trades our side report interface screens of FIGS. 58 and 59;

FIG. 61 illustrates a sample MEO report;

FIG. 62 is a screen shot illustrating an interface screen for generating a “solution type” MEO report;

FIG. 63 is a screen shot illustrating an interface screen for generating a “customer alternative” MEO report;

FIG. 64 is a screen shot illustrating an interface screen for generating a “blueprints” MEO report;

FIG. 65 illustrates a sample MEO detail report;

FIG. 66 is a screen shot illustrating an interface screen for generating a “solution type” MEO detail report;

FIG. 67 is a screen shot illustrating an interface screen for generating a “customer alternative” MEO detail report;

FIG. 68 is a screen shot illustrating an interface screen for generating a “blueprints” MEO detail report;

FIG. 68a illustrates a sample use report setting forth a summary of use information relating to the Blueprint itself;

FIG. 68b illustrates a sample trades analysis report setting forth a summary of trade information;

FIG. 68c illustrates a sample CNA analysis report setting forth a summary of CNA information;

FIG. 69 is a screen shot illustrating an interface screen for conducting a supplier value analysis;

FIG. 70 is a screen shot illustrating a weighting and scoring key for the supplier value analysis of FIG. 69; and

FIG. 71 is a screen shot illustrating an interface screen for conducting a supplier investment and risk analysis.

### DESCRIPTION OF THE EMBODIMENTS

The present invention is directed to a computer-implemented system and method for constructing a negotiation blueprint for a business negotiation. The system and method is designed to facilitate the organized and consistent execution of the process by a single individual or team of individuals working on the negotiation.

The method can be organized into two phases: analysis; and execution. The analysis consists of a structured review of the situation surrounding the negotiation from the perspective of each party or counterpart (i.e., buyer or seller), the understanding in detail of the implications on each party failing to reach agreement, and the critical terms of the agreement if it is reached. The execution phase provides negotiators a structured means of presenting alternatives to the counterpart of the negotiation to facilitate agreement.

The system is preferably a computer based program available over a network that facilitates the execution of the business method by presenting data related to typical negotiations of the type the user is executing. The user can customize, organize and communicate the information in a manner consistent with the method. Output from the system can be used to plan the negotiation interactions with the counterpart, and to communicate information directly to the counterpart. To better understand the computer implemented system and method, a brief discussion of an underlying negotiation process is in order.

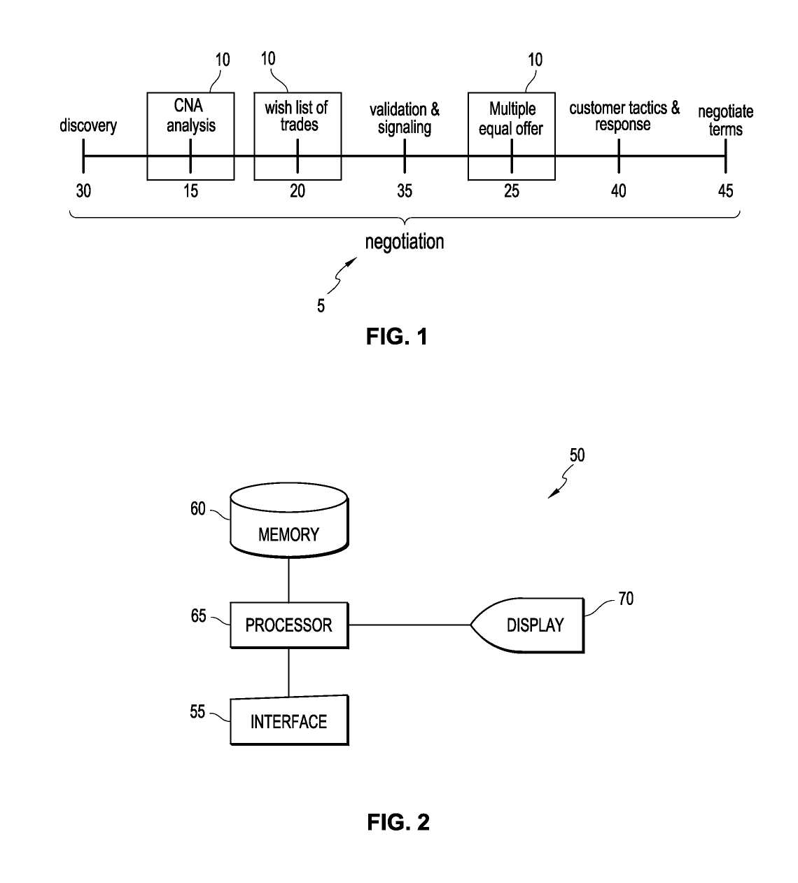

Referring initially FIG. 1, a preferred negotiation process may be represented by a linear timeline 5. From left to right, the linear timeline includes at least three steps that comprise the computer implemented system and method (to be further discussed) for constructing a negotiation blueprint 10. In one embodiment, the at least three steps comprise conducting CNA (consequences of not reaching an agreement) analysis 15, conducting trades analysis 20 and compiling multiple equal offers (MEOs) 25. However, as illustrated in FIG. 1, four additional steps comprise the entire timeline of the underlying negotiation process, resulting in seven total steps. The seven steps, from left to right, are: conducting discovery 30; conducting CNA analysis 15; conducting trades analysis 20; engaging in validation and signaling 35; compiling multiple equal offers 25; reviewing the customer's tactics and responses 40; and negotiating the terms 45. An introduction to each of these seven steps is provided below.

Conducting discovery 30 is an initial preparation step comprising collecting data relating to the counterpart with which a negotiation will take place. The collected data will optimally provide information regarding both counterparts' perspective in negotiating a transaction. Thus, the sales or buying professional and or the professional's team will collect data from both the prospective counterpart's organization, as well as the professional's own organization. The information obtained through such data collection is thereafter used when conducting the next step of the negotiation timeline, namely CNA analysis 15.

CNA analysis 15, one of the at least three steps of the computer-implemented system and method for constructing a negotiation blueprint 10, to be further discussed, is an acronym for analyzing the “consequences of no agreement.” CNA analysis allows sales or buying professionals to put themselves into the shoes of the counterpart as the counterpart compares the professional's total offer to their alternatives, given the their needs. Thus, instead of operating on the basis of random and unpredictable methods during a negotiation, CNA analysis 15 allows the professional to analyze its own offer in relation to the alternatives available to the counterpart, ultimately allowing the professional to make informed decisions during the negotiation process.

CNA analysis 15 utilizes the data collected during discovery 30 regarding the counterpart as well as from the professional's own organization. Again, CNA analysis involves answering the following question: “what are the consequences if the professional and counterpart do not reach an agreement?” The foregoing question needs to be answered from the perspective of both parties to the negotiation. As the seller, the consequences of no agreement are typically “losing the sale.” As the buyer, the consequences of no agreement are typically: 1) buy the goods or services from the seller's competition; 2) create the goods or services internally; or 3) do nothing. In the case of non-sales business to business negotiations, the consequence of no agreement could be significant impacts on the business conditions, relationship or other process outcomes.

Conducting trades analysis 20, another of the at least three steps of the computer-implemented system and method for constructing a negotiation blueprint 10, again to be further discussed, utilizes the results of the CNA analysis 15 to compile a “wish list” of trades for both the seller and buyer. These “trades” represent items that may be traded, in lieu of, or to minimize, price reductions proposed by the buyer in reaching a sales agreement. Conducting trades analysis thus allows a sales professional to systematically prepare in advance for resisting any problematic price or giveaway pressure applied by a buyer during the negotiation. By analyzing these trades for both the seller and buyer in advance, the sales professional can take proactive control of the negotiation in successfully avoiding the aforementioned pricing and giveaway pressures of the buyer. An enforcement provision is available in relation to conducting trades analysis 20. With this provision, a trade description is entered into the system's wish list along with a unit of measure and an associated range for that unit of measure. The enforcement provision thus relates to the allowability of a given trade in relation to the range of units. One of four levels of enforcement, to be further discussed, can be specified for each trade made in view of the foregoing range.

Engaging in validation and signaling 35 involve setting up a meeting between the seller and buyer so that the sales professional can educate and signal the buyer about the seller's CNA and trade analyses 15 and 20 in an effort to have the seller validate the analyses. Thus, the sales professional seeks to validate his or her estimation of the buyer's trade wish list, as well as the underlying data about the buyer that the seller has used to populate the CNA analysis 15. To obtain such validation information from an unforgiving or un-trustful buyer, the sales associate may have to ask underlying questions indirectly or perhaps engage in additional meetings until the buyer's trust is gained. As a follow up to any validation meetings held, the sales professional should revise the CNA and trades analyses 15 and 20, if necessary. The validation meetings thus serve as a “checkpoint” for the sales professionals before the seller creates offers and presents them to the buyer.

Compiling multiple equal offers (MEOs) 25, the third of the at least three steps of the computer-implemented system and method for constructing a negotiation blueprint 10, again to be further discussed, utilizes the results of the CNA and trades analyses 15 and 20 to compile a plurality of offers to the buyer, with each offer being of approximate equal value to the seller. CNA analysis 15 information provides the seller with titles for the MEOs 25 while trades analysis 20 provides the seller with the information that populates the MEOs.

In a preferred embodiment, MEOs 25 compilation give buyers at least three choices (i.e., at least three offers) for solving the acquisition needs at three different investment and risk levels, instead of giving them one choice (i.e., a single offer). For example, a seller could provide: 1) a premium offer or high-priced, high-value, custom solution; 2) a basic offer or a low-priced, off-the-shelf package; and 3) an intermediate offer, i.e., something in between. The goal for the seller is to shift the buyer's perspective from a single price-point offer for the seller's products and services to three different “business relationships” that instead focus on value and problem solving.

Reviewing the customer's tactics and responses 40 is the next step of the negotiation timeline 5 of FIG. 1. Buyers will often attempt to apply pricing pressure to the seller, stating that the buyer can buy the goods or services from a competitor at a cheaper price. Sellers should expect buyers to apply price pressure and commoditization during a negotiation. In response to these tactics, sellers should use the information of CNA analysis 15 to resist the buyer's commoditization attempts and trades analysis 20 information to resist the buyer's price and giveaway pressure. Thus, the seller can use CNA analysis 15 information to illustrate to the buyer the advantages of the seller's products and services over that of the seller's competitors, and use trades analysis 20 information to trade goods and or services in lieu of or to diminish the seller's pricing concessions to the buyer.

Although not illustrated within the timeline of FIG. 1, a notes provision is available in relation to the blueprint. The notes provision allows for “notes” relating to the negotiation preparation and underlying information to be added and edited as part of the blueprint system and method. Having become armed with the knowledge and information gained from CNA and trades analysis 15 and 20 and having prepared MEOs 30, and also having reviewed and becoming prepared for buyer's tactics, the seller is now ready for the final step of the timeline 5, namely, negotiating the deal 45.

Again, at least three of the foregoing seven steps comprise the computer implemented system and method for constructing a negotiation blueprint 10, namely conducting CNA analysis 15, conducting trades analysis 20 and compiling multiple equal offers 25. It should be understood that the input, analysis, compilations, calculations and displays underlying the CNA, trades and MEOs may be performed by any suitable computer system, such as that diagrammatically shown in FIG. 2. Information and data are input or entered into system 50 via any suitable type of user interface 55, and may be stored in memory 60, which may be any suitable type of computer readable and programmable memory. Analyses, calculations and compilations creating metadata are performed by processor 65, which may be any suitable type of computer processor, and may be displayed to the user on display 70, which may be any suitable type of computer display. As understood in the art, the interface 55 and display 70 may be connected directly to the processor 65, or may be indirectly connected to the processor via the internet, a wide area network (WAN), and/or a local area network (LAN).

The processor 65 may be associated with, or incorporated into, any suitable type of computing device, for example, a personal computer or a programmable logic controller. The display 70, the processor 65, the memory 60 and any associated computer readable recording media are in communication with one another by any suitable type of data bus, as is well-known in the art. Examples of computer-readable recording media include a magnetic recording apparatus, an optical disk, a magneto-optical disk, and/or a semiconductor memory (for example, RAM, ROM, etc.). Examples of magnetic recording apparatus that may be used in addition to memory 112, or in place of memory 60, include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW.

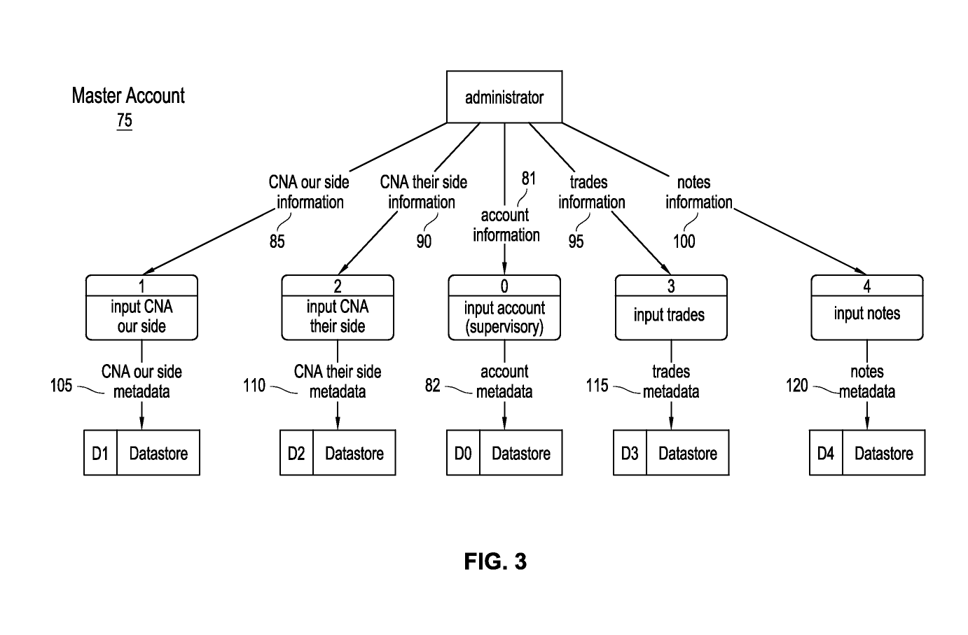

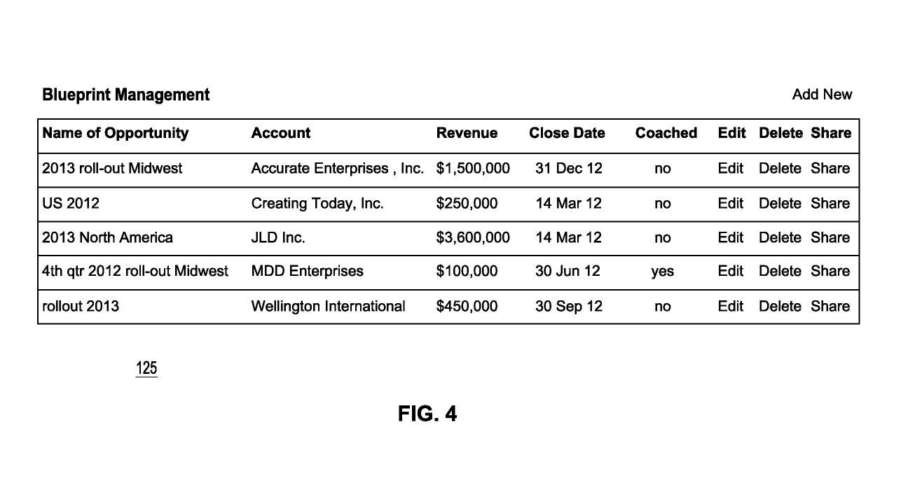

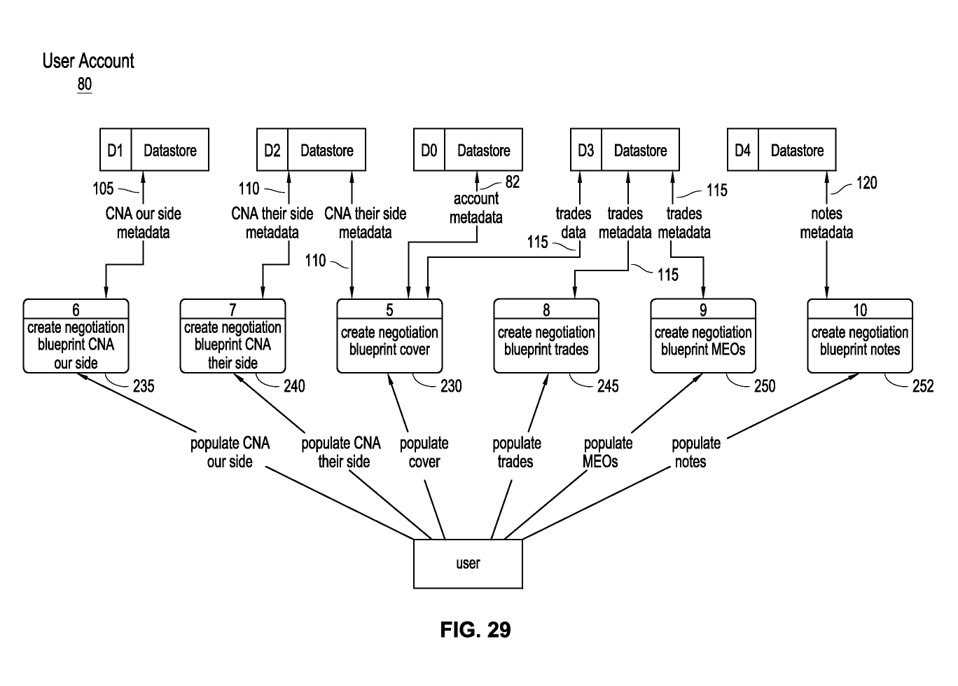

With further regard to the computer implemented system and method for constructing a negotiation blueprint 10, we note that the system and method each provide a master account 75 (FIG. 3) and at least one user account 80 (FIG. 29). The master account 75 allows for an input, of information, compiling the information with a processing means to create metadata, and storing at least the metadata within a data-store (i.e., memory). The metadata is utilized to establish data selection and input parameters of the negotiation blueprint for the at least one user account 80. The users of the at least one user account 80, in turn, utilize these compiled data selection and input parameters to populate and define the negotiation blueprint 10 for a specific buyer, seller or other account.

The master account 75 of the system and method is typically accessible only by administrators of the account. Such administrators input the information into the computer that is processed into the metadata underlying the data selection and input parameters to be used by a user of the at least one user account 80. Administrators may also edit the foregoing metadata, once input. The at least one user account 80 is accessible by sales professionals and/or sale team members. While these individuals cannot enter and edit the information and metadata underlying the data selection and input parameters, they may nonetheless input (i.e., populate) data conforming to the data selection and input parameters established by the metadata. It is noted, however, that some data populated by the user may be processed into further metadata used by the user.

In defining a negotiation blueprint for a specific user account, it thus follows that such accounts are created and managed by at least the administrators of the master account. Thus, referring to the information flow diagram of FIG. 3, access to the master account is thus provided to allow for the creation and management of such accounts. The administrator thus inputs account information 81 that is compiled by the processor to create account metadata 82. The account metadata is stored in at least one data-store for access by a user of the at least one user account. With further regard to the negotiation blueprint, because the blueprint 10 may be directed to sellers or sale professionals, further information underlying the blueprint is described from two perspectives: as applying to “our side” (i.e., sellers); and “their side” (i.e. buyers). Of course, these roles and classifications may be reversed. Referring again to FIG. 3 and a further discussion of the master account 75, access to the master account is thus provided to allow an input of information relating to CNA analysis in relation to the foregoing perspectives: CNA our side information 85 (i.e., from the seller's perspective); CNA their side information 90 (i.e., from the buyer's perspective).

Access to the master account is also provided to allow an input of trades information 95 and notes information 100. This information is compiled with the processor 65 if FIG. 2 to create metadata establishing the data selection and input parameters of the negotiation blueprint 10. Thus, in the embodiment of the master account 75 illustrated in FIG. 3: the CNA our side information 85 is compiled by the processor 65 to create CNA our side metadata 105; the CNA their side information 90 is compiled to create CNA their side metadata 110; the trades information 95, to include enforcement provisions, is compiled to create trades metadata 115; and the notes information 100 is compiled to create notes metadata 120. All of the foregoing metadata is stored within one or more data-stores (i.e., the memory 60) for access by a user of the at least one user account 80, to be further discussed.

For creating and managing negotiation blueprints and their underlying sellers, buyers or accounts, a blueprint management interface screen 125 (FIG. 4) is provided that allows administrators of the master account to add, delete, edit and share such accounts. It is noted that while administers can enter and edit the below described information within the master account, such entry is typically performed by users within the user account (to be further discussed). Nonetheless, administrators have the ability to make the below described entries in preferably an oversight or supervisory capacity, if necessary.

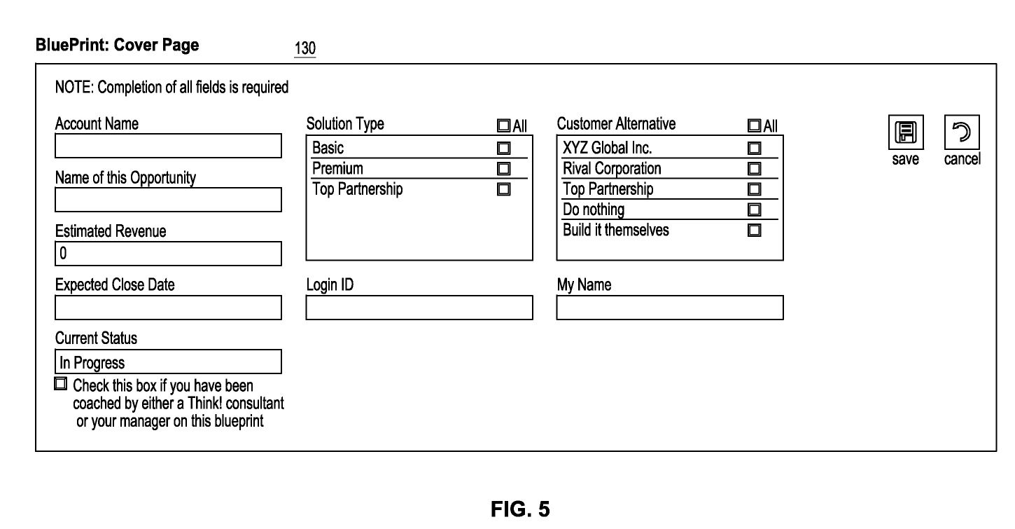

Referring to the blueprint management interface screen of FIG. 4, a table is presented listing a number of buyer accounts and other related information. Each of the buyer accounts listed within FIG. 4 represent parties with which users of the negotiation blueprint will negotiate a sales transaction. If the administrator clicks on the “add new” button located at the top right hand corner of the blueprint management interface screen 125, a supplemental add blueprint cover add interface screen 130 (FIG. 5) appears. As illustrated in FIG. 5, several fields are provided where an administrator can enter data. In one embodiment, “account name,” “opportunity name,” “estimated revenue,” “expected close date,” “current status,” “status comments,” “login ID” and “my name” entry fields are provided. Within the “account name” entry field, the administrator may enter the account name of the buyer account to which the negotiation blueprint 10 applies in negotiating a sales transaction. Within the “opportunity name” entry field, the administrator may enter the opportunity name by which the account is named within the seller's company. Within the “estimated revenue” entry field, the administrator may enter the estimated revenue to be made by the seller in successfully negotiating the sales transaction with the buyer underlying the account name. Within the “expected close date” entry field, the administrator may enter the expected close date upon which a successful negotiated sales transaction with the buyer will occur or “close.” Within the “current status” entry field, the administrator may enter the current status of the negotiation and sales transaction between the seller and buyer. Within the “status comments” entry field, the administrator may enter any helpful status comments relating to and/or explaining the status entered within the current status entry field. Within the “login ID” entry field, the administrator may enter a login identification for himself or herself or a user, created for accessing the buyer-specific account and precluding access to the account by other users not having the same ID. Within the “my name” entry field, the administrator may enter his or her name or that of a user associated with the login identification.

Along with entering data within the above-recited fields of the blueprint cover add interface screen 130 of FIG. 5, the administrator also may also utilize the metadata of one or more “selection fields” to further define the negotiation blueprint for the underlying buyer-specific account. In the embodiment illustrated in FIG. 5, a “solution type” selection field and “customer alternative” selection field are both provided. It is noted that the information comprising the “solution type” and “customer alternative” selection fields are metadata obtained from other areas of the master account 75. For example, the “solution type” selection field comprises “trades” metadata 115 while the “customer alternatives” selection field comprises “CNA their side” metadata 110, both obtained from the master account 75, to be further discussed.

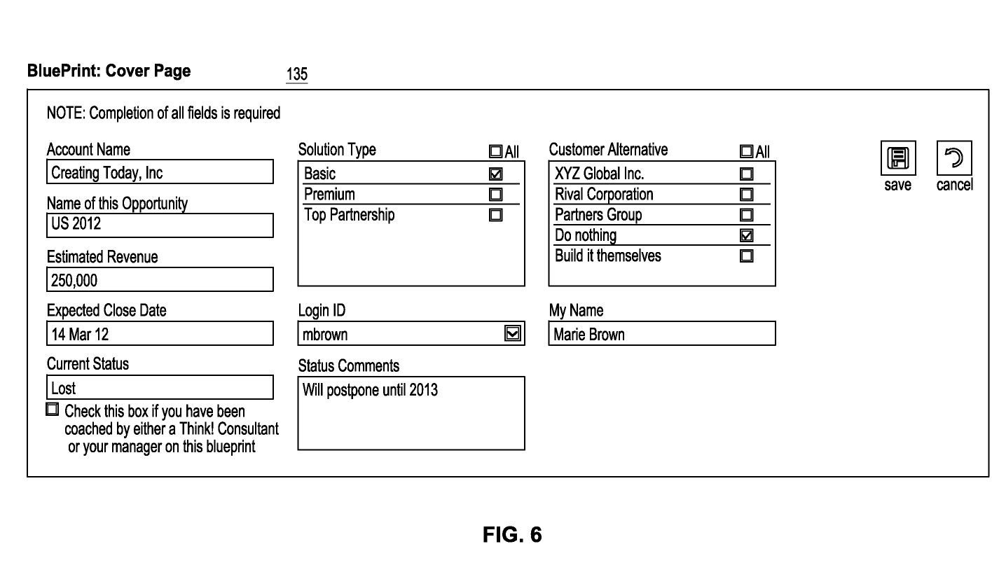

After the information is entered within the various fields and the solution type(s) and customer alternative(s) are selected within their respective selection fields, the administrator may click on the “save” icon. Upon clicking on the save icon, the processor 65 processes the information into the metadata of the blueprint cover page 130 and stores it within the data-store (FIG. 3). Upon returning to the blueprint management interface screen of FIG. 4, the new account name and related information entered within the foregoing entry fields will be displayed within the table therein. To edit any account listed within the table of the blueprint management interface screen of FIG. 4, the administrator may click on the edit button located at the right side of the account line item such that a blueprint cover edit interface screen 135 (FIG. 6) appears. For example, clicking on the edit button of the “Creating Today, Inc.” account name line item of FIG. 4 will cause the supplemental blueprint cover edit interface screen of FIG. 6 to appear with the edit fields and edit selection fields already completed, but available for edit.

Thus, in relation to the “Creating Today, Inc.” account name selected for edit within FIG. 4, the supplemental interface screen of FIG. 6 displays: Creating Today, Inc.” within the account name edit field as the account name; “US 2012” within the opportunity name edit field as the opportunity name; “250,000” within the estimated revenue edit field as the estimated revenue to be made; “14 mar 12” within the expected close date edit field as the expected close date upon which the closing of successfully negotiated sales transaction is to occur; “lost” within the current status edit field as the current status because the seller was apparently unsuccessful in negotiating with and selling to the buyer; “will postpone until 2013” within the status comments edit field as the current status to reflect that the seller will not likely engage in any further negotiation with the seller, relating to the lost sale, until the year 2013; “mbrown” within the login ID edit field as the login identification used to access the underlying buyer-specific account; “Marie Brown” within the “my name” edit field as the user name associated with the login ID; “basic” selected as the solution type; and “do nothing” selected as the customer alternative. Of course, the administrator can edit any of the foregoing metadata information within the screen. After making any such edits, the administrator may click on the “save” icon. Upon clicking on the save icon, the processor processes the information into the blueprint cover page 130 and stores it within the data-store (FIG. 3). Upon returning to the blueprint management interface screen 125 of FIG. 4, any edited account name and related information will be displayed within the table therein.

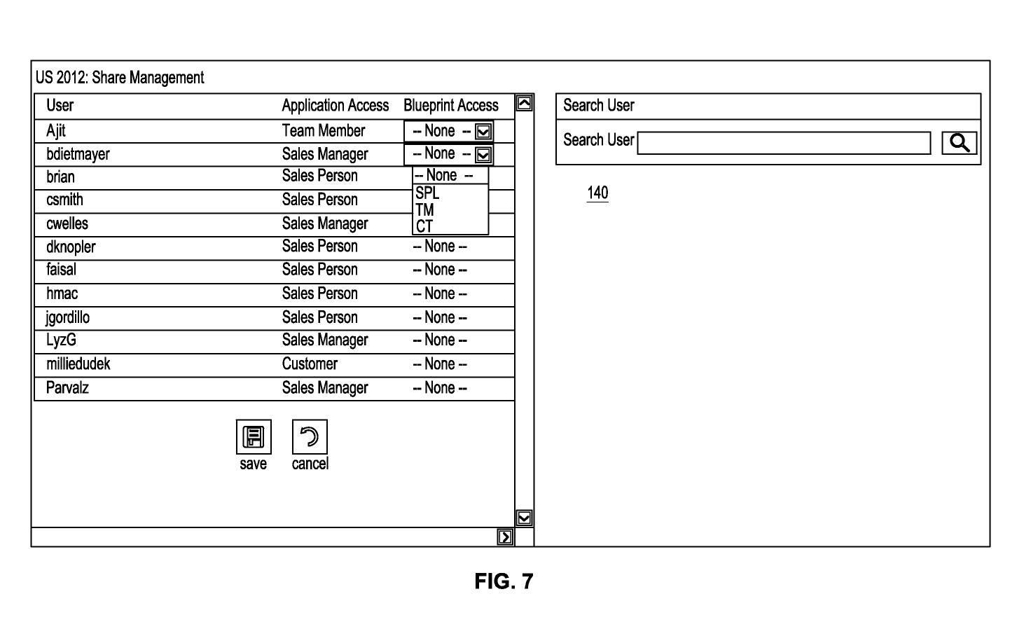

Because the foregoing negotiation blueprint account information is user specific, the blueprint management interface screen 125 of FIG. 4 includes a share button with every account line item. Upon clicking on the share button within any account line item, a supplemental blueprint cover share management interface screen appears. The blueprint cover share management interface screen allows the administrator to share a given account's negotiation blueprint with one or more users. For example, if the administrator clicks on the “share button” of the “Creating Today, Inc. account line item of the blueprint management interface screen of FIG. 4, the blueprint cover share management interface screen 140 of FIG. 7 appears. Within the interface screen of FIG. 7, a list of users is presented. For each user, the administrator can allow or deny varying levels access to the negotiation blueprint for the Creating Today, Inc account by selecting the level within the “blueprint access” selection field. The levels of the selection field vary from “none” allowing no access to others, to varying levels of access based upon position. For example, a selection of “TM” within the selection field would indicate that access to the blueprint for the Creating Today account has been granted to “team members,” who may only view the blueprint. A selection of “SPL” within the selection field would indicate that access to the blueprint for the account has been granted to “sales persons,” who may create, edit, delete and share the blueprint. Other varying levels of access are available as well within the selection field. Upon selecting the desired access for one or more users within the interface screen of FIG. 7, the administrator may click on the save button and is returned to the interface screen of FIG. 4

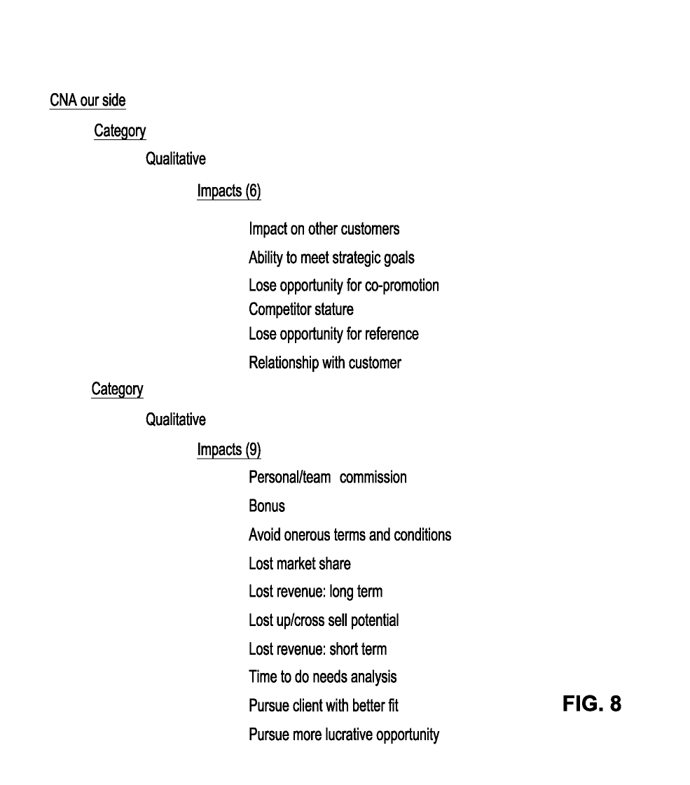

Turning now to a discussion of CNA analysis, as illustrated in the data structure of FIG. 8, CNA our side information 85 and metadata 105 within the master account 75 defines categories and related impacts as the data selection and input parameters for a seller. Although numerous categories may be utilized, one embodiment of the negotiation blueprint utilizes “qualitative” and “quantitative” categories. Falling within either of these categories are the impacts on the seller of failing to reach an agreement with the buyer. For example, falling within the qualitative category are six (6) impacts: “relationship with customer (buyer)”; “ability to meet strategic goals”; and four other impacts. Falling within the quantitative category are nine impacts (9): “lost market share”; “lost revenue”; and seven other impacts. Of course, the quantity and content of the categories and impacts illustrated herein are merely exemplary. As such, it is understood that any quantity and content of category and impact may be utilized.

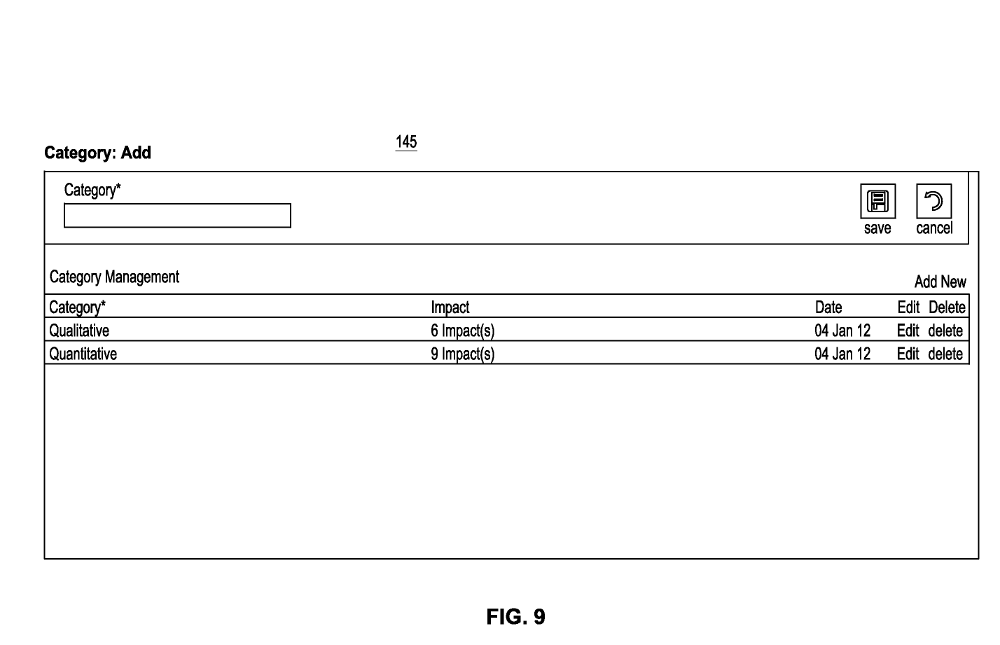

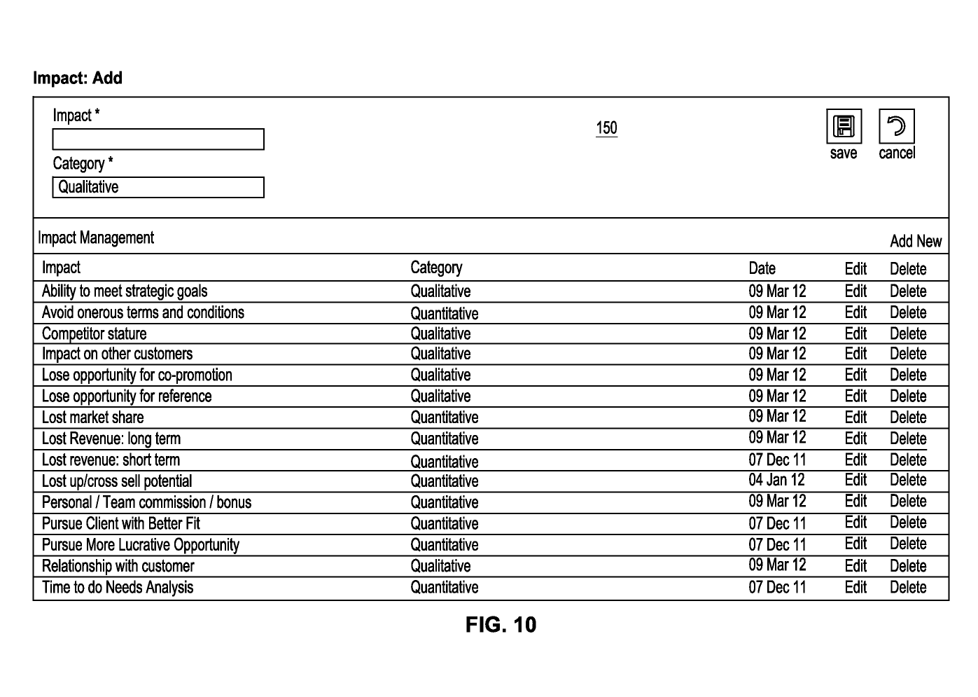

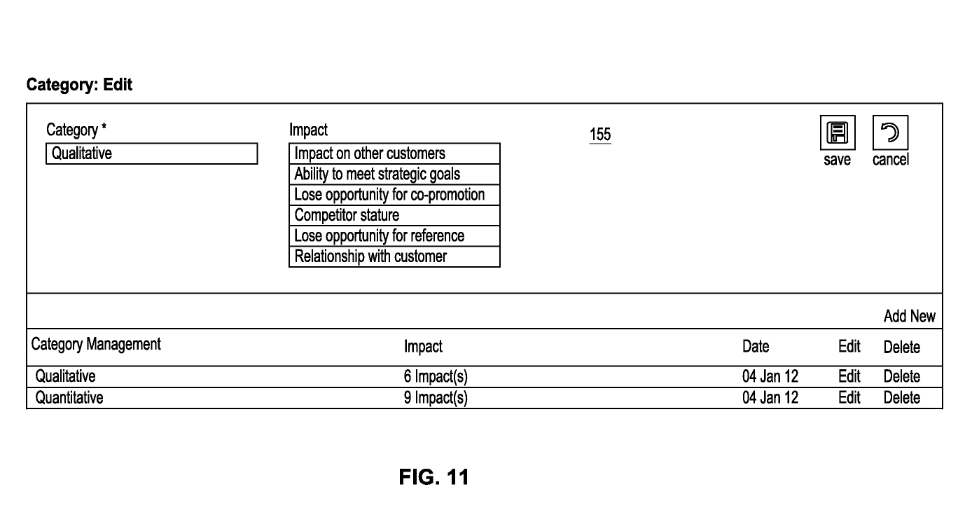

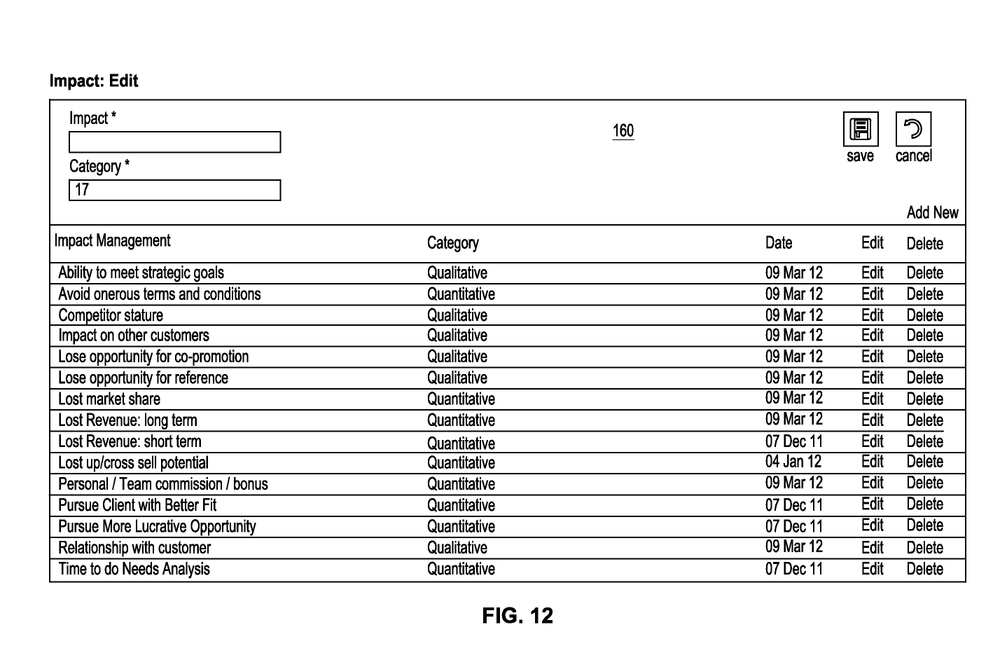

FIGS. 9 and 10 illustrate screen shots of “add” interface screens 145 and 150 for adding categories and impacts, respectively, while FIGS. 11 and 12 illustrate screen shot of “edit” interface screens 155 and 160 for respectively editing such categories and impacts. Each interface screen is roughly divided into upper and lower halves. The upper half of each screen displays “add” or “edit” fields while the lower half of each screen displays “management” information fields. Referring to FIG. 9 illustrating the category add interface screen 145, a category entry field is provided where an administrator can enter a category. After the category is entered within the category entry field, the administrator clicks on the “save” icon. Upon clicking on the save icon, the processor 65 processes information into the CNA our side metadata 105 and stores it within the data-store (FIG. 3). The metadata category is thereafter displayed in tabular form within the lower “management” half of the category add interface screen 145. Thus, as illustrated within FIG. 9, the exemplary categories of “qualitative” and “quantitative” have each been entered within the category entry field, saved, and thereafter displayed as metadata within the management field of the category add interface screen 145.

Referring to FIG. 10 illustrating the impact add interface screen 150, an impact entry field is provided where an administrator can enter an impact. A category “selection” field is also provided where the administrator can select metadata comprising one of the categories, added within the category entry field of the category add interface screen 145 of FIG. 9, desired to be associated with the entered impact. After the impact is entered within the impact entry field and the category is selected within the category selection field, the administrator clicks on the “save” icon. Upon clicking on the save icon, the processor 65 processes the information into the CNA our side metadata 105 and stores it within the data-store (FIG. 3). The metadata impact is thereafter displayed in tabular form within the lower “management” half of the impact add interface screen 150. Thus, as illustrated within FIG. 10, the exemplary impacts ranging from “ability to meet strategic goals” to “time to do needs analysis” have each been entered within the impact entry field, associated with a selected category, and thereafter displayed as metadata within the management field of the impact add interface screen 150.

As is evident within FIGS. 9 and 10, the tabular management fields of the respective “add” category and impact interface screens 145 and 150 each illustrate an “edit” column allowing for the edit of each entered line item. Thus, upon selecting “edit” for a given line item within the respective “add” category and impact interface screens of FIGS. 9 and 10, respective “edit” category and impact interface screens are displayed. FIGS. 11 and 12 thus illustrate these respective screen shots of the “edit” interface screens 155 and 160 for respectively editing the categories and impacts entered within the aforementioned “add” interface screens 145 and 150 of FIGS. 9 and 10. Referring to FIG. 11 illustrating the category edit interface screen 15S, a category edit field is provided where an administrator can edit the category based upon the edit line item selection made within the management field of the category add interface screen 145 of FIG. 9. An impact edit “selection” field is also provided where the administrator can change metadata comprising one of the impacts, added within the impact entry field of the impact add interface screen 150 of FIG. 10, desired to be associated with the edited category. After the category is edited within the category edit field and the impact is changed within the impact edit selection field, the administrator clicks on the “save” icon. Upon clicking on the save icon, the processor again processes the information into CNA our side metadata 105 and stores it within the data-store (FIG. 3). The metadata category is thereafter displayed in tabular form, along with the associated number of impacts, within the lower “management” half of the category edit interface screen 155. Thus, as illustrated within FIG. 11, the exemplary categories of “qualitative” and “qualitative” have each been edited and/or added within the edit or add category fields, associated with a selected impact, and thereafter displayed as metadata within the management field of the category edit interface screen 155.

Referring to FIG. 12 illustrating the impact edit interface screen 160, an impact edit field is provided where an administrator can edit an impact based upon the edit line item selection made within the management field of the impact add interface screen 150 of FIG. 10. A category edit “selection” field is also provided where the administrator can change metadata comprising one of the categories, added within the category field of the category add interface screen 145 of FIG. 9, desired to be associated with the edited impact. After the impact is edited within the impact edit field and the category is changed within the category edit selection field, the administrator clicks on the “save” icon. Upon clicking on the save icon, the processor 65 processes the information into CNA our side metadata 105 and stores it within the data-store (FIG. 3). The metadata impact is thereafter displayed in tabular form within the lower “management” half of the impact edit interface screen 160. Thus, as illustrated within FIG. 12, the exemplary impacts ranging from “ability to meet strategic goals” to “time to do needs analysis” have each been edited and/or added within the edit or add impact fields, associated with a selected category, and thereafter displayed as metadata within the management field of the impact edit interface screen 160.

As evident within FIGS. 11 and 12, the tabular management fields of the respective category and impact edit interface screens 155 and 160 each illustrate an “edit” column allowing for the edit of each entered line item. Thus, upon selecting “edit” for a given line item within the respective category and impact edit interface screens of FIGS. 11 and 12, the respective category and impact edit fields within the respective screens change to display the respective category or impact selected for edit. After the categories and impacts are added or edited by the administrator within the master account 75, the processor of the computer system and method compiles the information such that the categories and impacts will become available as “available selections” to a user utilizing the CNA analysis for “our side” within the user account 80.

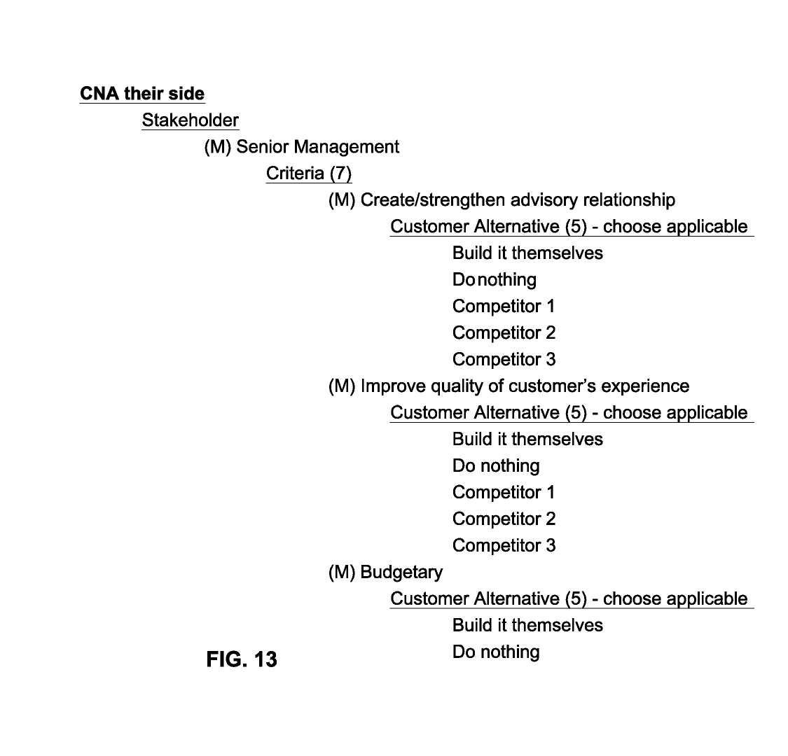

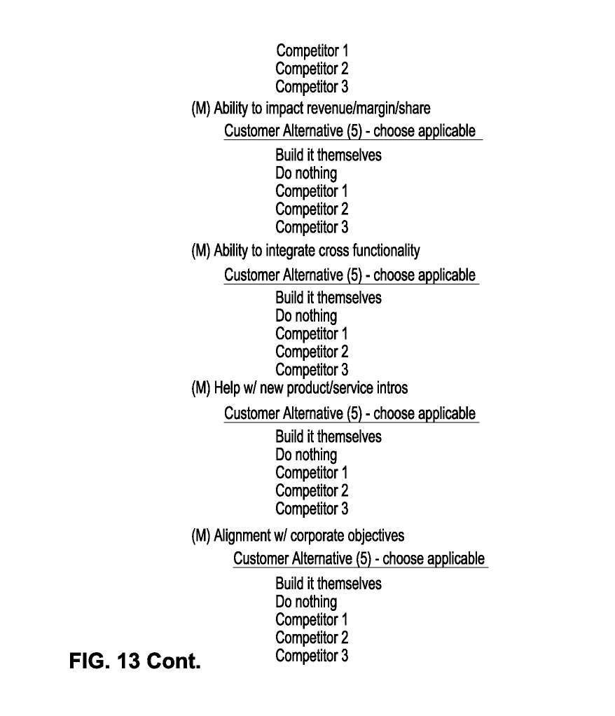

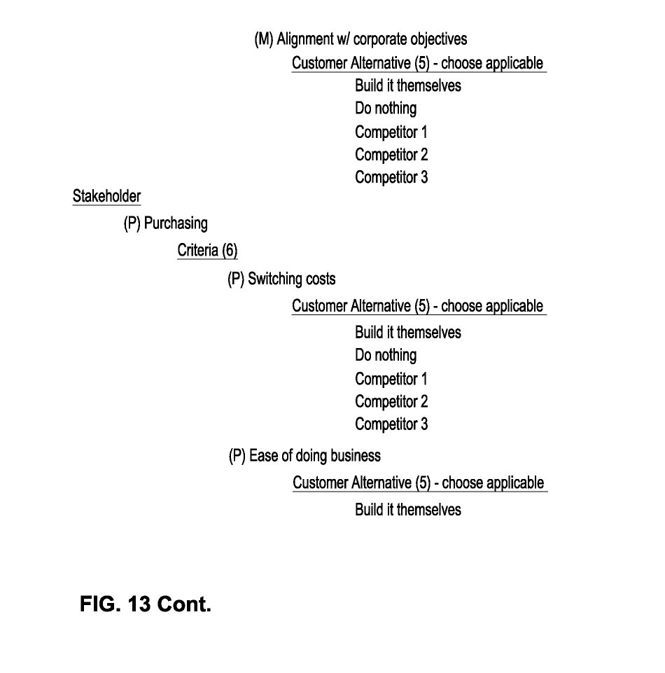

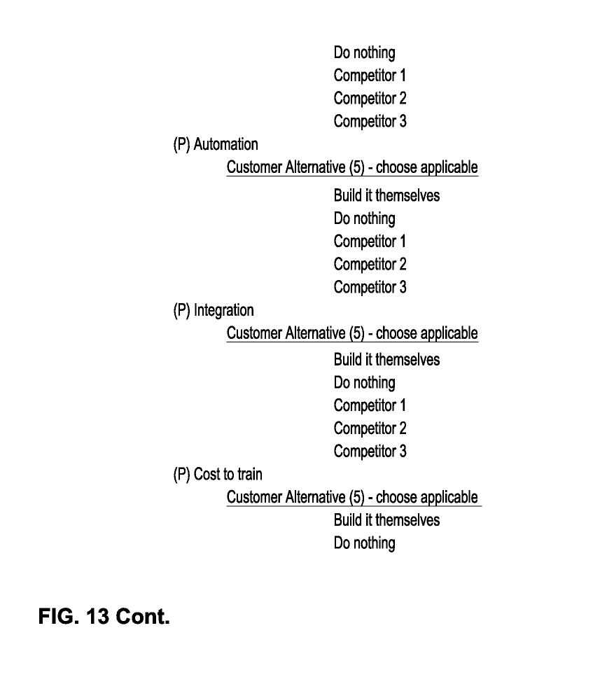

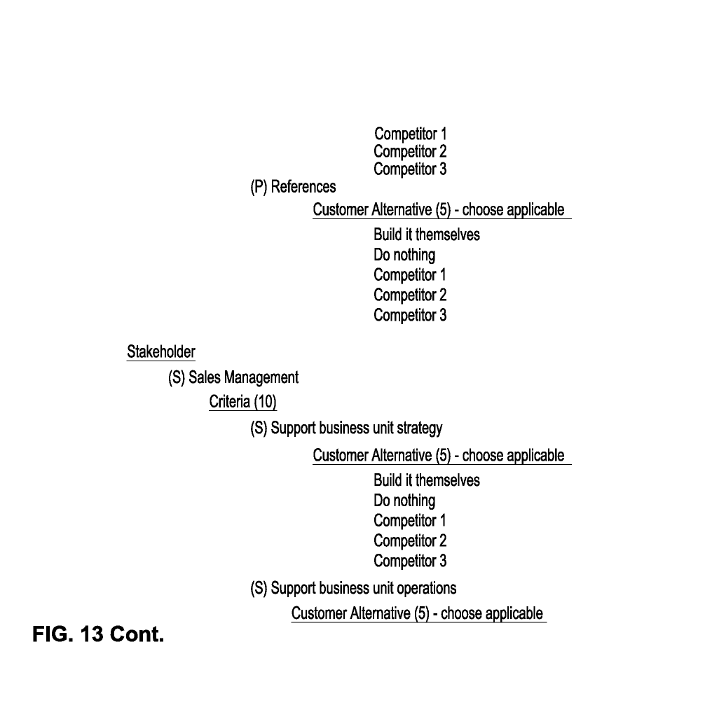

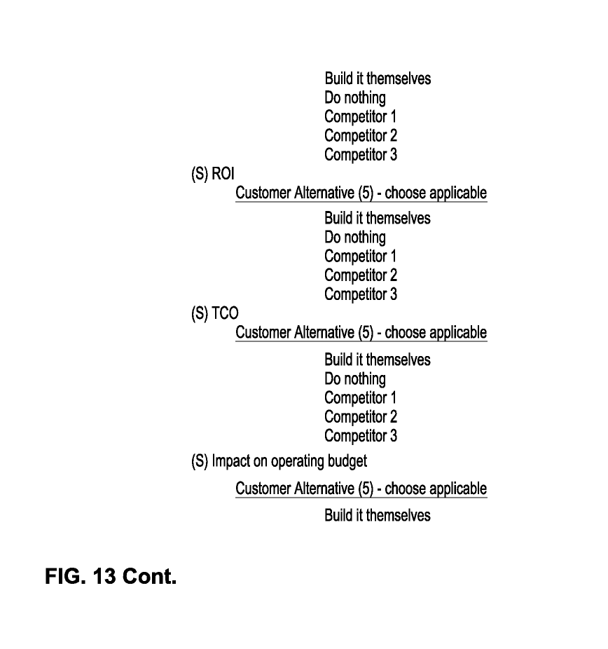

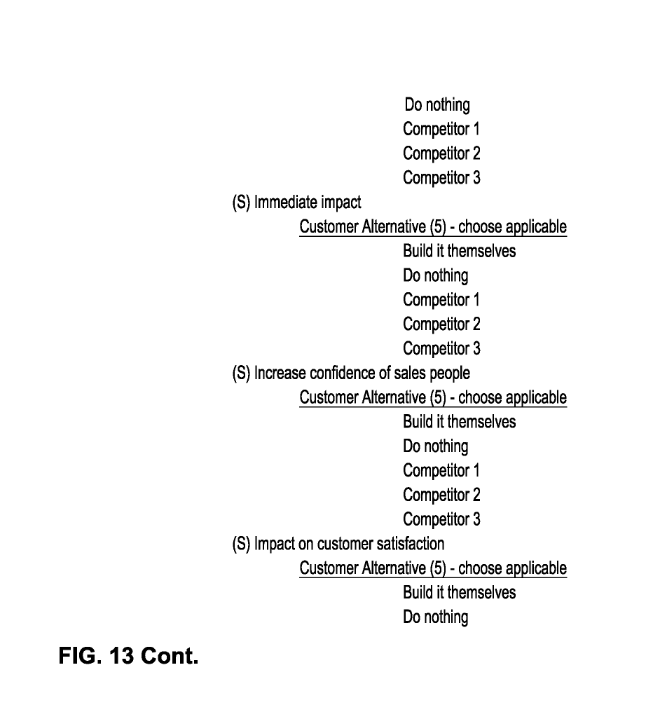

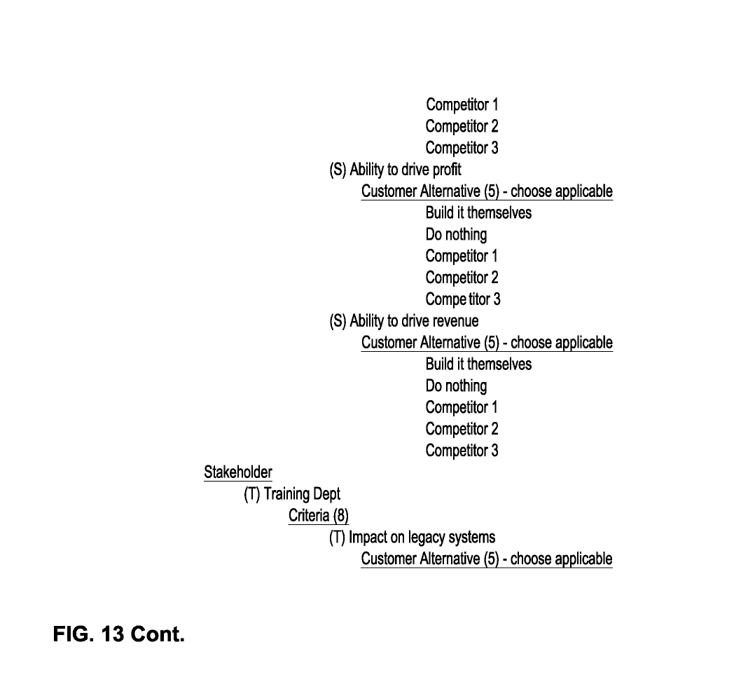

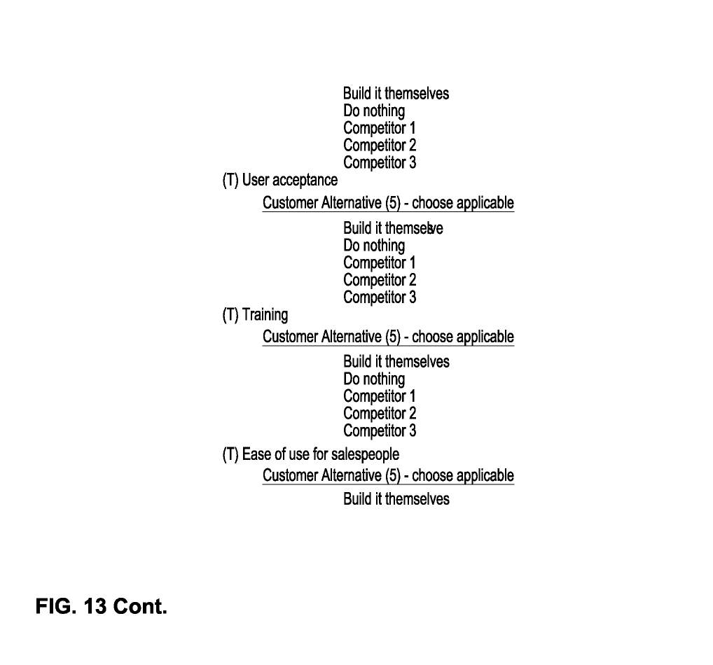

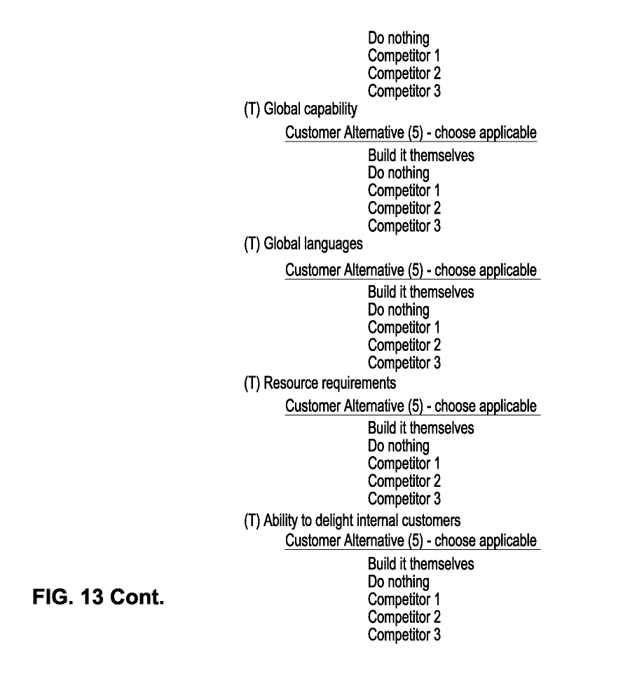

Referring to the data structure illustrated in FIG. 13, CNA their side information 90 and metadata within the master account 75 defines stakeholders and related criteria and related customer alternatives as the data selection and input parameters for a buyer. Although numerous stakeholders may be utilized, one embodiment of the negotiation blueprint utilizes “senior management,” “purchasing,” “sales management,” and “training department” as such stakeholders. Falling under any of these stakeholders are the criteria of how not reaching an agreement with the seller may affect the given stakeholder. For example, falling within the senior management stakeholder category are seven (7) criteria: “create/strengthen advisory relationship”; “budgetary” as well as five other criteria. Falling within the purchasing stakeholder category are six (6) criteria: “switching costs”; “ease of doing business” as well as four other criteria. The remaining stakeholders may each have one or more criteria as well.

Falling under any of the criteria for a given stakeholder are the customer alternatives available to the buyer as a consequence of the buyer of not reaching an agreement with a seller. As illustrated in FIG. 13, although numerous alternatives may be utilized, one embodiment of the negotiation blueprint utilizes five (5) alternatives: “build it themselves”; “do nothing”; “competitor 1”; “competitor 2”; and “competitor 3”. Of course, the quantity and content of the stakeholders and criteria illustrated herein are merely exemplary. As such, it is understood that any quantity and content of stakeholder and criteria may be utilized. Likewise, the quantity and content of the customer alternatives are merely exemplary while “competitors” may be entered by name. As such, it is understood that any quantity and content of customer alternative may be utilized.

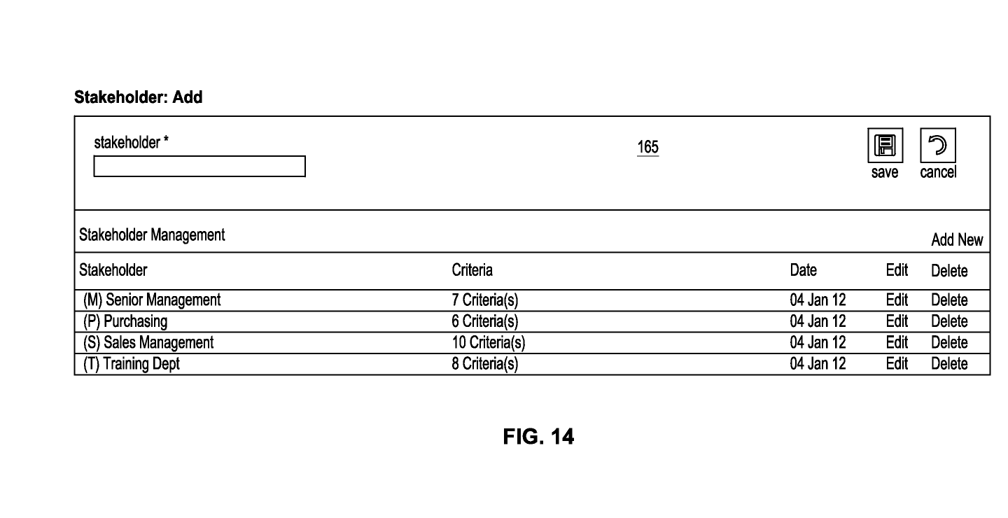

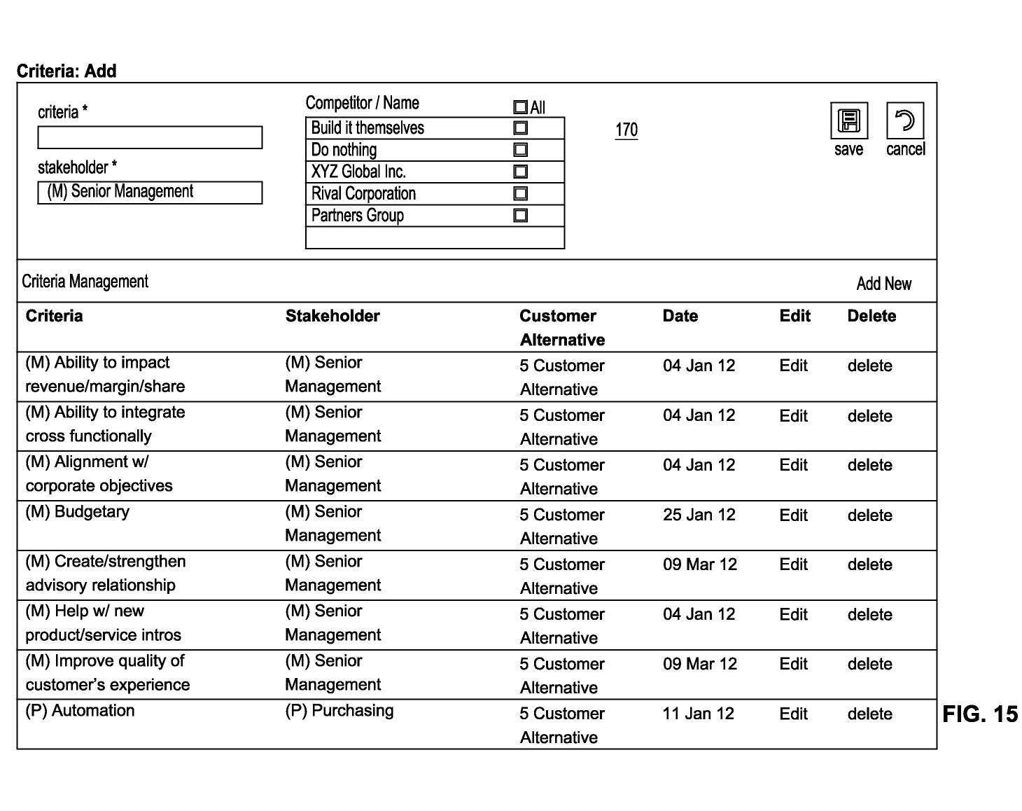

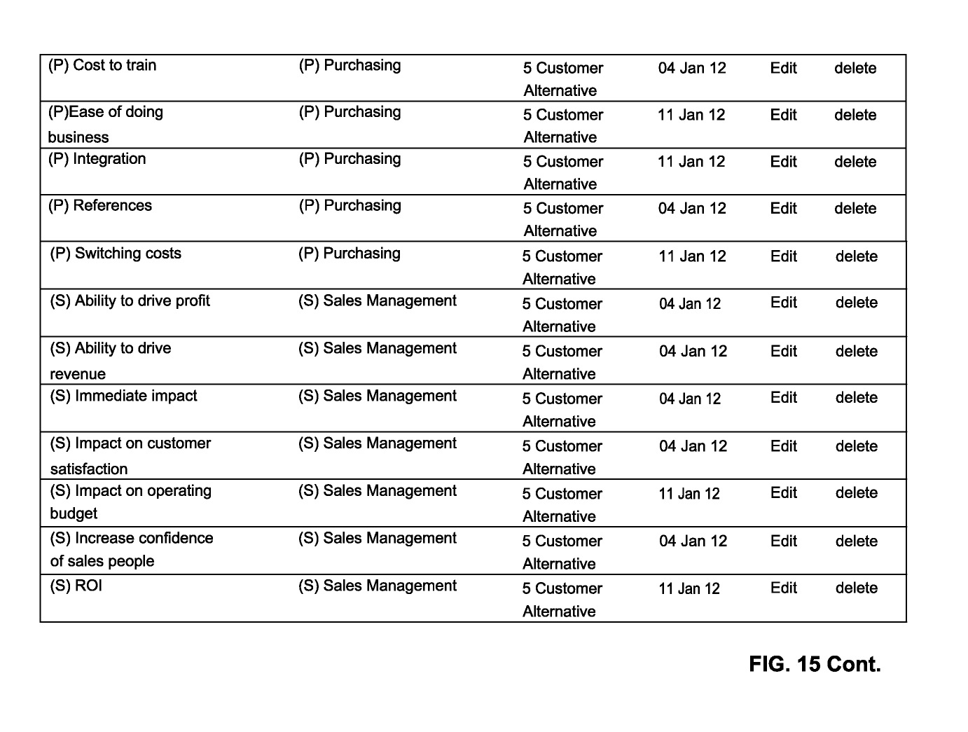

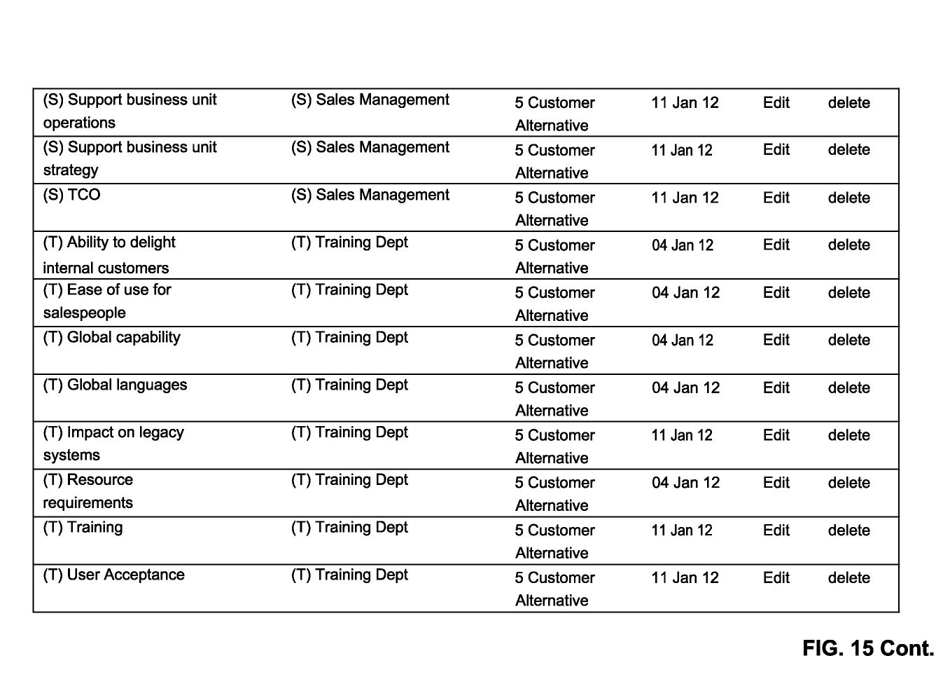

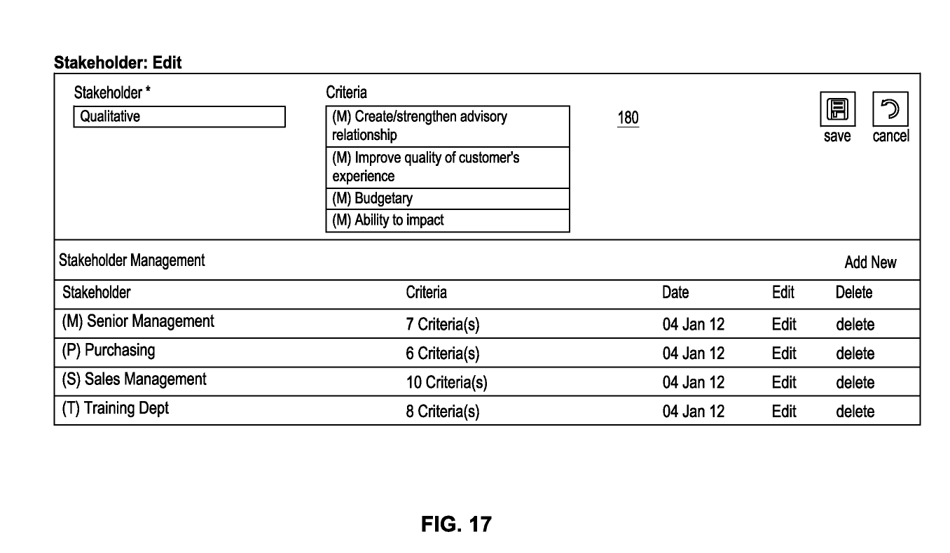

FIGS. 14, 15 and 16 illustrate screen shots of “add” interface screens 165, 170 and 175 for adding stakeholders, criteria and customer alternatives, respectively, while FIGS. 17, 18 and 19 illustrate screen shots of “edit” interface screens 180, 185 and 190 for respectively editing such stakeholder, criteria and alternatives. Again, each interface screen is roughly divided into upper and lower halves. The upper half of each screen displays “add” or “edit” fields while the lower half of each screen displays “management” information” fields. Referring to FIG. 14 illustrating the stakeholder add interface screen 165, a stakeholder entry field is provided where an administrator can enter a stakeholder. After the stakeholder is entered within the stakeholder entry field, the administrator clicks on the “save” icon. Upon clicking on the save icon, the processor 65 processes the information into CNA their side metadata 110 and stores it within the data-store (FIG. 3). The metadata stakeholder and number of associated criteria, which is added within the criteria entry field of the criteria add interface screen 170 of FIG. 15 (to be further discussed) are thereafter displayed in tabular form within the lower “management” half of the stakeholder add interface screen 165. Thus, as illustrated within FIG. 14, the exemplary stakeholders of “senior management,” “purchasing,” “sales management,” and “training dept” have each been entered within the stakeholder entry field, saved, and thereafter displayed as metadata within the management field of the stakeholder add interface screen 170. The number of criteria (to be further discussed) associated with each of the foregoing line items are also respectfully displayed as metadata within the management field of the stakeholder add interface screen 170.

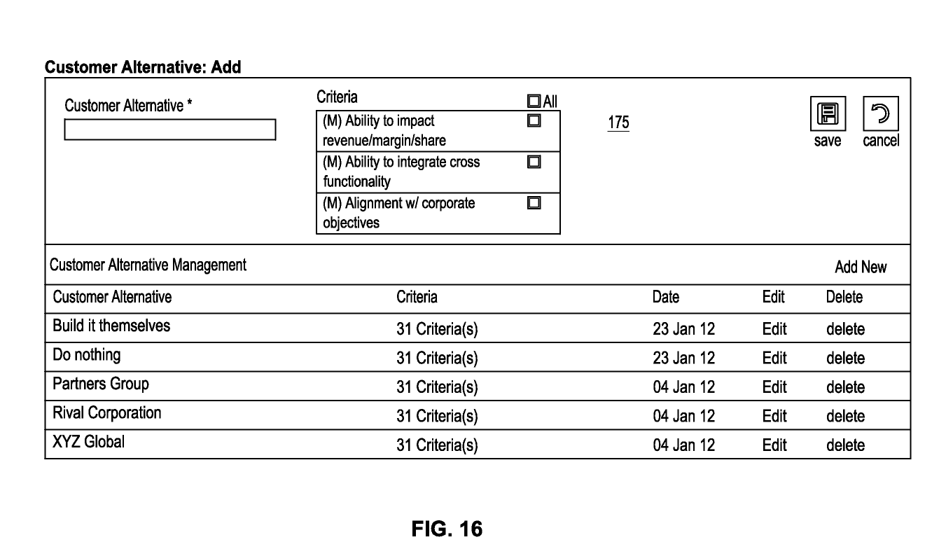

Referring to FIG. 15 illustrating the criteria add interface screen 170, a criteria entry field is provided where an administrator can enter a criteria. A stakeholder “selection” field is also provided where the administrator can select metadata comprising one of the stakeholders, added within the stakeholder entry field of the stakeholder add interface screen 165 of FIG. 14, desired to be associated with the entered criteria. A customer alternative “selection” field is further provided where the administrator can select metadata comprising one or more of the customer alternatives, which is added within the customer alternative entry field of the customer alternative add interface screen 175 of FIG. 16 (to be further discussed), desired to be associated with the entered criteria and stakeholder. After the criteria is entered within the criteria entry field and the stakeholder and customer alternative(s) are selected within their respective selection fields, the administrator clicks on the “save” icon. Upon clicking on the save icon, the processor 65 processes the information into CNA their side metadata 110 and stores it within the data-store (FIG. 3). The metadata criteria, stakeholder and number of associated customer alternatives are thereafter displayed in tabular form within the lower “management” half of the add criteria interface screen 170. Thus, as illustrated within FIG. 15, the exemplary criteria ranging from “ability to impact revenue/margin/share” to “user acceptance” have each been entered within the criteria entry field, associated with a selected stakeholder and one or more customer alternatives, and thereafter displayed as metadata within the management field of the criteria add interface screen 170.

Referring to FIG. 16 illustrating the customer alternative add interface screen 175, a customer alternative entry field is provided where an administrator can enter a customer alternative. A criteria “selection” field is also provided where the administrator can select metadata comprising one or more of the criteria, added within the criteria entry field of the criteria add interface screen 170 of FIG. 15, desired to be associated with the entered customer alternative. After the customer alternative is entered within the customer alternative entry field and the one or more criteria is selected within the criteria selection field, the administrator clicks on the “save” icon. Upon clicking on the save icon, the processor 65 processes the information into CNA their side metadata 110 and stores it within the data-store (FIG. 3). The metadata customer alternatives and number of associated criteria are thereafter displayed in tabular form within the lower “management” half of the customer alternative add interface screen 175. Thus, as illustrated within FIG. 16, the exemplary customer alternatives, including “build it themselves,” “do nothing,” “competitor 1 (i.e. Partners Group),” “competitor 2 (i.e., Rival Corporation),” and “competitor 3 (i.e., XYZ Global)” have each been entered within the customer alternative entry field, associated with one or more criteria, and thereafter displayed as metadata within the management field of the customer alternative add interface screen 175.

As evident within FIGS. 14, 15 and 16, the tabular management fields of the respective stakeholder, criteria and customer alternative add interface screens 165, 170 and 175 each illustrate an “edit” column allowing for the edit of each entered line item. Thus, upon selecting “edit” for a given line item within the respective stakeholder, criteria and customer alternative add interface screens of FIGS. 14, 15 and 16, respective stakeholder, criteria and customer alternative edit interface screens are displayed. FIGS. 17, 18 and 19 thus illustrate these respective screen shots of the edit interface screens 180, 185 and 190 for respectively editing the stakeholder, criteria and customer alternatives entered within the aforementioned add interface screens of FIGS. 14, 15 and 16.

Referring to FIG. 17 illustrating a stakeholder edit interface screen 180, a stakeholder edit field is provided where an administrator can edit a stakeholder based upon the edit line item selection made within the management field of the stakeholder add interface screen 165 of FIG. 14. A criteria edit “selection” field is also provided where the administrator can change metadata comprising one of the criteria, added within the criteria entry field of the criteria add interface screen 170 of FIG. 15, desired to be associated with the edited stakeholder. After the stakeholder is edited within the stakeholder edit field and the criteria is changed within the criteria edit selection field, the administrator clicks on the “save” icon. Upon clicking on the save icon, the processor 65 again processes the information into CNA their side metadata 110 and stores it within the data-store (FIG. 3). The metadata stakeholder is thereafter displayed in tabular form, along with the associated number of criteria, within the lower “management” half of the stakeholder edit interface screen 180. Thus, as illustrated within FIG. 17, the exemplary stakeholders of “senior management,” “purchasing,” “sales management,” and “training dept” have each been edited and/or added within the stakeholder edit or add field, associated with a selected criteria, and thereafter displayed as metadata within the management field of the stakeholder edit interface screen 180.

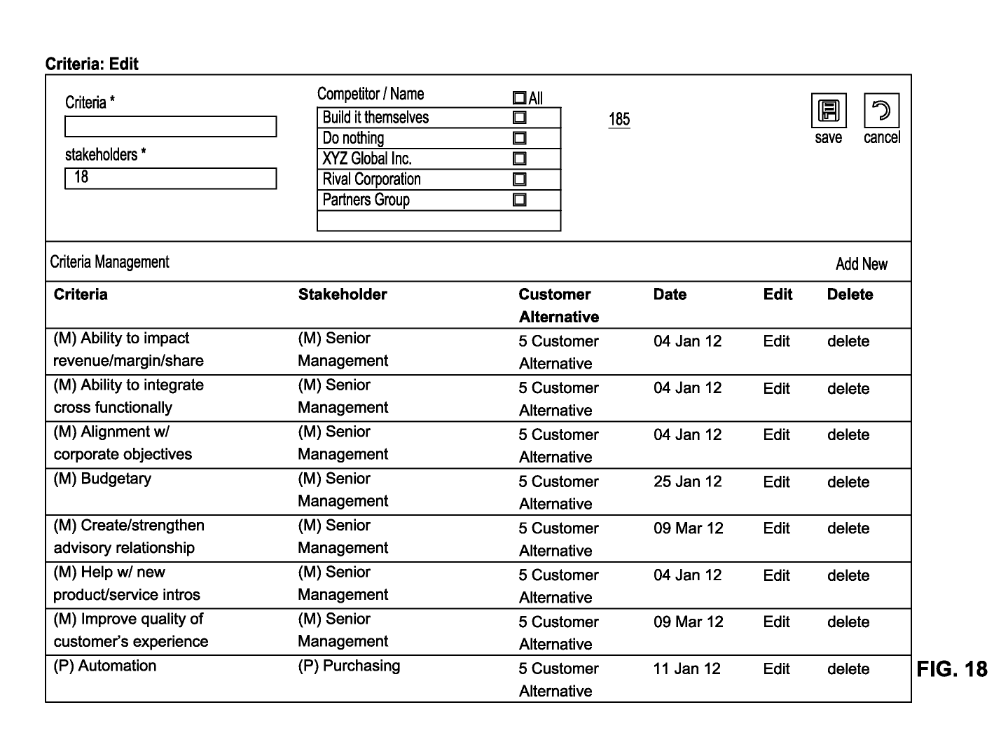

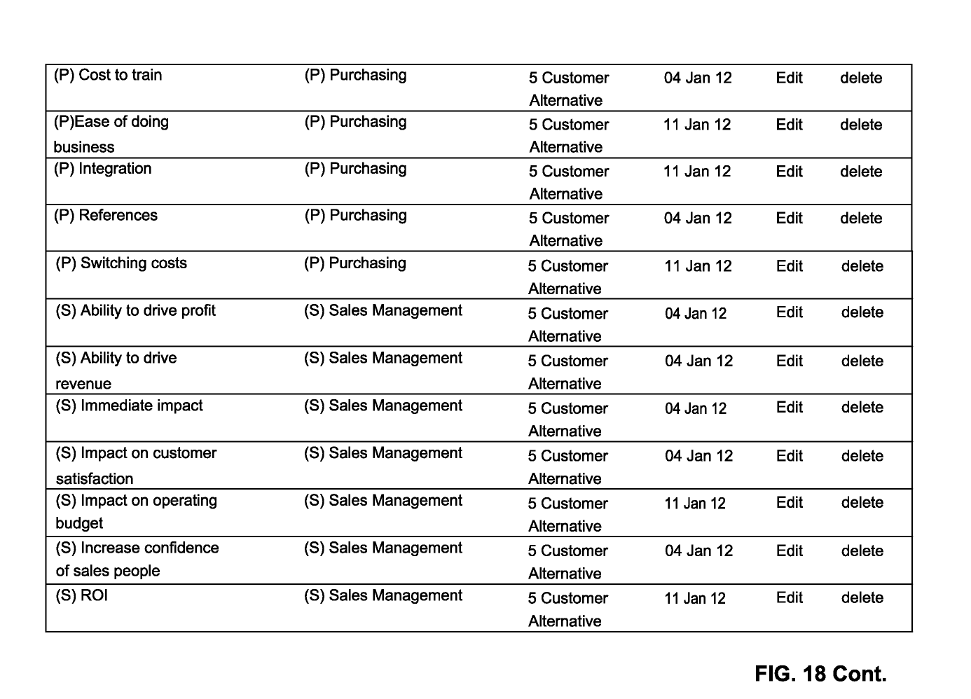

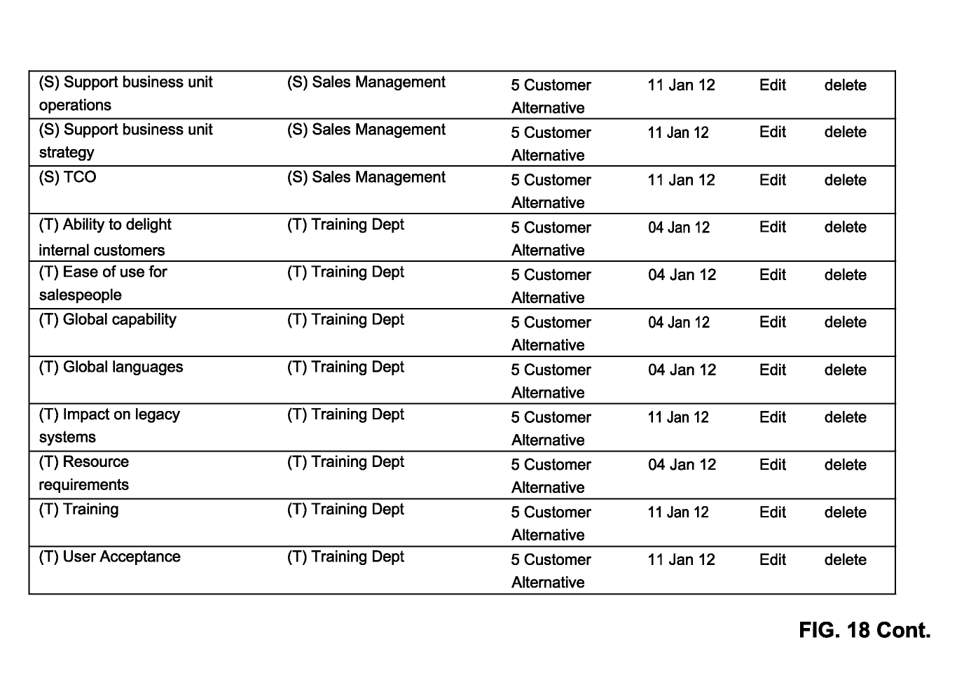

Referring to FIG. 18 illustrating the criteria edit interface screen 185, a criteria edit field is provided where an administrator can edit a criteria based upon the edit line item selection made within the management field of the criteria add interface screen 170 of FIG. 15. A stakeholder edit “selection” field is also provided where the administrator can change metadata comprising one of the stakeholders, added within the stakeholder entry field of the stakeholder add interface screen 165 of FIG. 14, desired to be associated with the entered criteria. A customer alternative edit “selection” field is further provided where the administrator can change metadata comprising one or more of the customer alternatives, which is added within the customer alternative entry field of the customer alternative add interface screen 175 of FIG. 16, desired to be associated with the edited criteria and selected stakeholder. After the criteria is edited within the criteria edit field and the stakeholder and customer alternative(s) are changed within their respective selection fields, the administrator clicks on the “save” icon. Upon clicking on the save icon, the processor 65 processes the information into CNA their side metadata and stores it within the data-store (FIG. 3). The metadata criteria, stakeholder and number of associated customer alternatives are thereafter displayed in tabular form within the lower “management” half of the criteria edit interface screen 185. Thus, as illustrated within FIG. 18, the exemplary criteria ranging from “ability to impact revenuemargin/share” to “user acceptance” have each been edited and/or added within the criteria edit or entry fields, associated with a stakeholder and one or more customer alternatives, and thereafter displayed as metadata within the management field of the criteria edit interface screen 185.

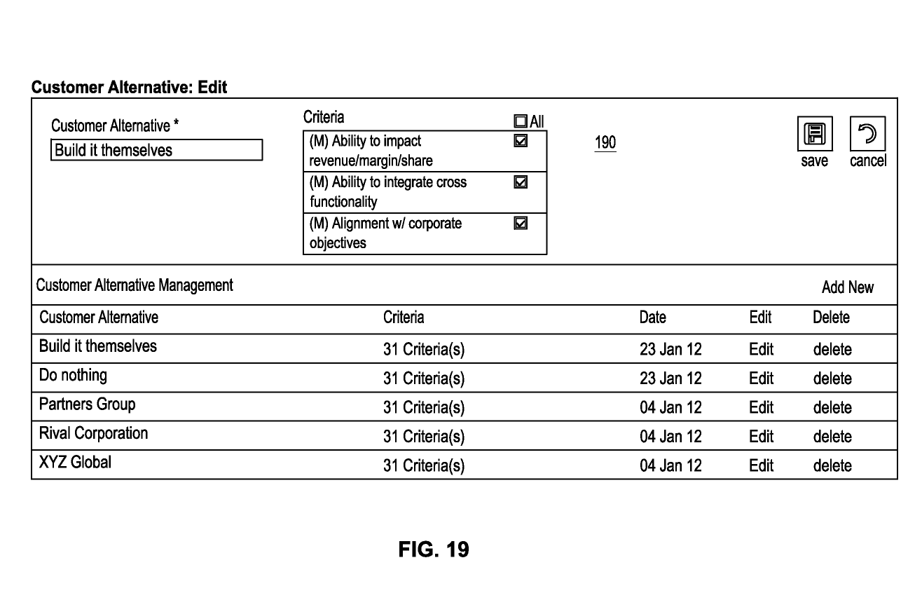

Referring to FIG. 19 illustrating the customer alternative edit interface screen 190, a customer alternative edit field is provided where an administrator can edit a customer alternative. A criteria edit “selection” field is also provided where the administrator can change metadata comprising one or more of the criteria, added within the criteria entry field of the criteria add interface screen 170 of FIG. 15, desired to be associated with the edited customer alternative. After the customer alternative is entered within the customer alternative edit field and the one or more criteria is changed within the criteria edit selection field, the administrator clicks on the “save” icon. Upon clicking on the save icon, the processor 65 processes the information into CNA their side metadata 110 and stores it within the data-store (FIG. 3). The metadata customer alternative and number of associated criteria are thereafter displayed in tabular form within the lower “management” half of the interface customer alternative edit interface screen 190. Thus, as illustrated within FIG. 19, the exemplary customer alternatives, including “build it themselves,” “do nothing,” “competitor 1 (i.e. Partners Group),” “competitor 2 (i.e., Rival Corporation)” and “competitor 3 (i.e., XYZ Global)” have each been edited and/or added within the edit or entry customer alternative fields, associated with one or more criteria, and thereafter displayed as metadata within the management field of the customer alternative edit interface screen 190.

As evident within FIGS. 17, 18 and 19, the tabular management fields of the respective stakeholder, criteria and customer alternative edit interface screens 180, 185 and 190 each illustrate an “edit” column allowing for the edit of each entered line item. Thus, upon selecting “edit” for a given line item within the respective stakeholder, criteria and customer alternative edit interface screens of FIGS. 17, 18 and 19, the respective “edit” stakeholder, criteria and customer alternative fields within the respective screens change to display the respective stakeholder, criteria or customer alternative selected for edit. After the stakeholders, criteria and customer alternatives are added or edited by the administrator within the master account 75, the processor of the computer system and method compiles the information such that the stakeholder, criteria and customer alternatives will become available as “available selections” to a user utilizing the CNA analysis for “their side” within the user account 80.

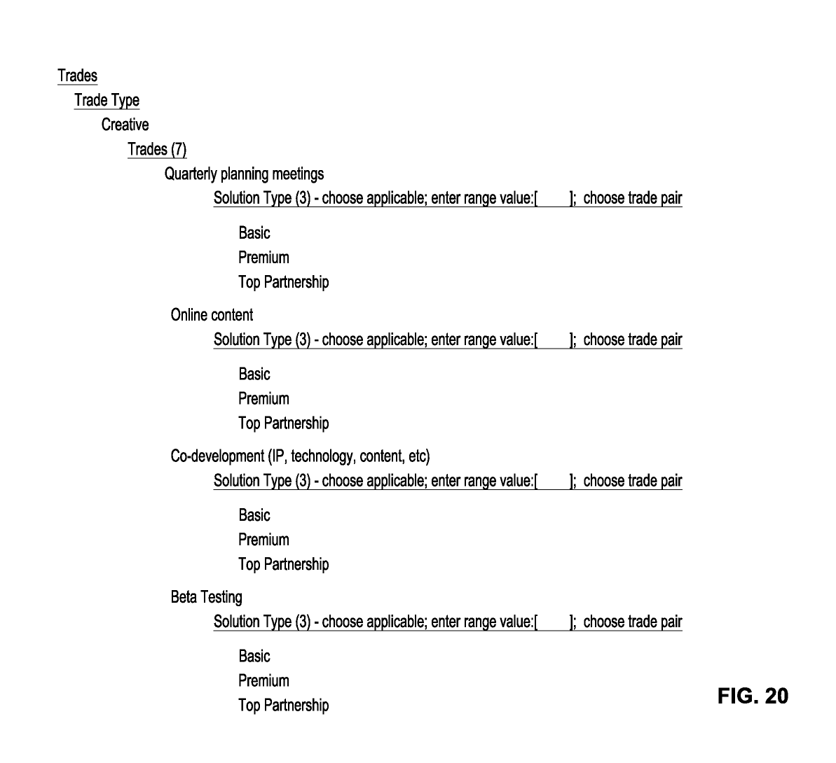

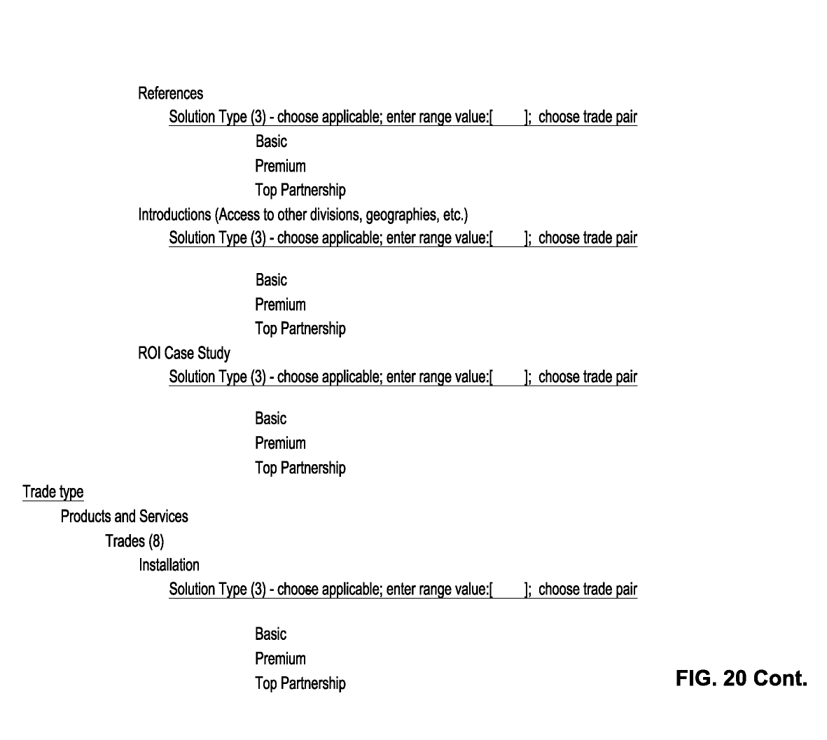

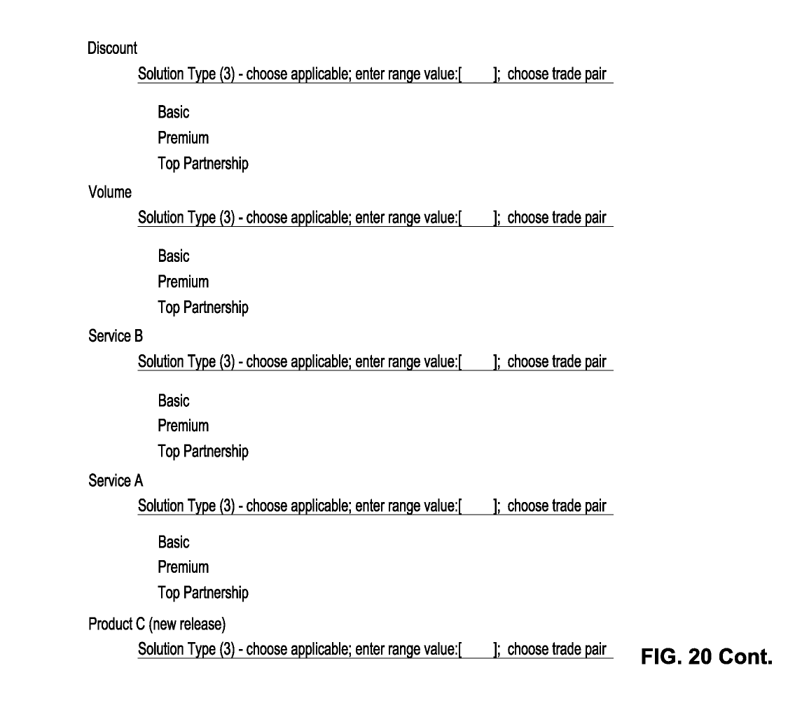

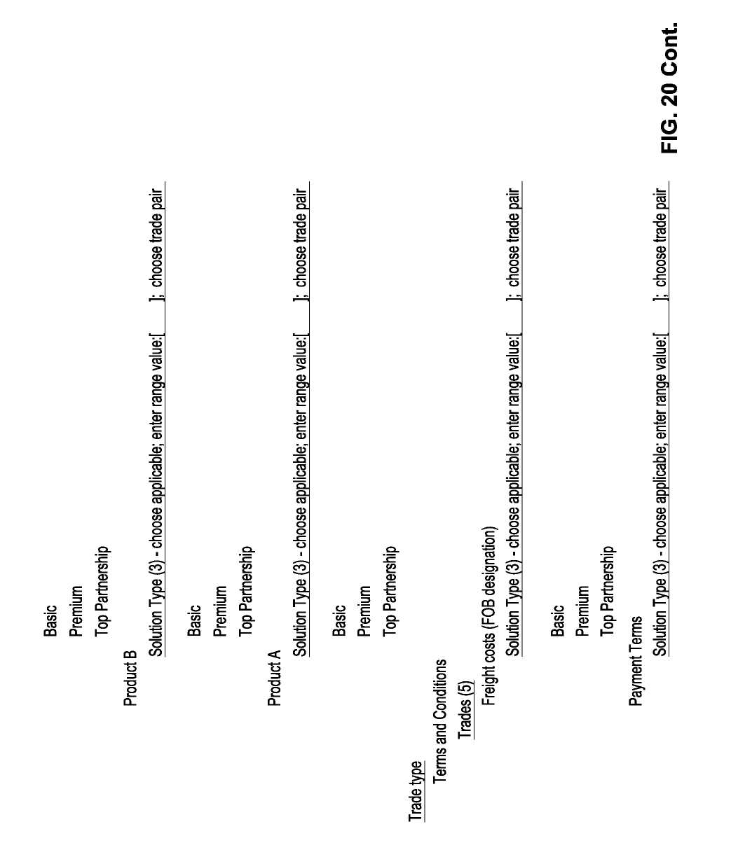

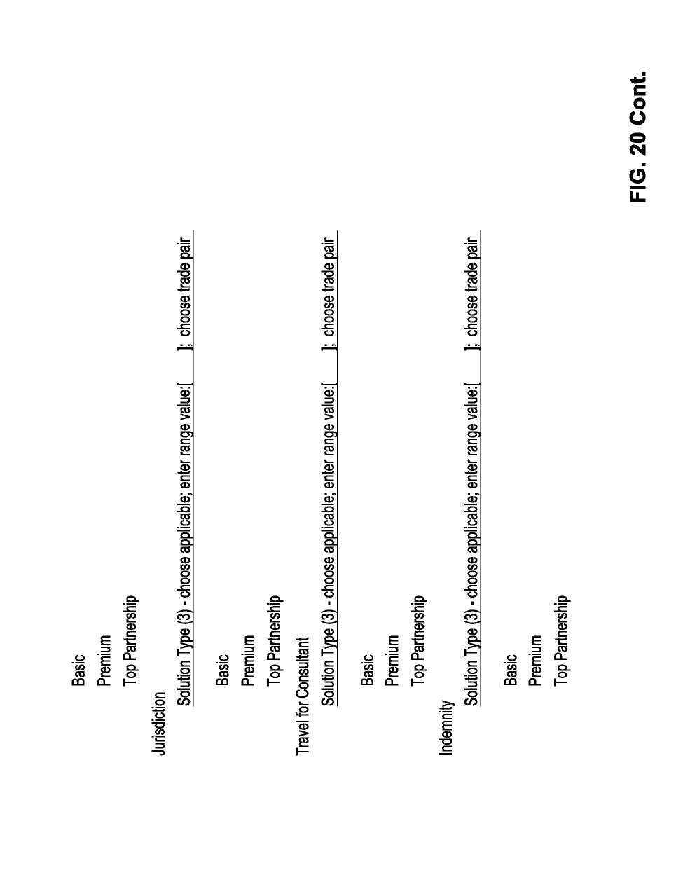

Turning now to a discussion of trades analysis data selection and input parameters of the negotiation blueprint master account, we again note that items may be traded, in lieu of, or to minimize, price reductions proposed by the buyer in reaching a sales agreement. Thus, as illustrated in the data structure of FIG. 20, trades information 95 and metadata 115 within the master account defines such trades, as well as related trade types and related solution types and related ranges. In defining trade types within the trades analysis 20 of the master account 75, administrators input or enter categories that define the types of trade that may occur in lieu of or to minimize possible price concessions by the seller. Although numerous trade types may be utilized, one embodiment of the negotiation blueprint 10 utilizes “creative,” “products and services” and “terms and conditions” trade types.

Falling within any of these trade types are the actual subject matter of the trades. For example, falling within the “creative” trade type are seven (7) trades: “quarterly planning meetings”; “online content”; and five remaining creative trade types. Falling within the “products and services” trade type are eight (8) trades: “installation”; “discounts”; and six remaining products and services trade types. Falling within the “terms and conditions” trade types are five (5) trades: “freight costs (FOB designation)”; “payment terms”; and three remaining trade types. Associated with each trade within each trade type are three (3) solution types, a range value and a designation of trade pair. With regard to the three solution types, such types may comprise: “basic”; “premium”; and “top partnership”. The range values, manually entered by the administrator, may comprise any value entered by the administrator. These range values may be utilized in enforcement provisions, to be further discussed. The trade pair designation may comprise a pairing of any of the trades, also as designated by the administrator. As with CNA information and metadata, the quantity and content of the trade types, trades and solution types are merely exemplary. As such, it is understood that any quantity and content of trade, trade type and solution type may be utilized.

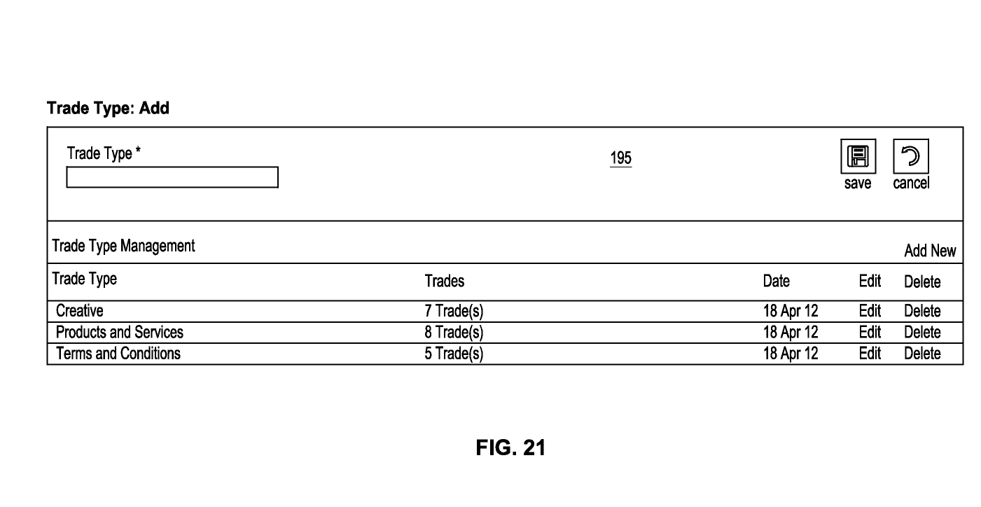

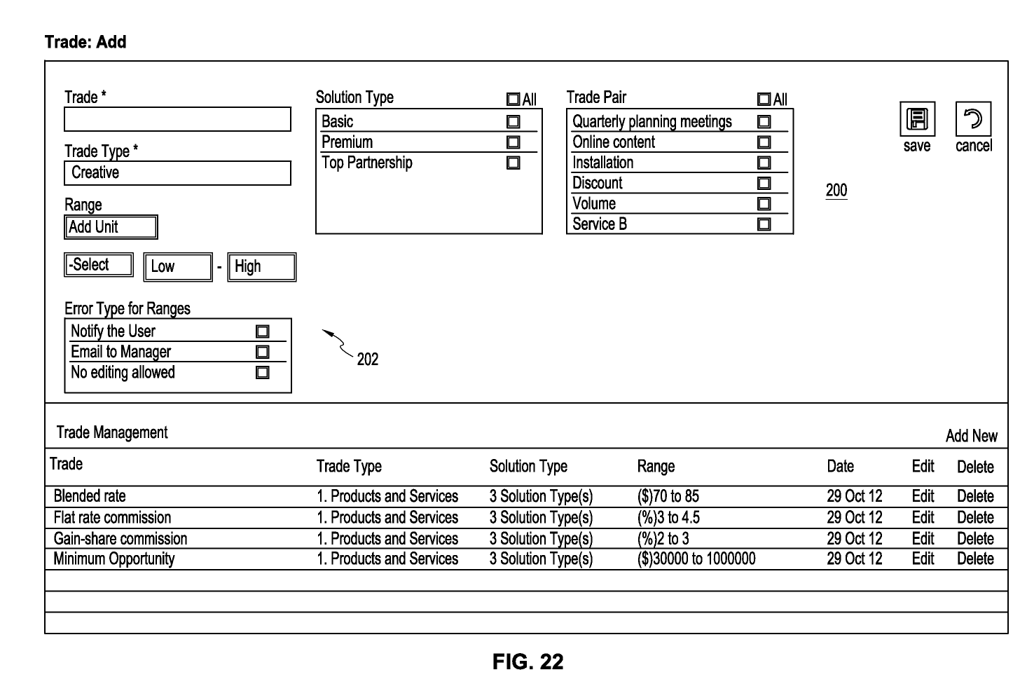

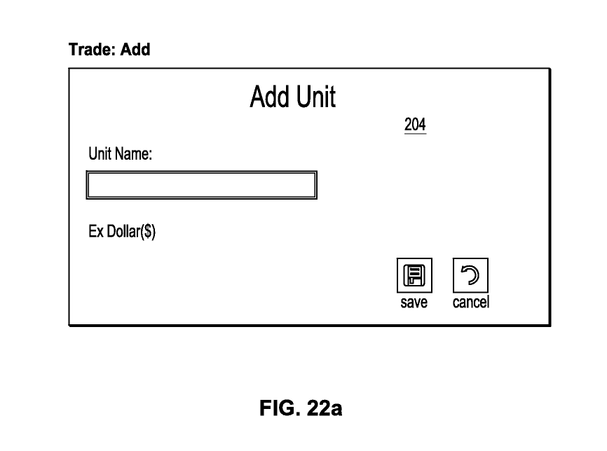

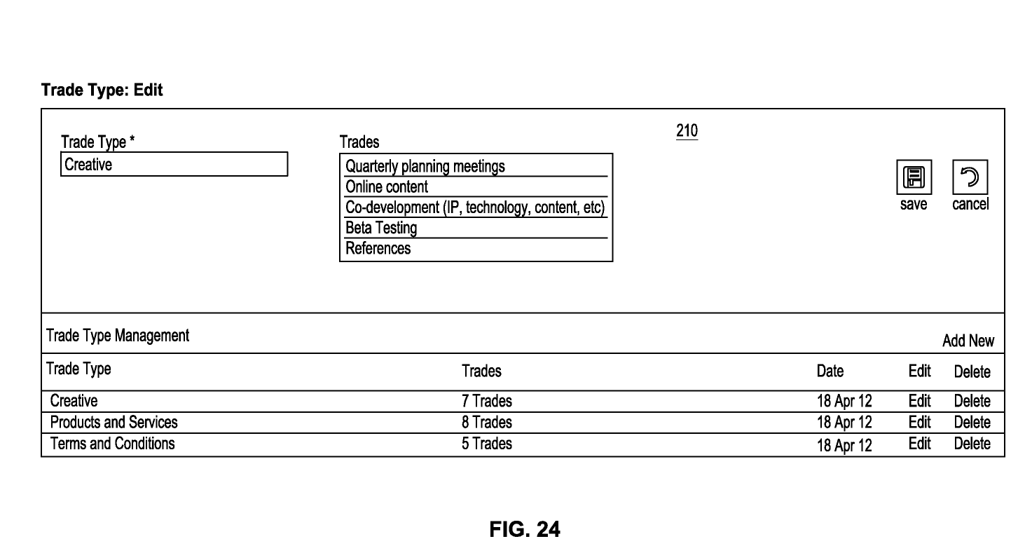

FIGS. 21, 22 and 23 illustrate screen shots of “add” interface screens 195, 200 and 205 for adding trade types, trades and solution types, respectively, while FIGS. 24, 25 and 26 illustrate screen shots of “edit” interface screens 210, 215 and 220 for respectively editing such trade types and solution types. Again, each interface screen is roughly divided into upper and lower halves. The upper half of each screen displays “add” or “edit” fields while the lower half of each screen displays “management” information fields. Referring to FIG. 21 illustrating a trade types add interface screen 195, a trade types field is provided where an administrator can enter a trade type. After the trade type is entered within the trade type entry field, the administrator clicks on the “save” icon. Upon clicking on the save icon, the processor 65 processes the information into trades metadata 115 and stores it within the data-store (FIG. 3). The metadata trade type and number of associated trades, which are added within the trades entry field of the trades add interface screen 200 of FIG. 22 (to be further discussed) are thereafter displayed in tabular form within the lower “management” half of the trades types add interface screen 195. Thus, as illustrated within FIG. 21, the exemplary trade types of “creative,” “products and services” and “terms and conditions” have each been entered within the trade type field, saved, and thereafter displayed as metadata within the management field of the trade types add interface screen 195. The number of trades (to be further discussed) associated with each of the foregoing line items are also respectfully displayed as metadata within the management field of the trade types add interface screen 195.

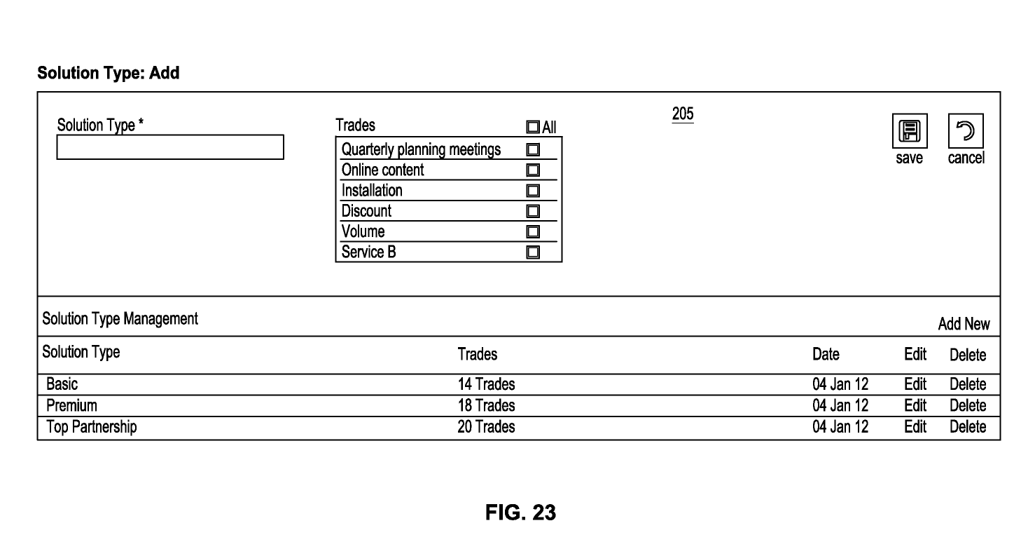

Referring to FIG. 22 illustrating a trades add interface screen 200, a trades entry field is provided where an administrator can enter a trade. A trade types “selection” field is also provided where the administrator can select metadata comprising one of the trade types, added within the trade type entry field of the trade types add interface screen 195 of FIG. 21, desired to be associated with the entered trade. A solution type “selection” field is further provided where the administrator can select metadata comprising one or more of the solution types, which are added within the solution type entry field of the solution type add interface screen 205 of FIG. 23 (to be further discussed), desired to be associated with the entered trade types and trade. For each trade added, a trade pair “selection” field is also provided. A corresponding trade (added during a previous entry of the trades entry field) is thus selected within the trade pair selection field to pair the corresponding trade with the trade entered within the trade entry field.

An enforcement provision 202 is also provided for each trade. The enforcement provision comprises a unit selection field, a range entry field (representing low and high values), an “add unit” button, and a rule enforcement selection box. Thus, for a given trade entered within the trade entry field, along with corresponding selected trade types, solution types and trade pairs, a unit is selected from within the unit selection field and corresponding low and high values for the unit are entered within the range entry fields. For example, a selected unit could comprise a quantity number (#); a dollar (S); a kilogram mass (Kg); a meter length (M); or any other common quantifying unit or measure. The range entered may be any range of the unit or measure as defined between a low value and a high value.

If a given unit is not available within the unit selection field, the “add unit” button can be actuated to cause a supplemental entry screen 204 to appear (FIG. 22a), thus allowing the administrator to enter a desired unit (i.e., hours or other unit) within a unit entry field. After the desired unit is entered, the administrator actuates the save button, and is returned to the screen of FIG. 22. The unit is thus saved as metadata in the data-store (FIG. 3) and will thus now appear within the unit selection field of FIG. 22.

The enforcement rules of the enforcement provision 21 are illustrated within the enforcement selection box, namely, “Notify the User,” “Email the Manager” and ““No editing Allowed.” If no enforcement rule is selected within the enforcement selection box, a default rule of “Do Nothing” is applied. The enforcement rules utilize the ranges input within the master account in relation to a given trade. The enforcement rules are applied within the user account when a user enters a given trade value. Any such trade value entered by a user is thus compared by the processor (i.e., as a comparator utilizing a conditional construct; if-then-else logic) with the related metadata range. If the value does not fall within the range, one of the foregoing four enforcement rules (default rule plus three selections) is applied by the processor. Each of the four enforcement rules (default rule plus three selections) thus represents an action that must occur in relation to the foregoing range selection:

1. Do Nothing (default)—allows the user to enter any amount as a trade value regardless of the range specified and displayed;

2. Notify the User—allows the user to enter any amount as a trade value, but notifies the user via a pop-up window when the value entered is outside the range specified and displayed;

3. Email the Manager—allows the user to enter any amount as a trade value, but notifies the user via a pop-up window when the value entered is outside the range specified and displayed, and sends an email notification to the user's manager; or

4. No Editing Allowed—no editing of the specified range is allowed for a specified trade within the trades analysis section, the user is not allowed to enter a value outside the specified range within the MEO section, and the value will default to the nearest high or low value within the range.

The foregoing rules may thus be utilized by the administrator to influence the trade values entered by the user. After the trade is entered within the trade entry field, the trades type and solution type(s) are selected within their trades type and solution type respective selection fields, the corresponding trade is selected within the trade pair selection field, a unit is selected or entered with the associated range, and an enforcement rule is optionally selected, the administrator clicks on the “save” icon. Upon clicking on the save icon, the processor 65 processes the information into trades metadata 115 and stores it within the data-store (FIG. 3). The metadata trades, trades type, range, and number of associated solution types are thereafter displayed in tabular form within the lower “management” half of the trades add interface screen 200. Thus, as illustrated within FIG. 22, the exemplary trades from “Blended Rate” to “Minimum Opportunity” have each been entered within the trades entry field, associated with a trade type, range and one or more solution types, and thereafter displayed as metadata within the management field of the trades add interface screen 200.

Referring to FIG. 23 illustrating the solution type add interface screen 205, a solution type entry field is provided where an administrator can enter a solution type. A trades “selection” field is also provided where the administrator can select metadata comprising one or more of the trades, added within the trades entry field of the trades add interface screen 200 of FIG. 22, desired to be associated with the solution type. After the solution type is entered within the solution type entry field and the one or more trades are selected within the trades selection field, the administrator clicks on the “save” icon. Upon clicking on the save icon, the processor 65 processes the information into trades metadata 115 and stores it within the data-store (FIG. 3). The metadata solution type and number of associated trades are thereafter displayed in tabular form within the lower “management” half of the solution type add interface screen 205. Thus, as illustrated within FIG. 23, the exemplary solution types, including “basic,” “premium” and “top partnership” have each been entered within the customer alternative entry field, associated with one or more trades, and thereafter displayed as metadata within the management field of the solution type add interface screen 205.

As evident within FIGS. 21, 22 and 23, the tabular management fields of the respective trade type, trades and solution type add interface screens 195, 200 and 205 each illustrate an “edit” column allowing for the edit of each entered line item. Thus, upon selecting “edit” for a given line item within the respective trade type, trades and solution type add interface screens of FIGS. 21, 22 and 23, respective trade type, trades and solution type edit interface screens are displayed. FIGS. 24, 25 and 26 thus illustrate these respective screen shots of the “edit” interface screens 210, 215 and 220 for respectively editing the trade type, trades and solution type entered within the aforementioned add interface screens 195, 200 and 205 of FIGS. 21, 22 and 23.

Referring to FIG. 24 illustrating a trade type edit interface screen 210, a trade type edit field is provided where an administrator can edit a trade type based upon the edit line item selection made within the management field of the trade type add interface screen 195 of FIG. 21. A trades edit “selection” field is also provided where the administrator can change metadata comprising one of the trades, added within the trades entry field of the trades add interface screen 200 of FIG. 22, desired to be associated with the edited trade type. After the trade type is edited within the trade type edit field and the trades are changed within the trades edit selection field, the administrator clicks on the “save” icon. Upon clicking on the save icon, the processor 65 again processes the information into trades metadata 115 and stores it within the data-store (FIG. 3). The metadata trade type is thereafter displayed in tabular form, along with the associated number of trades, within the lower “management” half of the trade type edit interface screen 210. Thus, as illustrated within FIG. 24, the exemplary trade types of “creative,” “products and services” and “terms and conditions” have each been edited and/or added within the trade type edit or add field, associated with selected trades, and thereafter displayed as metadata within the management field of the trade type edit interface screen 210.

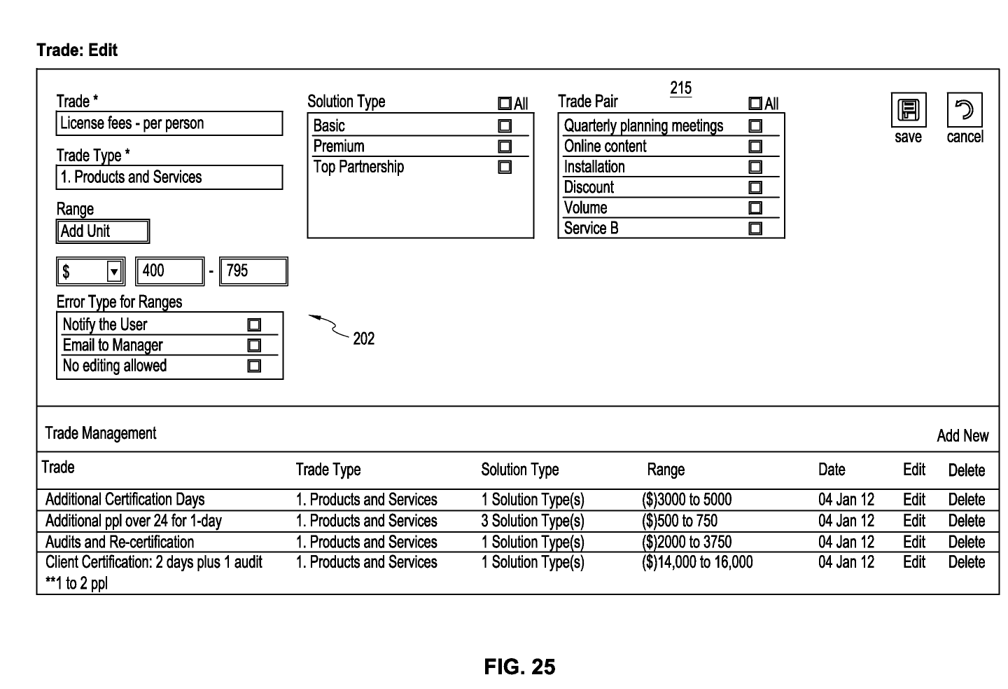

Referring to FIG. 25 illustrating the trades edit interface screen 215, a trades edit field is provided where an administrator can edit a trade. A trade type edit “selection” field is also provided where the administrator can change metadata comprising one of the trade types, added within the trade type entry field of the trade type add interface screen 195 of FIG. 21, desired to be associated with the edited trade. A solution type edit “selection” field is further provided where the administrator can change metadata comprising one or more of the solution types, which is added within the solution type entry field of the solution type add interface screen 205 of FIG. 23, desired to be associated with the edited trade type and trade. For each trade, a range edit field and trade pair edit “selection” field are also provided. A corresponding trade is changed within the trade pair edit selection field to create the trade pair, with the trades edited within the trades edit field. The enforcement provision 202 may also be edited as well. Thus, the unit selection field, a range entry fields and rule selection box may each be edited, with the “add unit” button utilized (along with unit entry screen 204 of FIG. 22a) to add any unit not available for edit within the unit selection field.

After the trades are edited within the trades edit field, the trade type and solution type(s) are changed within their respective trade type and solution type edit selection fields, the trade pair edited within the trade pair edit selection field, the unit is edited with the associated range, and an enforcement rule is optionally edited, the administrator clicks on the “save” icon. Upon clicking on the save icon, the processor 65 again processes the information into the trades metadata 115 and stores it within the data-store (FIG. 3). The metadata trades, trade type, range and number of associated solution types are thereafter again displayed in tabular form within the lower “management” half of the trades edit interface screen 215. Thus, as illustrated within FIG. 25, the exemplary trades ranging from “additional certification days” to “ppl” have each been edited and/or added within the trades edit or entry fields, associated with a trade type, range and one or more solution types, and thereafter displayed as metadata within the management field of the trades edit interface screen 215.

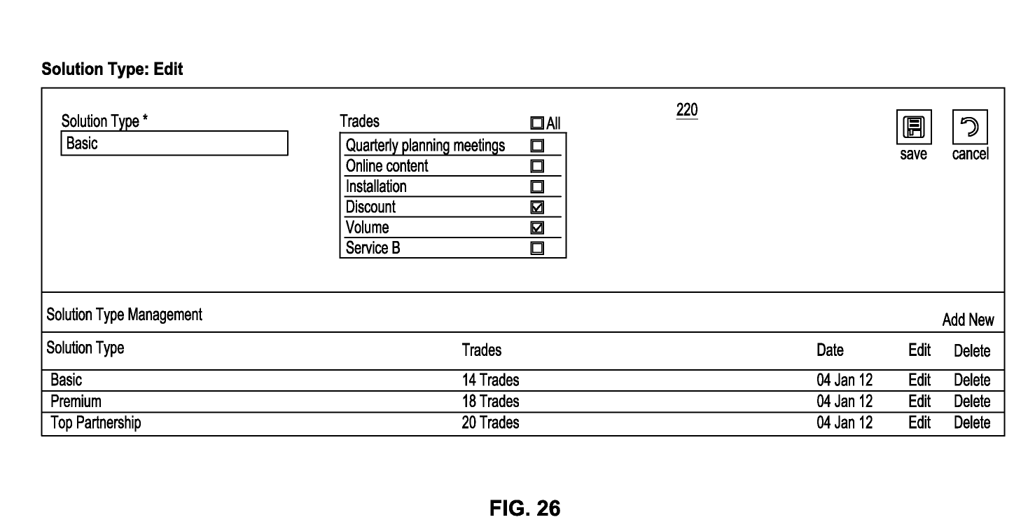

Referring to FIG. 26 illustrating the solution type edit selection screen 220, a solution type edit field is provided where an administrator can edit a solution type. The trades edit “selection” field is also provided where the administrator can change metadata comprising one or more of the trades, added within the trades entry field of the trades add interface screen 200 of FIG. 22, desired to be associated with the solution type. After the solution type is edited within the solution type edit field and the one or more trades are selected within the trades edit selection field, the administrator clicks on the “save” icon. Upon clicking on the save icon, the processor 65 processes the information into trades metadata 115 and stores it within the data-store (FIG. 3). The metadata solution type and number of associated trades are thereafter again displayed in tabular form within the lower “management” half of the solution types edit interface screen 220. Thus, as illustrated within FIG. 26, the exemplary solution types, including “basic,” “premium,” and “top partnership” have each been edited and/or added within the customer alternative edit or entry fields, associated with one or more trades, and thereafter displayed as metadata within the management field of the solution types edit interface screen 220.

As evident within FIGS. 24, 25 and 26, the tabular management fields of the respective trade type, trades and solution type edit interface screens 210, 215 and 220 each illustrate an “edit” column allowing for the edit of each entered line item. Thus, upon selecting “edit” for a given line item within the respective trade type, trades and solution type edit interface screens of FIGS. 24, 25 and 26, the respective “edit” trade type, trades and solution type fields within the respective screens change to display the respective trade type, trade or solution type selected for edit. After the trade type, trades or solution types are edited and/or added by the administrator within the master account 75, the processor of the computer system and method compiles the information such that the trade type, trades and solution type will become available as “available selections” to the user utilizing the trades analysis for both “our side” and “their side” trades within the user account 80. It is noted that although the master account does not classify the trade types, trades and solution types metadata as “our side” (i.e., seller) and “their side” (i.e., buyer), the computer nonetheless compiles the forgoing information such that the user may classify the trades as “our side” and “their side” within the user account.

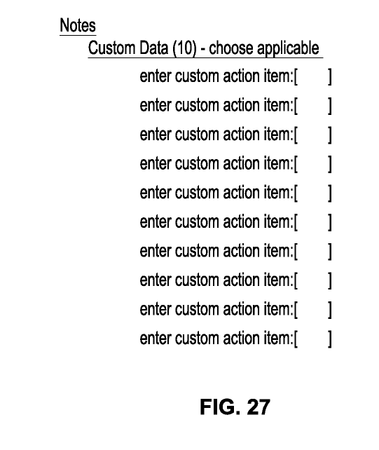

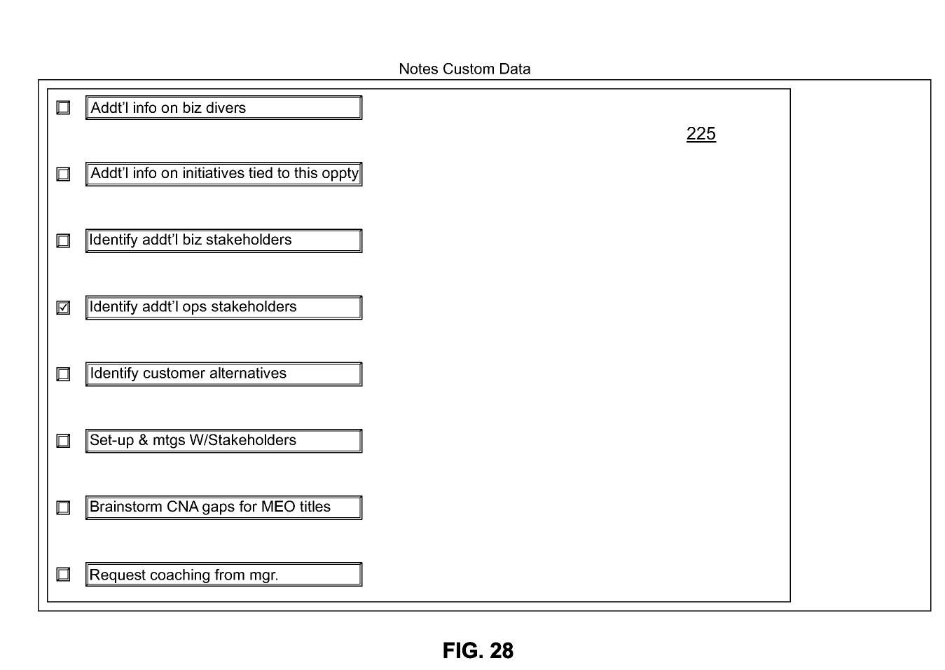

Turning now to a discussion of notes pertaining to the negotiation blueprint, we note that the information and metadata within the master account may comprise custom data relating to the blueprint. As illustrated in the data structure of FIG. 27, such organizational custom data within the master account 75 may include ten (10) action items that may be entered and selected. As with CNA and trades information entered within the master account, the quantity and content of the notes action items are merely exemplary. As such, it is understood that any quantity and content of action item may be utilized. Thus, referring to FIG. 28 illustrating the notes custom data add/edit interface screen 225, at least one custom data entry/edit field is provided. After a custom item is entered or edited within the custom data entry/edit field, the administrator clicks on the “save” icon. Upon clicking on the save icon, the processor 65 processes the information into metadata and stores it within the data-store (FIG. 3). Thus, as illustrated within FIG. 28, the exemplary custom data includes “addt'l info on biz drivers,” “addt'l info on initiatives tied to this opportunity,” and “identify addt'l biz stakeholders,” etc. have each been edited and/or added within the custom data entry/edit fields, and thereafter displayed as metadata within the notes user account 80 as custom data selection fields.

Referring to FIG. 29 and a discussion of the user account 80, a population of data is allowed utilizing metadata establishing the data selection and input parameters defined by the administrators of the master account 75. In one embodiment, the at least one user account 80 utilizes these metadata to populate data defining a negotiation for a specific client or account and to create other metadata for the user. Through these data selection and input parameters of the metadata, the underlying information is available as “available selections” to users utilizing the at least one user account 80 to create the negotiation blueprint 10. The completed negotiation blueprint is thereafter displayed to the user, exported to another software program, or made the basis of one or more reports (to be further discussed).

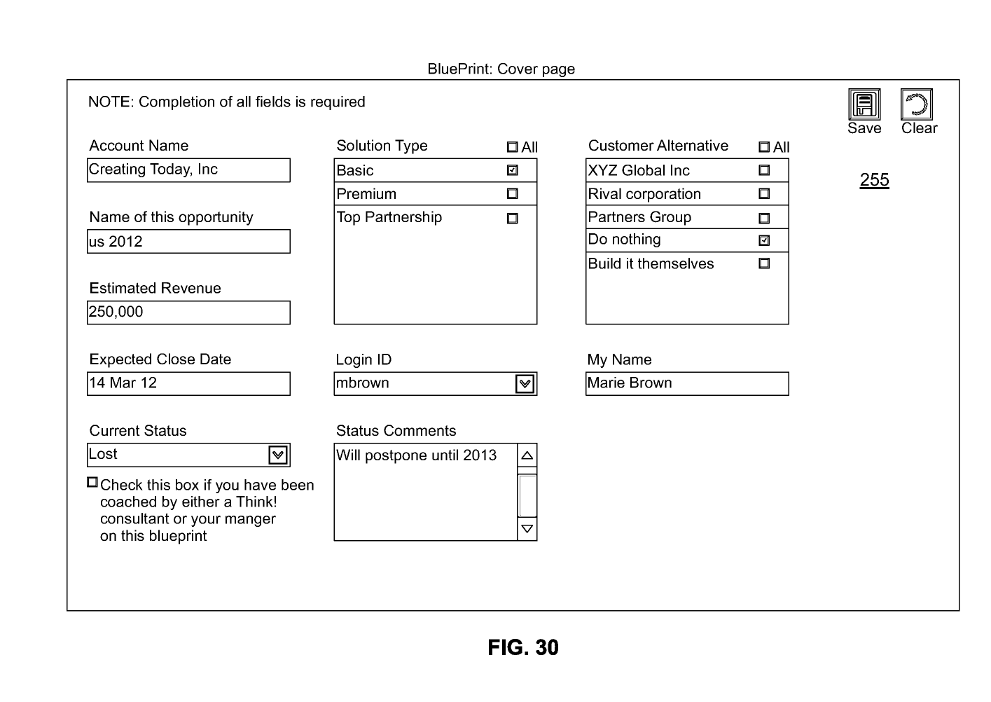

With regard to the at least one user account 80, the at least three steps of the negotiation process again comprise CNA analysis 15, trades analysis 20 and multiple equal offers compilation 25. More specifically and referring to FIG. 30, access to the at least one user account 80 is provided to allow a user to populate data to create a buyer-specific: negotiation blueprint “cover page” 230; negotiation blueprint CNA analysis for both our side 235 and their side 240; negotiation blueprint trades 245; negotiation blueprint MEOs 250; and negotiation blueprint notes 252. Metadata establishing the data selection and input parameters defined by the administrators of the master account 75 is drawn from one or more data-stores and used by the user to populate the foregoing negotiation blueprint parts. The user thereafter populates data within the data selection and input parameters of the metadata, with the processor 65 processing the metadata and data to create the buyer-specific negotiation blueprint.

Thus, in one embodiment: accounts metadata 82, CNA their side metadata 110 and trades metadata 115 are drawn from one or more data-stores, populated by the user, and processed by the processor 65 to create the negotiation blueprint cover 230; CNA our side metadata 105 are drawn from one or more data-stores, populated by the user and processed by the processor 65 to create the negotiation blueprint CNA for our side 235; CNA their side metadata 110 are drawn from one or more data-stores, populated by the user and processed by the processor to create the negotiation blueprint CNA for their side 240; trades metadata 115 are drawn from one or more data-stores, populated by the user and processed by the processor 65 to create the negotiation blueprint trades 245; trades metadata 115 and MEO metadata 120 are drawn from one or more data-stores, populated by the user and processed by the processor 65 to create the negotiation blueprint MEOs 250; and notes metadata 120 are drawn from one or more data-stores, populated by the user and processed by the processor 65 to create negotiation blueprint notes 252.

Referring to FIG. 30, which illustrates a screen shot of a negotiation blueprint cover interface screen 255, several fields are provided where a user can enter or edit data. In one embodiment, “account name,” “opportunity name,” “estimated revenue,” “expected close date,” “current status,” “status comments,” “login ID” and “my name” user entry fields are provided. Within the “account name” entry field, the user enters the account name of the buyer account to which the negotiation blueprint 10 applies in negotiating a sales transaction. Within the “opportunity name” entry field, the user enters the opportunity name by which the account is named within the seller's company. Within the “estimated revenue” entry field, the user enters the estimated revenue to be made by the seller in successfully negotiating the sales transaction with the buyer underlying the account name. Within the “expected close date” entry field, the user enters the expected close date upon which a successful negotiated sales transaction with the buyer will occur or “close.” Within the “current status” entry field, the user enters the current status of the negotiation and sales transaction between the seller and buyer. Within the “status comments” entry field, the user enters any helpful status comments relating to and/or explaining the status entered within the current status entry field. Within the “login ID” entry field, the user enters a login identification created for accessing the buyer-specific account and precluding access to the account by other users not having the same ID. Within the “my name” entry field, the user enters his or her name or that of a user associated with the login identification. The user can edit the underlying information within the fields of the interface screen of FIG. 30 as well. Again, while specific data are entered within the various fields of the foregoing examples, it is understood that these data are exemplary and that any data may be entered.

Along with entering or editing data within the above-recited fields of the blueprint cover interface screen 255 of FIG. 30 to populate the underlying data, a user also utilizes the metadata of one or more “selection fields” to further define the negotiation blueprint for the underlying buyer-specific account. In the embodiment illustrated in FIG. 30, a “solution type” user selection field and “customer alternative” selection user selection field are both provided. It is noted that the information comprising the “solution type” and “customer alternative” user selection fields are metadata obtained from the master account 75. Referring again to FIGS. 13, 20 and 29, the “solution type” selection field comprises “trades” metadata 115 while the “customer alternatives” selection field comprises “CNA their side” metadata 110, both obtained from the master account 75. Thus, a user can select one or more of the “basic,” “premium,” or “top partnership” solution types for association with the underlying buyer-specific account, while also selecting one or more of the “do nothing,” “build it themselves,” “competitor 1,” “competitor 2,” or “competitor 3,” customer alternatives for association with the same.

After the user entry information is entered or edited within the various fields and the solution type(s) and customer alternative(s) user selections are selected within their respective selection fields, the user clicks on the “save” icon. Upon clicking on the save icon, the processor processes the information into the blueprint cover page 255 and stores it within the data-store (FIG. 3). Any changes to the foregoing fields will also appear within the supplemental blueprint cover edit interface screen 135 (FIG. 6) within the master account 75.

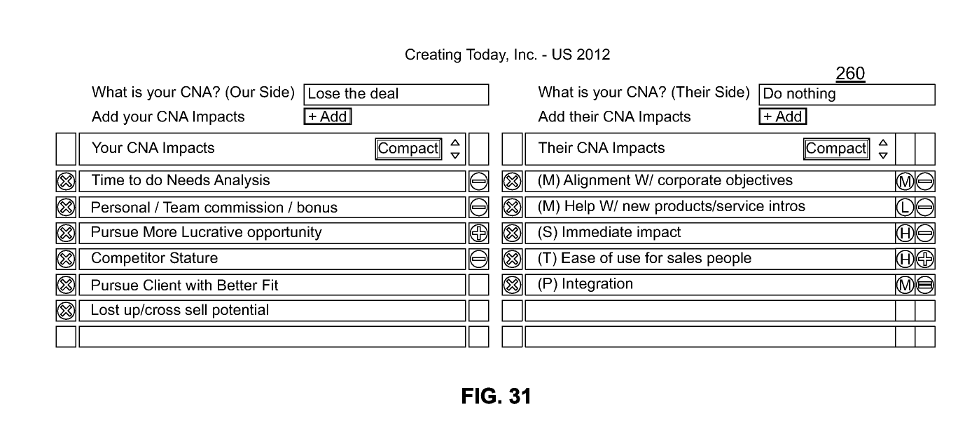

With regard to negotiation blueprint CNA analyses 235 and 240 within the user account 80, as illustrated in negotiation blueprint CNA analysis interface screen 260 of FIG. 31, a user is allowed to populate data within two columns, namely a column representing the consequences of no agreement for “our side” (i.e., the seller) and a column representing the consequences of no agreement for “their side” (i.e., the buyer). Starting initially with the CNA column for our side, the user of the at least one user account 80 can list the different impacts on the seller if the seller does not reach an agreement with the buyer. In doing so, the user accesses the CNA our side metadata 105 of the master account 75 by clicking on the CNA our side metadata Add button.

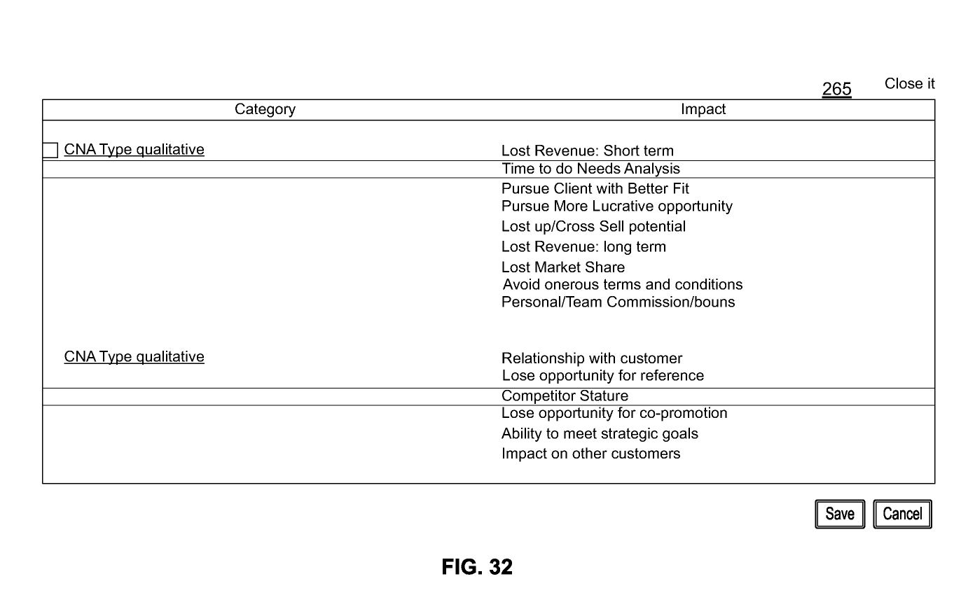

Clicking on the CNA our side metadata Add button causes a CNA our side supplemental interface screen 265 (FIG. 32) to appear. Within the CNA our side supplemental interface screen of FIG. 32, the user can thus choose a category (i.e., either quantitative or qualitative) and thereafter choose an impact from within that category. For example, as illustrated in FIG. 32, the user has selected the quantitative category and has thereafter selected the “time to do need analysis” impacts metadata from the master account 75. Similarly, from within the qualitative category, the user has thereafter selected the “competitor stature” impacts metadata, again from the master account. Although the foregoing category and impact metadata have been selected within the CNA our side supplemental interface screen 265 of FIG. 32, it is noted that any category and impact metadata from the CNA our side metadata 105 of the master account 75 may have been selected.

After selecting the category and impact metadata within the CNA our side supplemental interface screen 265 of FIG. 32, the user clicks on the Save button and returns to the negotiation blueprint CNA analysis interface screen 260 of FIG. 31 to find the selected impact(s) listed within the CNA column for our side. The user may optionally thereafter assign a value to each selected impact for each category reflecting how each impact will affect the seller: a “+” (plus sign) for positive; a “−” (minus sign) for negative; or a “_” (blank) for neutral or unknown at this time. The plus sign reflects that the impact will have a positive effect on the seller, the minus sign reflects that the impact will have a negative effect on the seller while the blank reflects that the impact has neither been determined as a positive or negative effect on the seller. Thus, for example, with regard to the impacts chosen within the CNA our side supplemental interface screen 265 of FIG. 32 for inclusion within the CNA column for our side if FIG. 31, the user has chosen to assign both the “time to do need analysis” impact and “competitive stature” impact with a minus sign to signify that each impact has a negative effect on the seller.

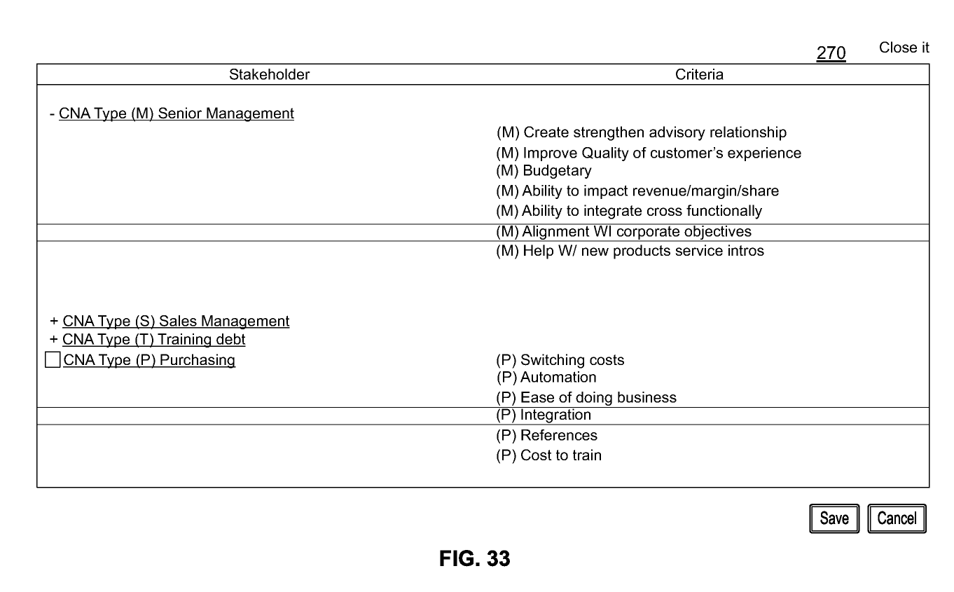

Referring again to FIG. 31, within the CNA column for their side, the user of the at least one user account 80 can list the different criteria relating to a stakeholder of the buyer if the seller does not reach an agreement with the buyer. In doing so, the user accesses the CNA their side metadata 110 of the master account 75 by clicking on the CNA their side metadata Add button. Clicking on the CNA their side metadata Add button causes a CNA their side supplemental interface screen 270 (FIG. 33) to appear. Within the CNA their side supplemental interface screen of FIG. 33, the user can thus choose a stakeholder (i.e., either “senior management,” “purchasing,” “sales management” or “training department”) and thereafter choose a criteria relating to that stakeholder. For example, as illustrated in FIG. 33, the user has selected the senior management stakeholder category and has thereafter selected the “alignment w/ corporate objectives” criteria metadata from the master account 75. Similarly, from within the purchasing stakeholder category, the user has thereafter selected the “integration” criteria metadata, again from the master account. Although the foregoing stakeholder and criteria metadata have been selected within the CNA their side supplemental interfaces screen 270 of FIG. 33, it is noted that any stakeholder and criteria metadata from the CNA their side metadata 110 of the master account 75 may have been selected.

After selecting the stakeholder and criteria metadata and within the CNA their side supplemental interface screen 270 of FIG. 33, the user clicks on save and returns to the negotiation blueprint CNA analysis interface screen 260 of FIG. 31 to find the selected criteria listed within the CNA their side column. The user can thereafter assign a value to each selected criteria for each stakeholder reflecting how, in relation to each criteria, the seller's offer compares to the competitor's offer: the “+” (plus sign) for positive; the “−” (minus sign) for negative; or an “=” (equal sign) for equal. For each criteria, the plus sign reflects that the seller's offer is better than the competitor's offer, the minus sign reflects that seller's offer is worse than the competitor's offer, while the equal sign reflects that the seller's offer is equal to the competitor's offer. The user can also assign an importance level to the selected criteria for each stakeholder reflecting a level of importance of the selected criteria to the buyer: an “H” for high; an “M” for medium; and an “L” for low. The “H” reflects that the criteria will have a high level of importance to the buyer, the “M” reflects that the criteria will have a medium level of importance to the buyer while the “L” will reflect that the criteria will have a low level of importance to the buyer.

Thus, for example, with regard to the criteria chosen within the CNA their side supplemental interface screen 270 of FIG. 33 for inclusion within the CNA column for their side of FIG. 31, the user has chosen to assign the “alignment with corporate objectives” criteria with a “minus” value and “medium” importance level while assigning the “integration” criteria with an “equal” value and “medium” importance level to signify the value and importance of each criteria in relation to the buyer. Optimally, the seller will note criteria that is both of “high importance” (i.e., “H”) to the buyer and reflects that the seller's offer is better (i.e., “+”) than the competitor's (i.e., reflects that the seller has a competitive advantage over the competitor). All such criteria designated as “H+” are further compiled by the processor 65 as metadata to appear within the negotiation blueprint MEOs 250 of the user account 80 (to be further discussed). Furthermore, the information of the impact and criteria columns of FIG. 31 may be compacted by clicking the compact button to remove gaps from between line items.

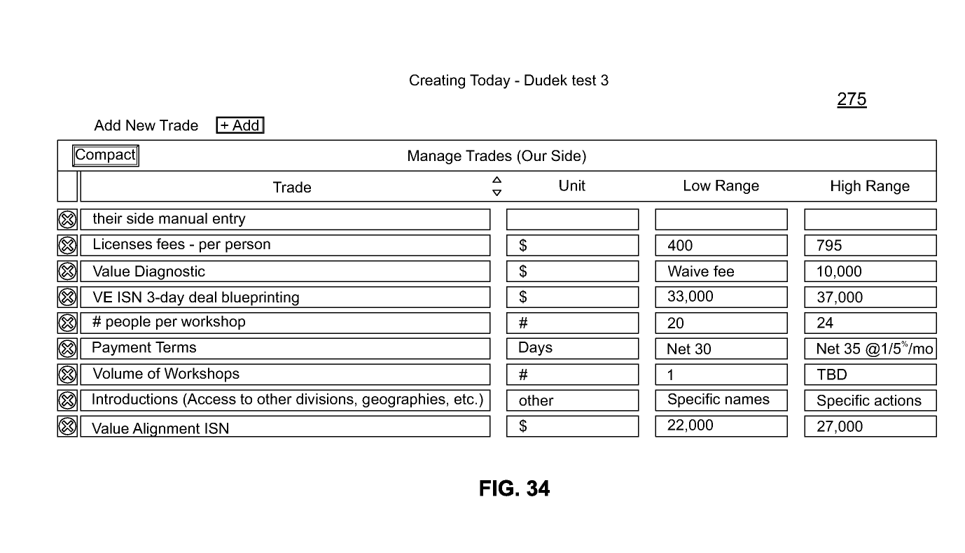

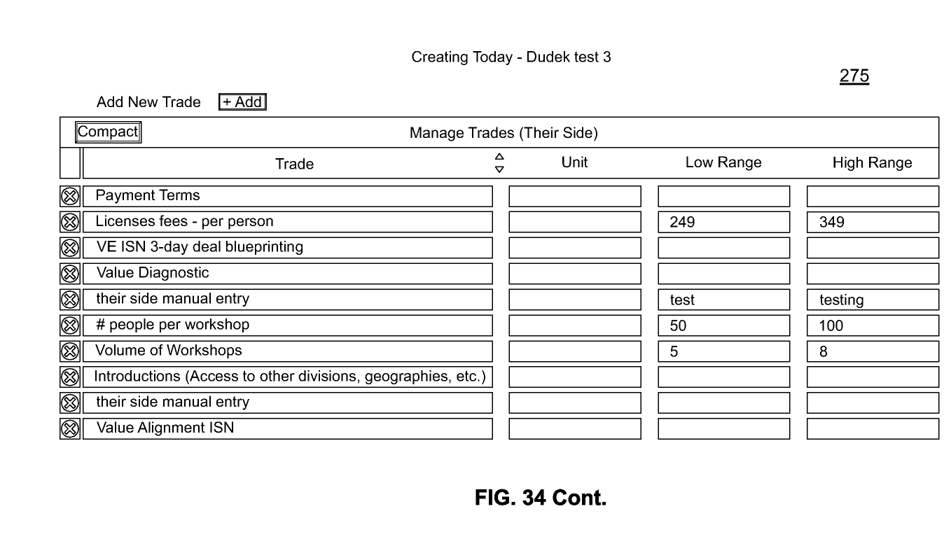

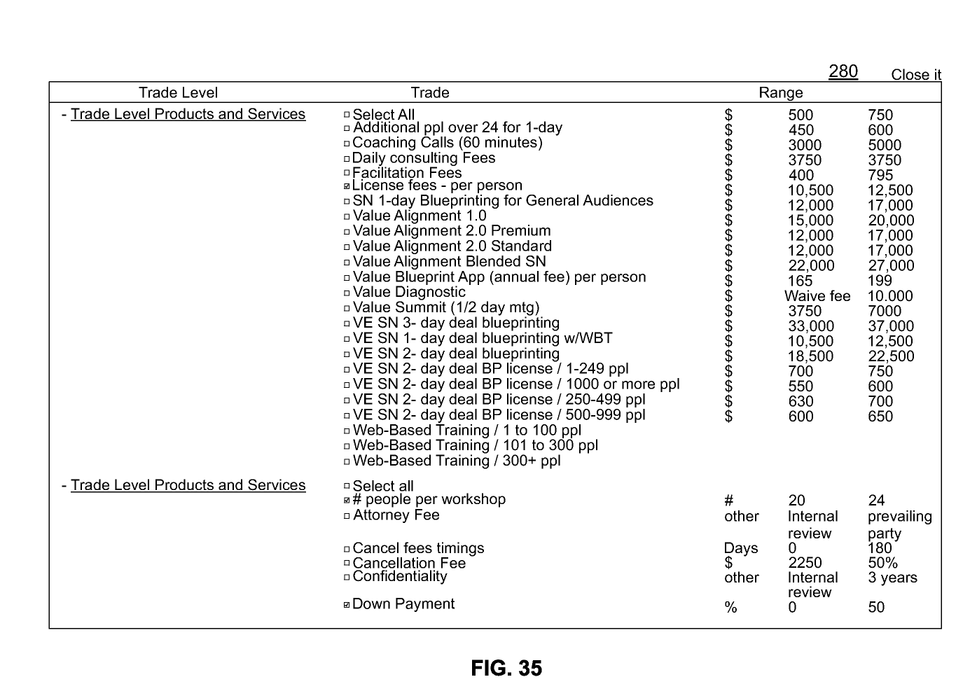

With regard to negotiation blueprint trades 245 within the user account 80, as illustrated in the negotiation blueprint trades interface screen 275 of FIG. 34, a user is allowed to populate data within two columns, namely a trades column for “our side” (i.e., the seller) and a trades column for their “their side” (i.e., the buyer). Starting initially with the trades column for our side, the user of the at least one user account 80 can list the trades, units and pre-populated ranges available to the seller via the trades our side metadata from the master account. In doing so, the user accesses the trades metadata 115 of the master account 75 by clicking on the trades our side metadata Add button. Clicking on the trades our side metadata Add button causes a trades our side supplemental interface screen 280 (FIG. 35) to appear. Within the trades our side supplemental interface screen of FIG. 35, the user can thus select a trade type (i.e., either creative; products and services; or terms and conditions) and thereafter select a trade and associated range from within that trade type. For example, as illustrated within FIG. 35, the user has selected the products and services trade type and has thereafter selected the “licensing fees—per person” trade and associated “$400 to $795” range metadata from the master account 75. Similarly, from within the terms and conditions trade type, the user has thereafter selected the “#people per workshop” trade and associated “20 to 40” range metadata, again from the master account 75. Although the foregoing trade type, trades and associated range metadata have been selected within the trades our side supplemental interface screen 280 of FIG. 35, it is noted that any trade type, trade and associated range metadata from the trades metadata 115 of the master account 75 may have been selected.

After selecting the trade type, trades and associated ranges metadata from within the trades our side supplemental interface screen 280 of FIG. 35, the user clicks on close and returns to the negotiation blueprint trades interface screen 275 of FIG. 34 to find the selected trades and ranges listed within the trades column for our side. All such trade information is further compiled by the processor as metadata to appear within the blueprint MEOs 250 of the user account (to be further discussed).

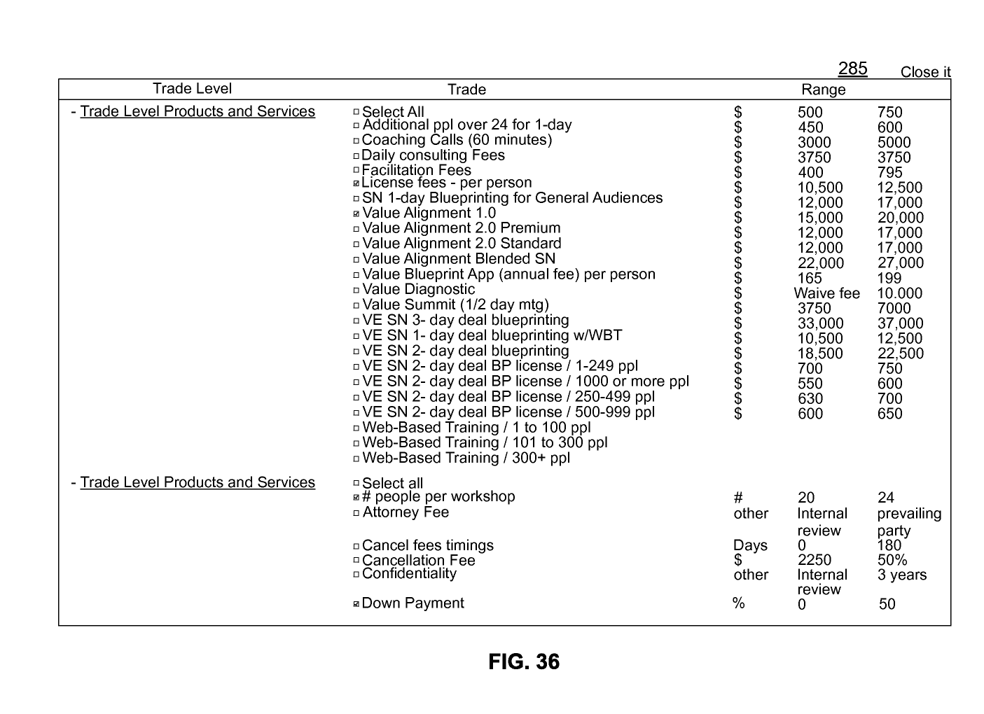

Referring again to FIG. 34, and utilizing the column for their side, the user of the at least one user account 80 can list the trades, units available to the seller via the trades their side meta data from the master account, to include the same trades as listed on Our Side, but with ranges manually entered by the user based on the customer expectations of the buyer. The user may again access the trades metadata 115 of the master account 75 by clicking on the trades their side metadata Add button located at the left of the column. Clicking on the trades their side metadata Add button causes a trades their side supplemental interface screen 285 (FIG. 36) to appear. Within the trades their side supplemental interface screen of FIG. 36, the user can thus again choose a trade type (i.e., either creative; products and services; or terms and conditions) and thereafter choose a trade from within that trade type.

For example, as illustrated within FIG. 36, in addition to the already selected “licensing fee” trade, the user has selected the products and services trade type and has thereafter selected the “value alignment 1.0” trade from the master account 75. Similarly, in addition to the already selected “#people” trade from within the terms and conditions trade type, the user has thereafter selected the “down payment” trade metadata, again from the master account 75. These selections will thus appear within the next iteration of the “their side’ screen of FIG. 34. Any ranges associated with the trades selected for “their side” may be manually entered by the user, with such ranges based upon customer expectation. The ranges manually entered for “their side” trades may thus be different from the metadata based ranges available for “our side” trades. Although the foregoing trade type and trades metadata have been selected within the trades their side supplemental interface screen 285 of FIG. 36, it is noted that any trade type and trade metadata from the trades metadata 115 of the master account 75 may have been selected.

After selecting the trade type and trades from within the trades their side supplemental interface screen 285 of FIG. 36, the user clicks on close and returns to the negotiation trades blueprint interface screen 275 of FIG. 34 to find the additional selected trades and ranges listed within trades column for their side. The user may manually enter any associated “their side” ranges within the listing. User may also manually type in any appropriate trade text data at this time. This information listed within the trades our side and trades their side columns of FIG. 34 may be sorted a variety of ways, and/or compacted to remove gaps from between line items by clicking on the compact button. Again, all such trade information is further compiled by the processor as metadata to appear within the blueprint MEOs 250 of the user account (to be further discussed).

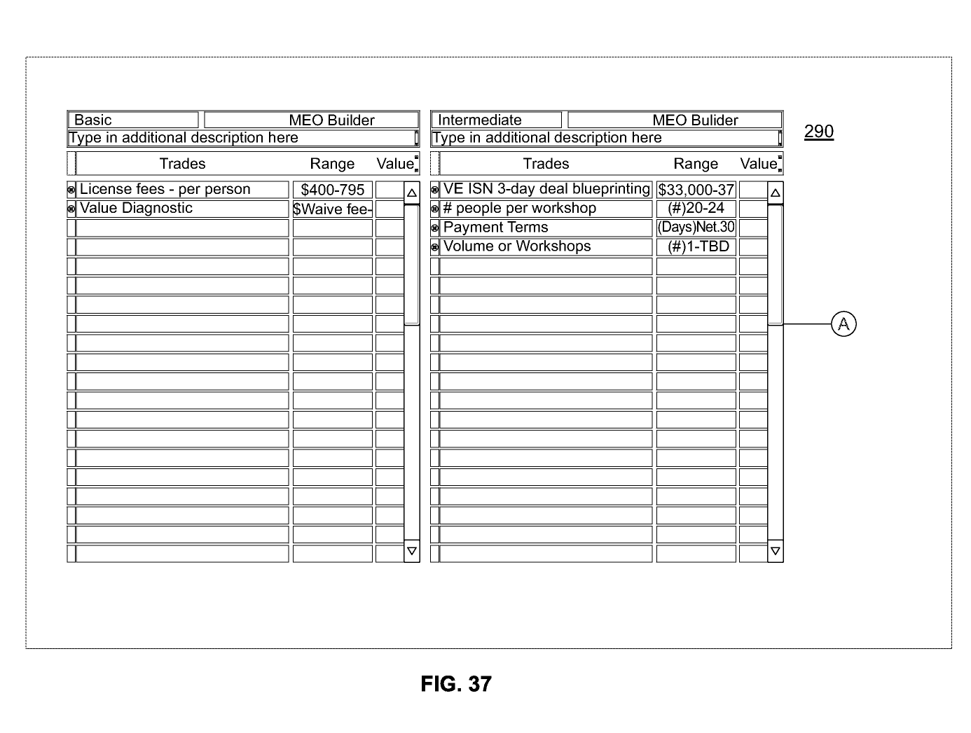

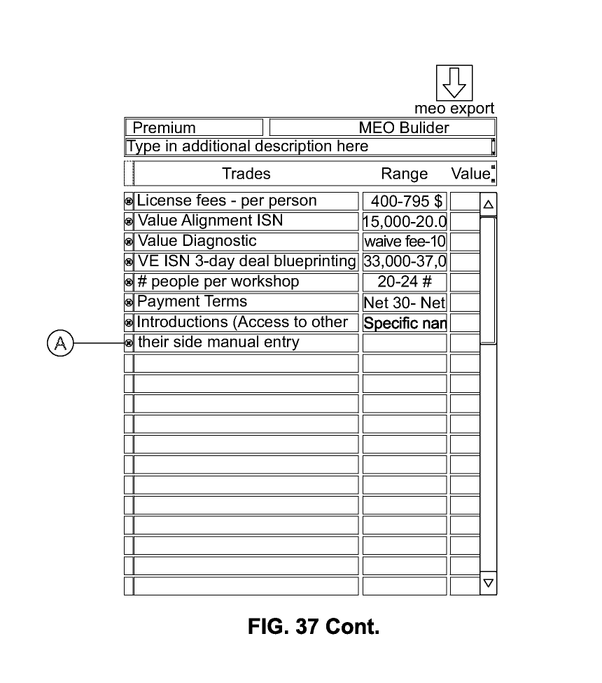

With regard to multiple equal offers (MEOs), recall that MEOs of the seller give buyers at least three choices (i.e., at least three offers), for solving the buyer's acquisition needs at three different investment or risk levels, instead of giving them one choice (i.e., a single offer). Thus, as illustrated within the negotiation blueprint MEOs interface screen 290 of FIG. 37, three columns are presented, i.e., left, middle and right columns, where the user formulates three different offers based upon underlying trades. A title field is provided for each trades column where the user can input respective titles. Clicking on each respective title will present metadata information rated as “H+” from the user's “their side” CNA analysis section to assist the user in drafting the respective titles. For example, as illustrated within FIG. 37, the respective titles “premium offer;” “basic offer;” and “intermediate offer” are utilized in relation to the left, middle and right trades column. Again, however, these titles are exemplary, as any title may be utilized. In relation to each title field, a description field is provided where the user can enter a description further describing the respective column.

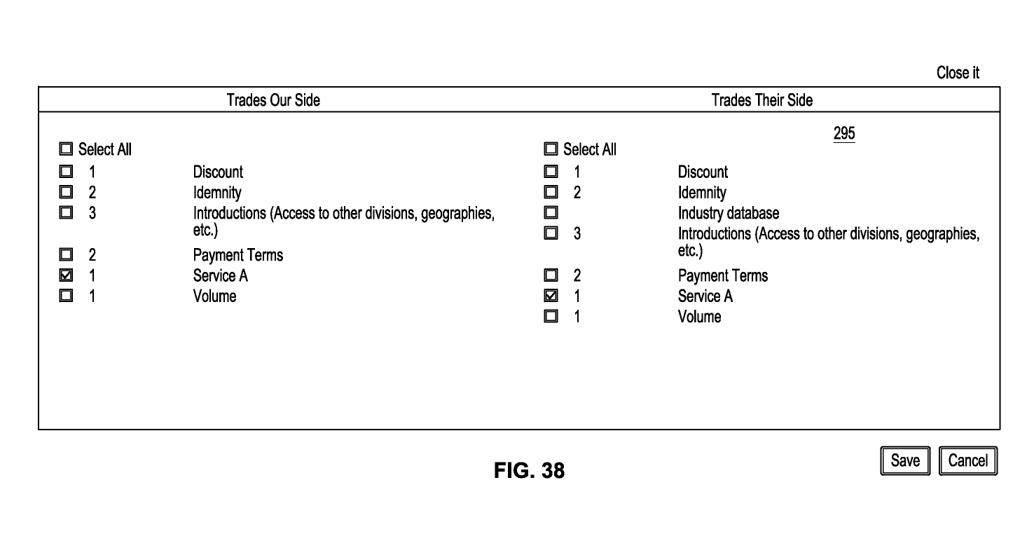

As further illustrated within FIG. 37, each of the three trades columns includes a button entitled MEO builder. By clicking on the MEO builder button relating to a given column, a supplemental interface screen appears presenting the user with user trades metadata 115 established by the user within both the “our side” and “their side” trades sections of the user account 80. Each trade line item for both the “our side” and “their side” trades is presented as a user trades selection field that the user can select to populate the given trades column of the MEO. Thus, upon clicking on the MEO builder button of the left side trades column, a left side trades column supplemental interface screen 295 (FIG. 38) appears wherein the user selects the user trades selection field of any trades desired to populate the column. As illustrated in FIG. 38, the user has selected “service A.” Upon clicking on the “save” and thereafter the “close it” buttons of the left side trades column supplemental interface screen 295, the selected “service A” trade will appear within the left side trades column of the next iteration of the negotiation blueprint MEOs interface screen 290 of FIG. 37.

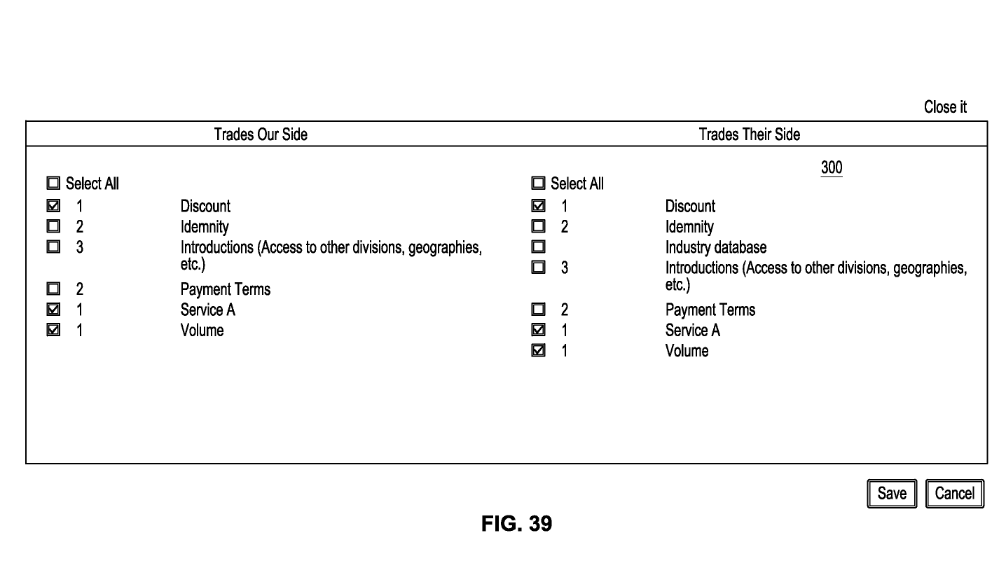

Similarly, upon clicking on the MEO builder button of the middle trades column, a middle trades column supplemental interface 300 screen (FIG. 39) appears wherein the user selects the user trades selection field of any trades desired to populate the column. As illustrated in FIG. 39, the user has selected “discount,” “service A,” and “volume” from both the “our side” and “their side” trades. Upon clicking on the “save” button and thereafter the “close it” button of the middle trades column supplemental interface screen 300, the selected “discount,” “service A” and “volume” trades will appear within the middle trades column 33 of the next iteration of the negotiation MEOs interface screen 290 of FIG. 37.

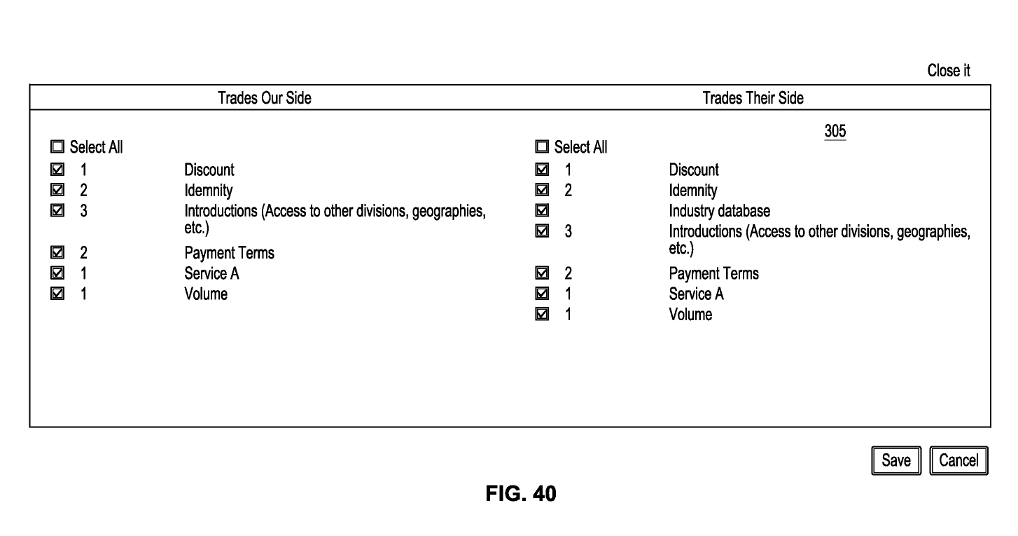

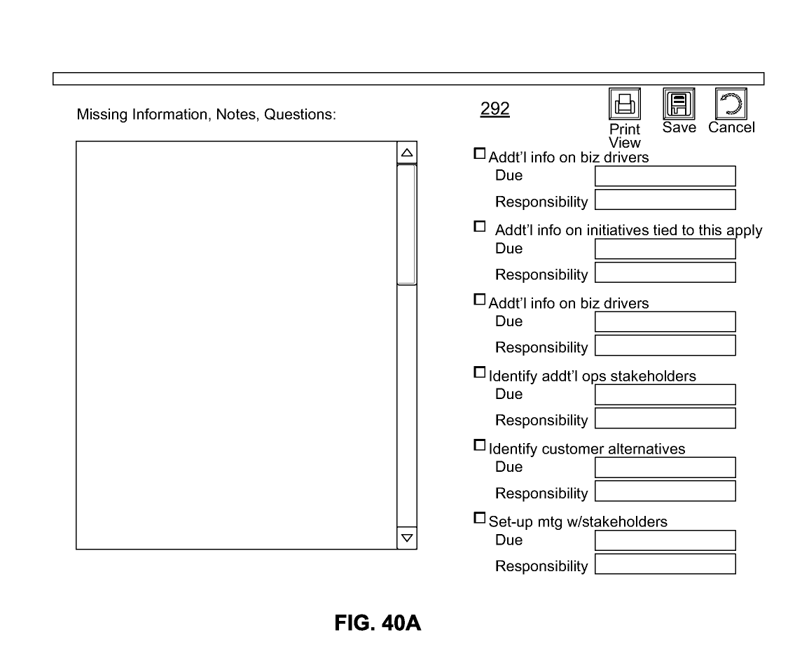

Furthermore, upon clicking on the MEO builder button of the right side trades column, a right side trades column supplemental interface screen 305 (FIG. 40) appears wherein the user selects the user trades selection field of any trades desired to populate the column. As illustrated in FIG. 40, the user has selected “discount,” “indemnity,” “introductions (access to other divisions, geographies, etc),” “payment terms,” “service A” and “volume” from both the “our side” and “their side” trades, while also selecting the “industry database” trade from the “their side” trades. Upon clicking on the “save” button and thereafter the “close it” button of the right side trades column supplemental interface screen 305, the selected “discount,” “indemnity,” “introductions (access to other divisions, geographies, etc),” “payment terms,” “service A,” “volume,” and “industry database” trades will appear within the right side trades column of the next iteration of the negotiation blueprint MEO interface screen 290 of FIG. 37. After selecting one or more trades for a given column of the negotiation blueprint MEOs interface screen 290 of FIG. 37, the user is thereafter able to enter further information for each selected trade within the column. For example, the user may enter the “unit price” for a product of the line item.

As illustrated within FIG. 40a, a notes screen 292 is further provided for users. The information presented within the notes screen comprises a basic entry field on the left of the screen and a column of selection fields on the right of the screen. The notes metadata 120 from the master account 75 (see the notes interface screen 225 of FIG. 28), namely, custom data information and respectively related due date and responsibility information, is utilized to populate the selection fields. Each custom data line item that is presented within notes column is presented as a user MEOs selection field that the user can select to populate the column. After entering any basic notes to the basic entry field, making the desired selections and entering the related dates and responsibilities, the save button is actuated to save the data.

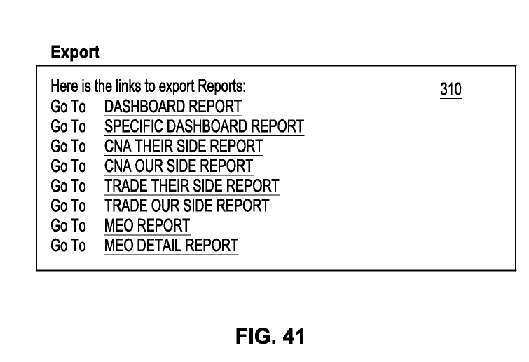

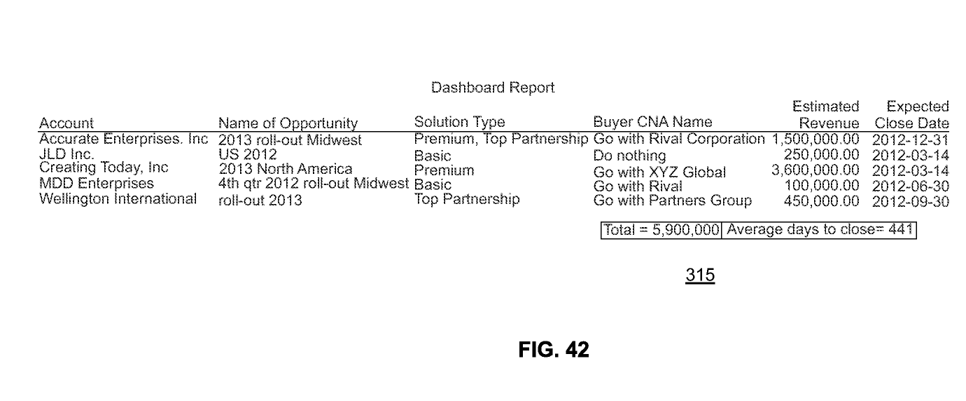

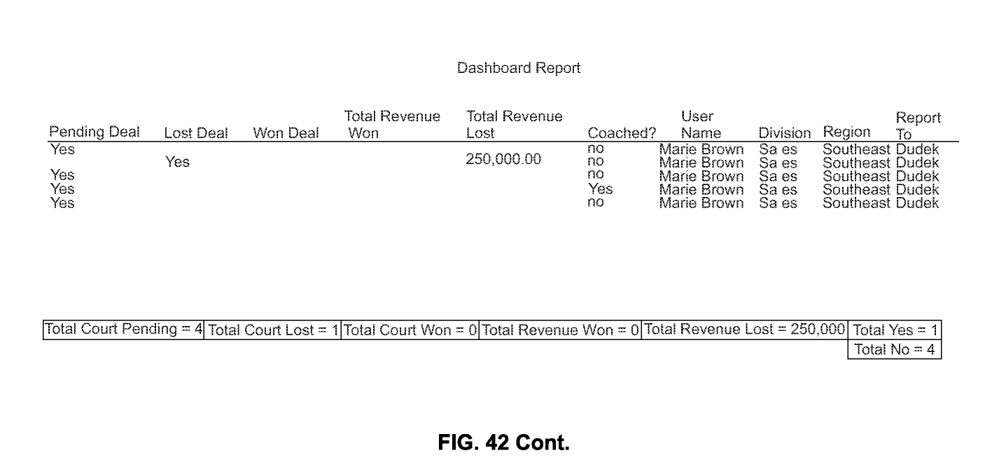

Having populated the CNA 235 and 249, trades 245 and MEOs 250 of the negotiation blueprint for one or more buyers or accounts, various reports may be created by the system 50 utilizing both metadata and populated data from the respective master and user accounts. FIG. 41 thus illustrates a screen shot of an export interface screen 305 setting forth such reports. As illustrated therein, a user or administrator may select: a dashboard report; a specific dashboard report; a CNA their side report; a CNA our side report; a trade their side report; a trade our side report; an MEO report; or an MEO detail report. A “Use Report,” “Trades analysis” report, and/or “CNA Analysis” report may also be created, to be further discussed. FIG. 42 sets forth an example of the dashboard report 315. As illustrated within FIG. 42, the dashboard report provides a summary of the blueprint accounts and related information as presented within the blueprint cover edit interface screen 130 of FIG. 6 and the negotiation blueprint cover interface screen 255 of FIG. 30. Thus, the dashboard report 315 presents information such as: account name; opportunity name; estimated revenue; status; user name; and other information. Thus, clicking on the dashboard report link within export interface screen 310 of FIG. 41 causes the above-described dashboard report to be displayed.

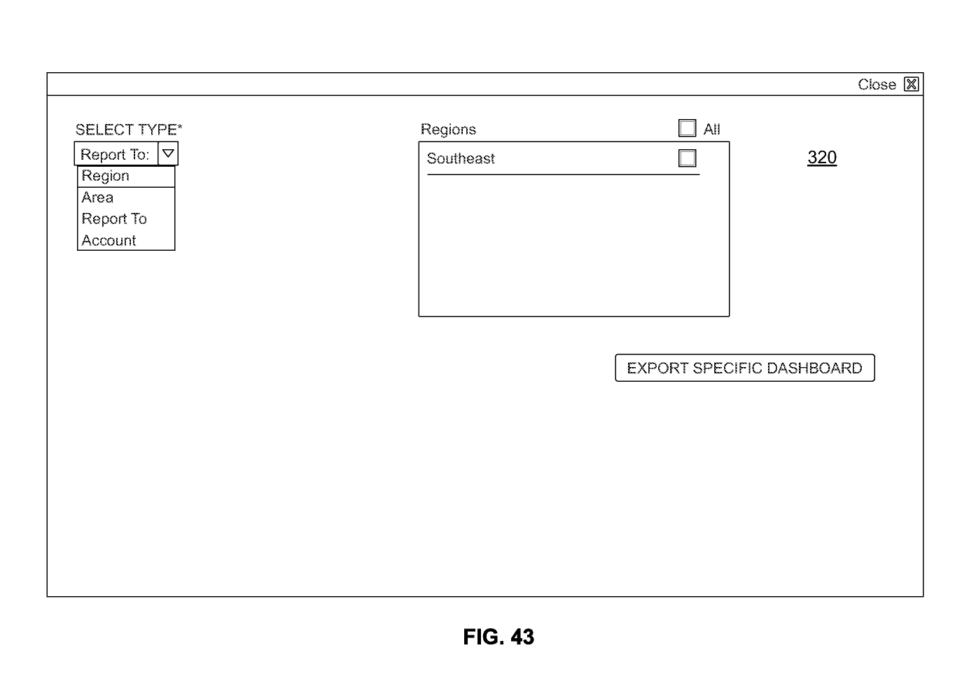

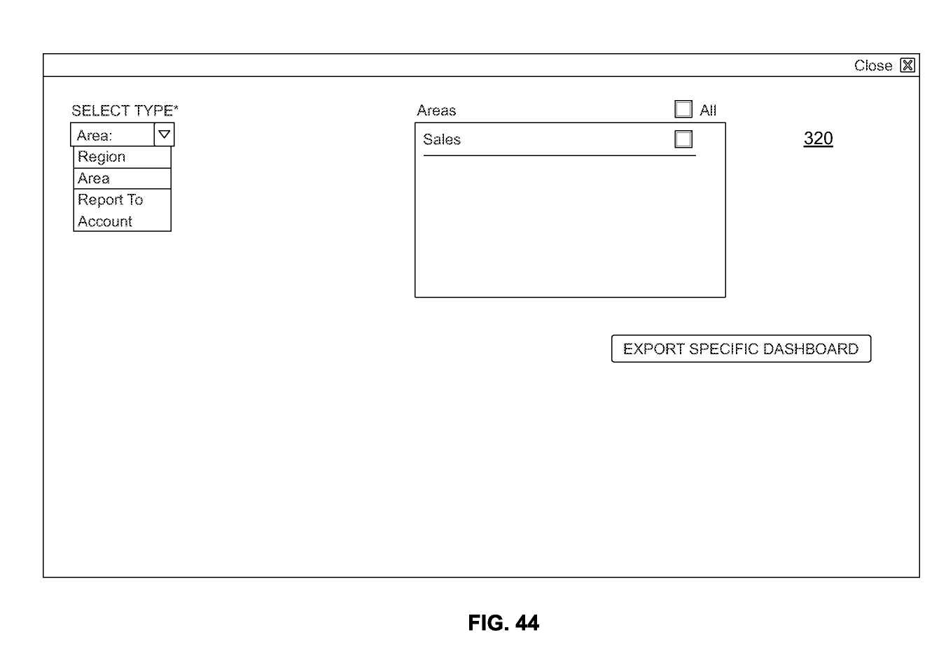

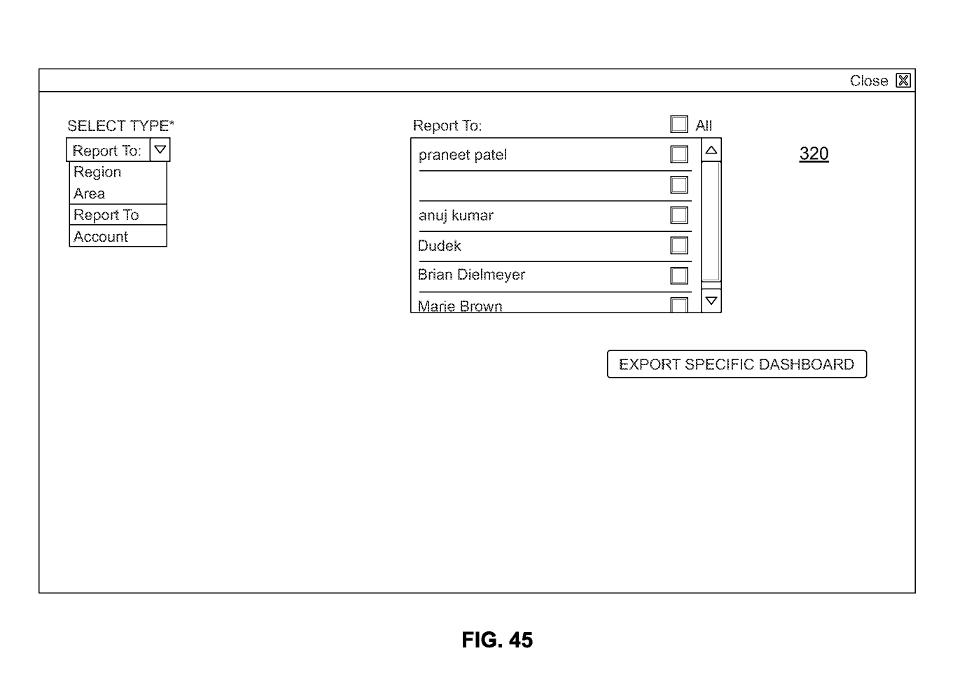

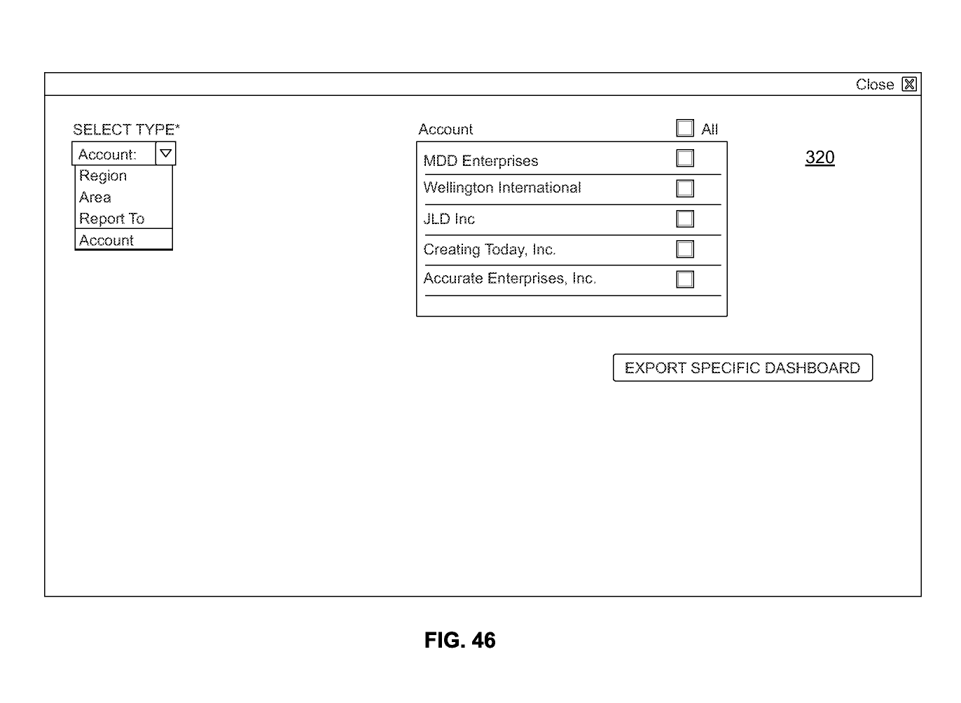

The specific dashboard report is similar to the dashboard report 315, but further allows the report to be tailored a number of different ways. Clicking on the specific dashboard report link within the export interface screen 310 of FIG. 41 thus causes the specific dashboard supplemental interface screen 320 to appear. Within the specific dashboard supplemental interface screen is a “select type” selection field that allows for the report to be directed to: a region; an area; a specific user (entitles “report to”); or an account. FIGS. 43, 44, 45 and 46 thus respectively illustrate the specific dashboard supplemental interface screen 320 utilizing each foregoing type. FIG. 43, illustrating the selection of “region” within the select type selection field, presents a “regions” selection field allowing for one or more given regions (i.e., “southeast”) to be selected to further tailor the specific dashboard report. FIG. 44, illustrating the selection of “area” within the select type selection field, presents an “areas” selection field allowing for one or more given areas (i.e., “sales”) to be selected to further tailor the specific dashboard report. FIG. 45, illustrating the selection of “report to” within the select type selection field, presents a “report to” selection field allowing for one or more given users or administrators (i.e., “Marie Brown”) to be selected to further tailor the specific dashboard report. FIG. 46, illustrating the selection of “account” within the select type selection field, presents an “account” selection field allowing for one or more given buyers (i.e., “Creating Today, Inc.”) to be selected to further tailor the specific dashboard report. Clicking on the “export specific dashboard” button within each of the foregoing interface screens causes the respective tailored specific dashboard reports to be displayed.

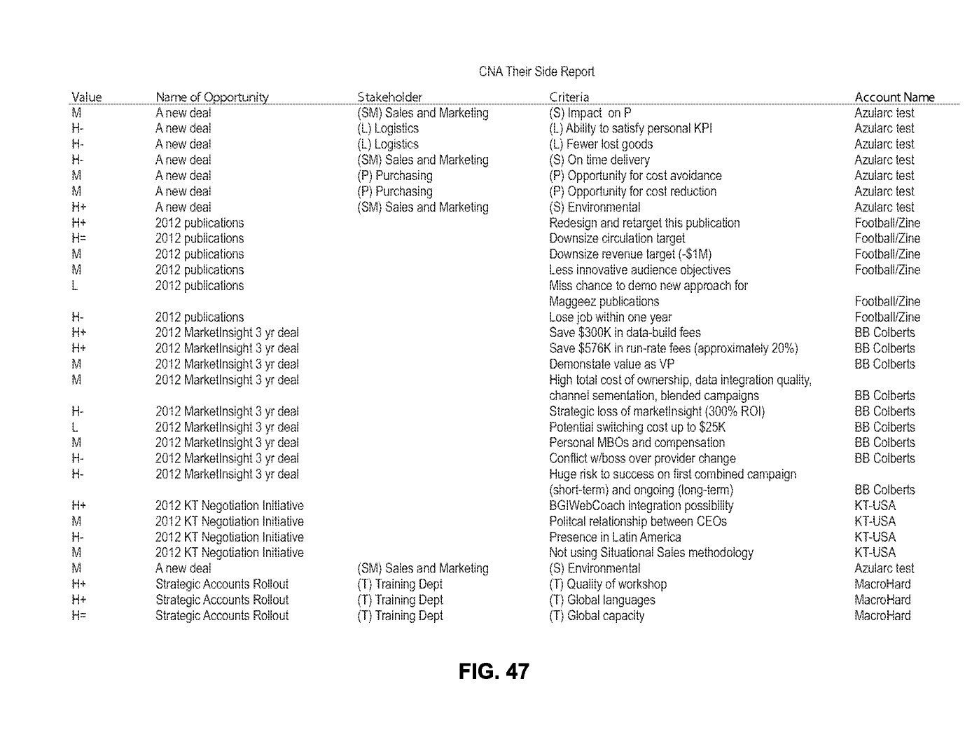

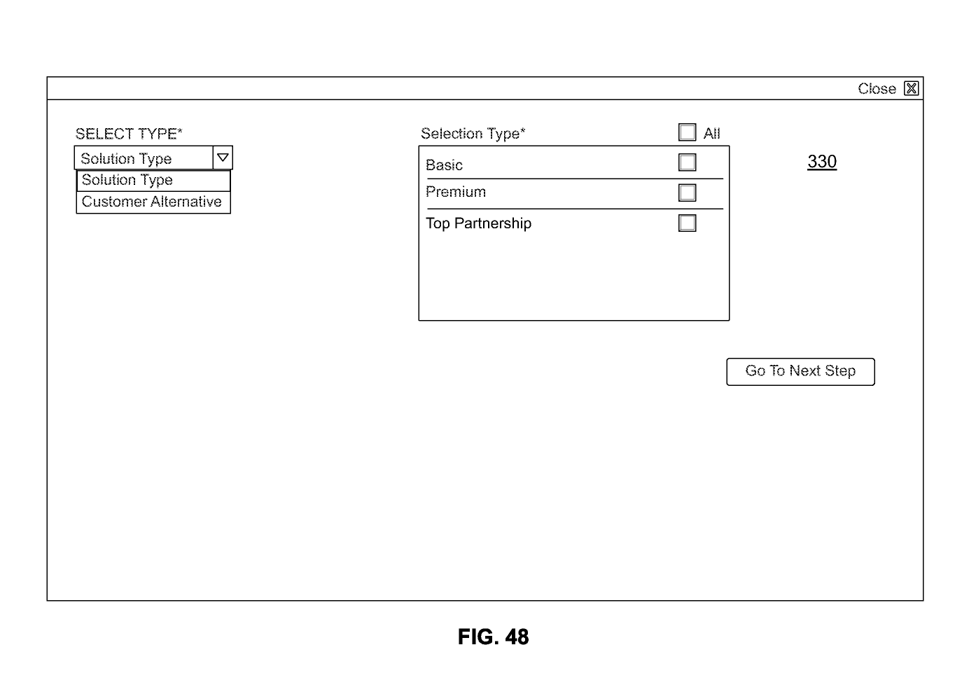

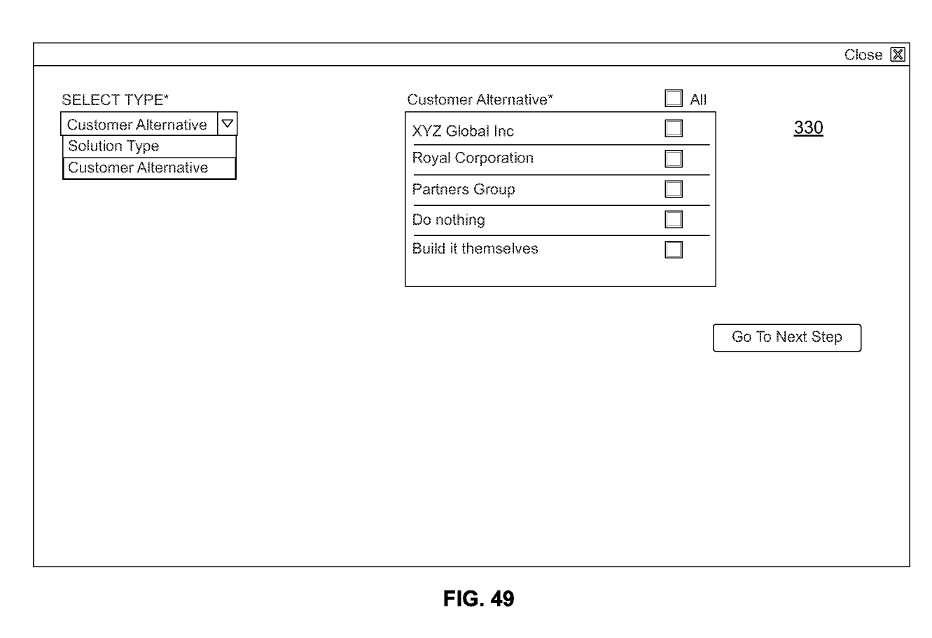

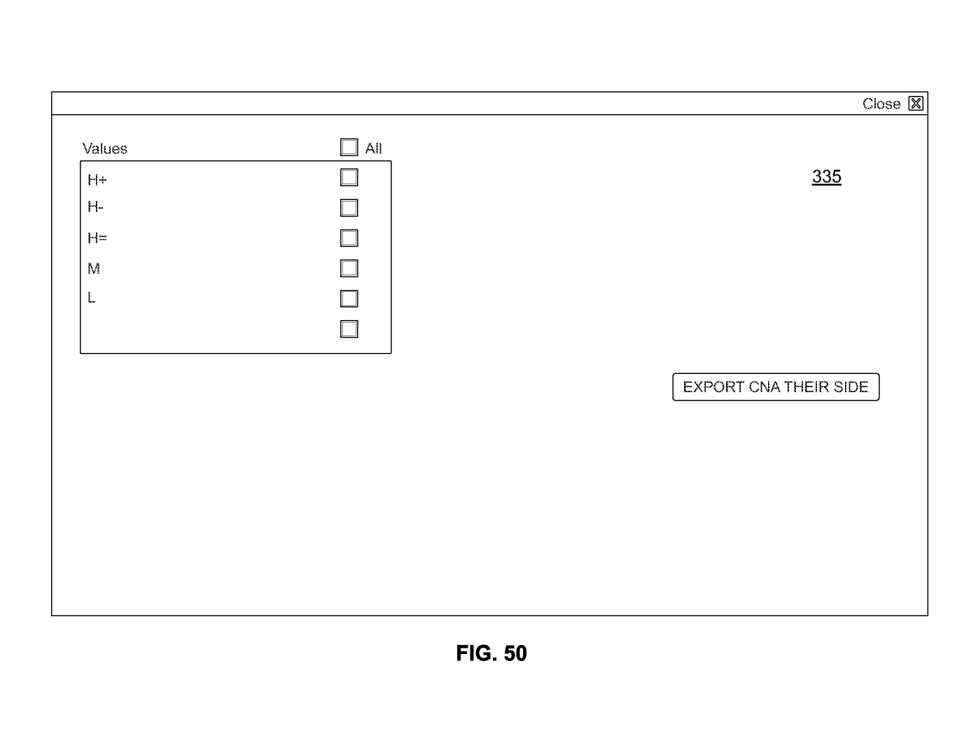

As illustrated within FIG. 47, the CNA their side report 325 sets forth a summary of the CNA their side information 90 and metadata 110. Thus, the CNA their side report presents stakeholder and criteria data, and other information relating to the various opportunities. Clicking on the CNA their side report link within the export interface screen 310 of FIG. 41 thus causes the CNA their side supplemental interface screen 330 to appear. Within the CNA their side supplemental interface screen is a “select type” selection field that allows for the report to be directed to: a solution type; or a customer alternative. FIGS. 48 and 49 thus respectively illustrate the CNA their side supplemental interface screen 330 utilizing each foregoing type. FIG. 48, illustrating the selection of “solution type” within the select type selection field, presents a “solutions type” selection field allowing for one or more given solution types (i.e., basic, premium; and top partnership) to be selected to further tailor the CNA their side report 325. FIG. 49, illustrating the selection of “customer alternative” within the select type selection field, presents a “customer alternative” selection field allowing for one or more given customer alternatives (i.e., competitor 1; competitor 2; competitor 3; do nothing; build it themselves) to be selected to further tailor the CNA their side report 325. Of course, the information of the solution types and customer alternatives selection fields comprise CNA their side metadata of the master account 75. Clicking on the “go to next step” button within each of the foregoing interface screens causes the yet another supplemental interface screen to appear, namely, the CNA their side secondary supplemental interface screen 335 of FIG. 50. Within the CNA their side secondary supplemental interface screen, a “values” selection field is provided that allows for the selection of one or more values and importance levels (i.e. H+; H−; H=; M; L from the CNA column for their side of FIG. 31) to further tailor the report. Thereafter clicking on the “export CNA their side” button within the respective secondary supplemental interface screens causes the respective tailored CNA their side reports to be displayed.

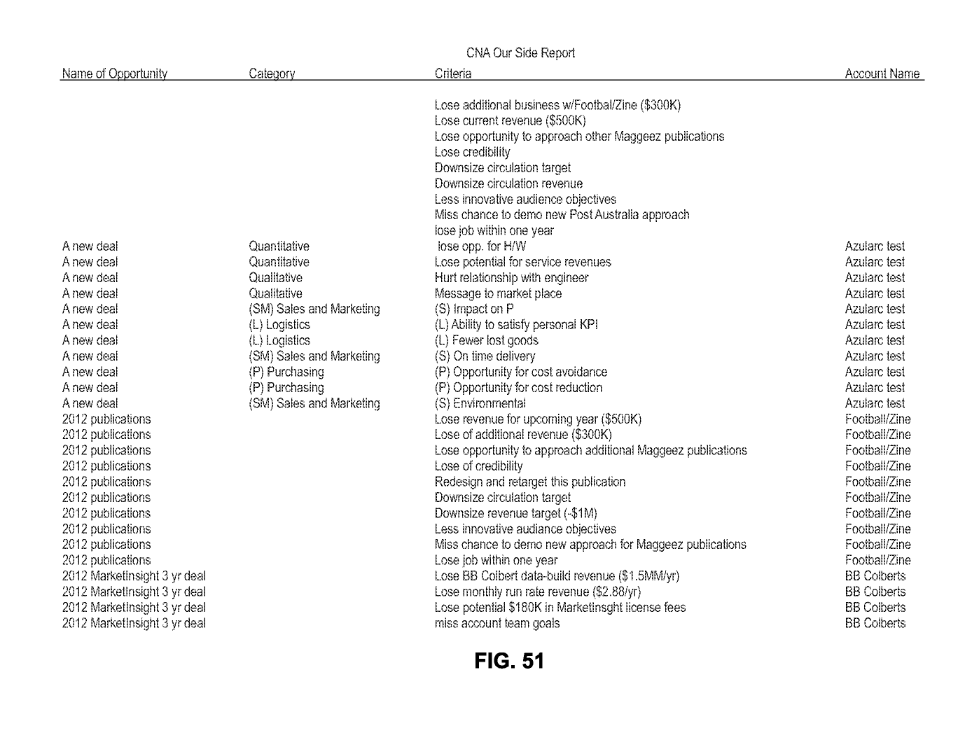

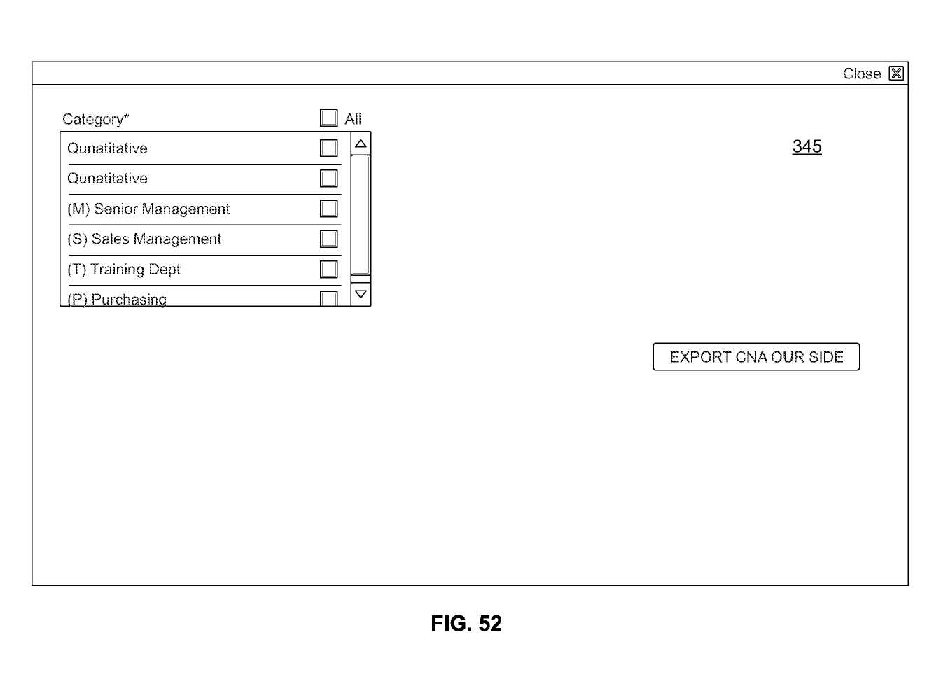

As illustrated within FIG. 51, the CNA our side report 340 sets forth a summary of the CNA our side information 85 and metadata 105. Thus, the CNA our side report 340 presents category and impact data, and other information relating to the various opportunities. Clicking on the CNA our side report link within the export interface screen 310 of FIG. 41 thus causes the CNA our side supplemental interface screen 345 of FIG. 52 to appear. Within the CNA our side supplemental interface screen is a “category” selection field that allows for the report to be directed to one or more categories (i.e., quantitative; qualitative) Of course, the information of the category selection field comprises CNA our side metadata of the master account 75. Clicking on the “export CNA our side” button within the CNA our side supplemental interface screen causes the tailored CNA our side report 325 to be displayed.

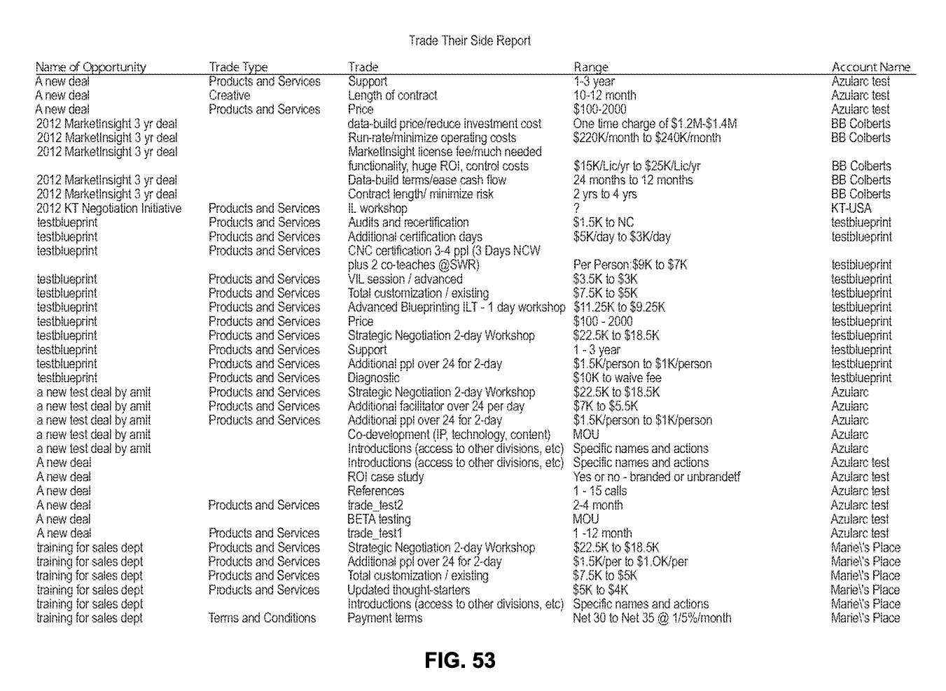

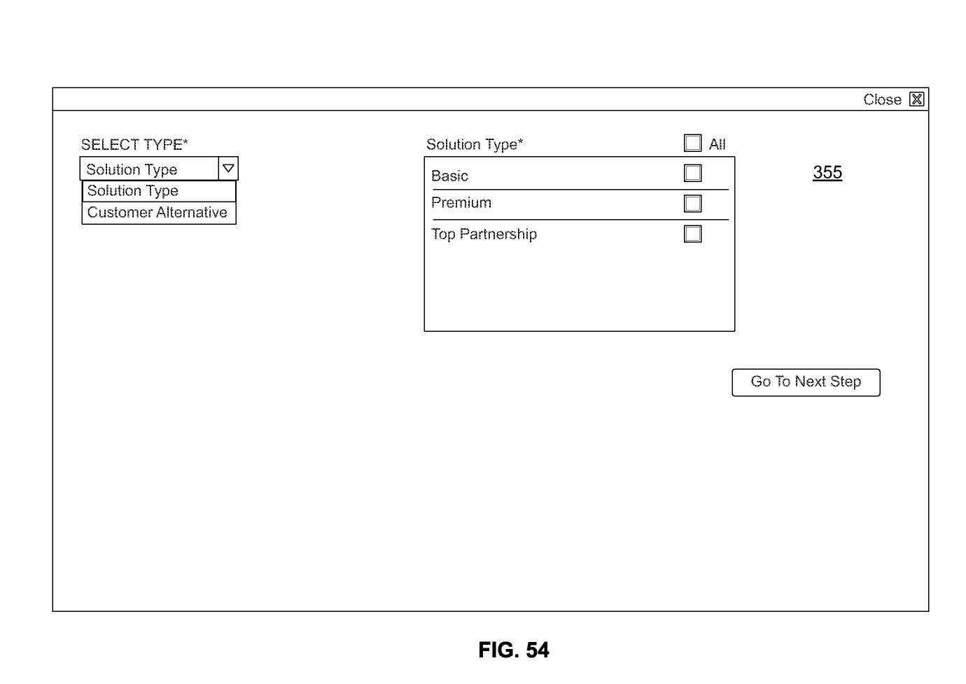

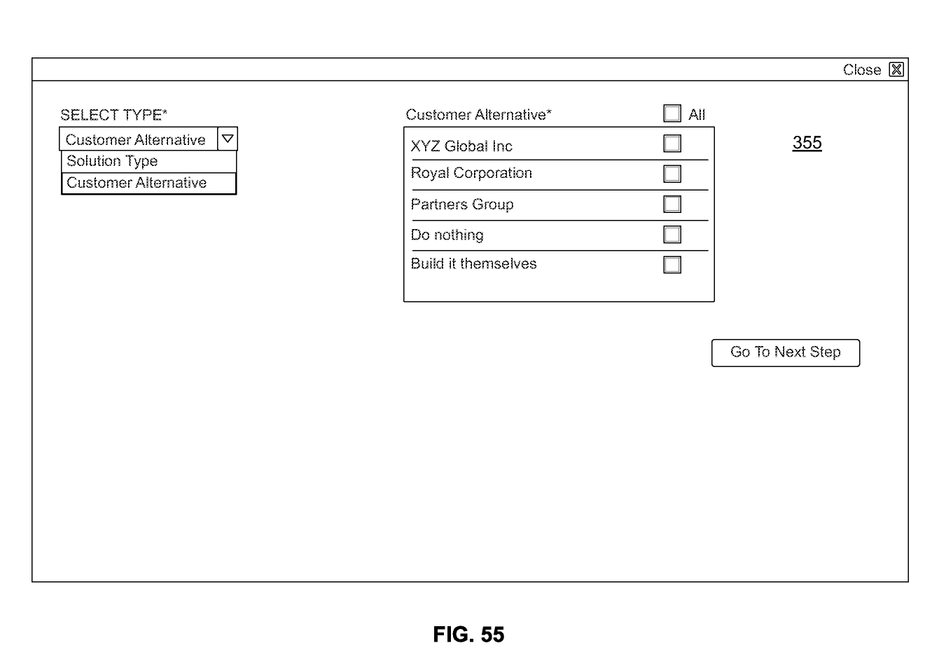

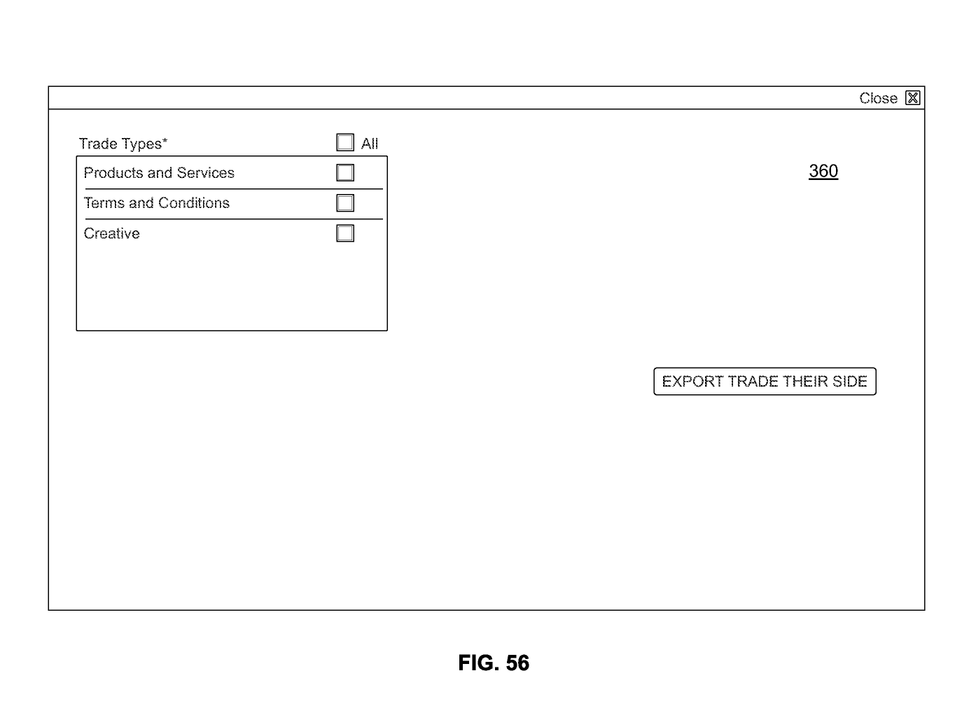

As illustrated within FIG. 53, the trade their side report 350 sets forth a summary of the trade their side information and metadata. Thus, the trade their side report presents trade type, trades and range data, and other information relating to the various opportunities. Clicking on the trade their side report link within the export interface screen 310 of FIG. 41 thus causes the trade their side supplemental interface screen 355 to appear. Within the trade their side supplemental interface screen is a “select type” selection field that allows for the report to be directed to: a solution type; or a customer alternative. FIGS. 54 and 55 thus respectively illustrate the trade their side supplemental interface screen 355 utilizing each foregoing type. FIG. 54, illustrating the selection of “solution type” within the select type selection field, presents a “solutions type” selection field allowing for one or more given solution types (i.e., basic, premium; and top partnership) to be selected to further tailor the trade their side report 350. FIG. 55, illustrating the selection of “customer alternative” within the select type selection field, presents a “customer alternative” selection field allowing for one or more given customer alternatives (i.e., competitor 1; competitor 2; competitor 3; do nothing; build it themselves) to be selected to further tailor the trade their side report 350. Of course, the information of the solution types and customer alternatives selection fields comprise CNA their side metadata of the master account 75. Clicking on the “go to next step” button within each of the foregoing interface screens causes the yet another supplemental interface screen to appear, namely, the trade their side secondary supplemental interface screen 360 of FIG. 56. Within the trade their side secondary supplemental interface screen, a “trade types” selection field is provided that allows for the selection of one or more trade types (i.e. products and services, terms and conditions; creative) to further tailor the trades their side report 350. Thereafter clicking on the “export trade their side” button within the respective secondary supplemental interface screens causes the respective tailored trade their side reports to be displayed.

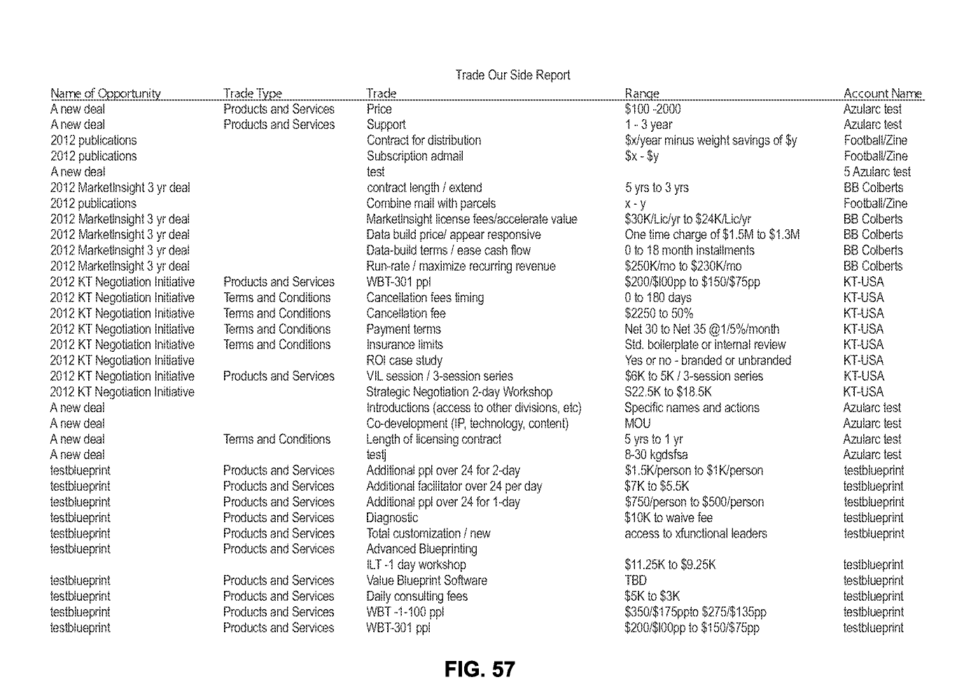

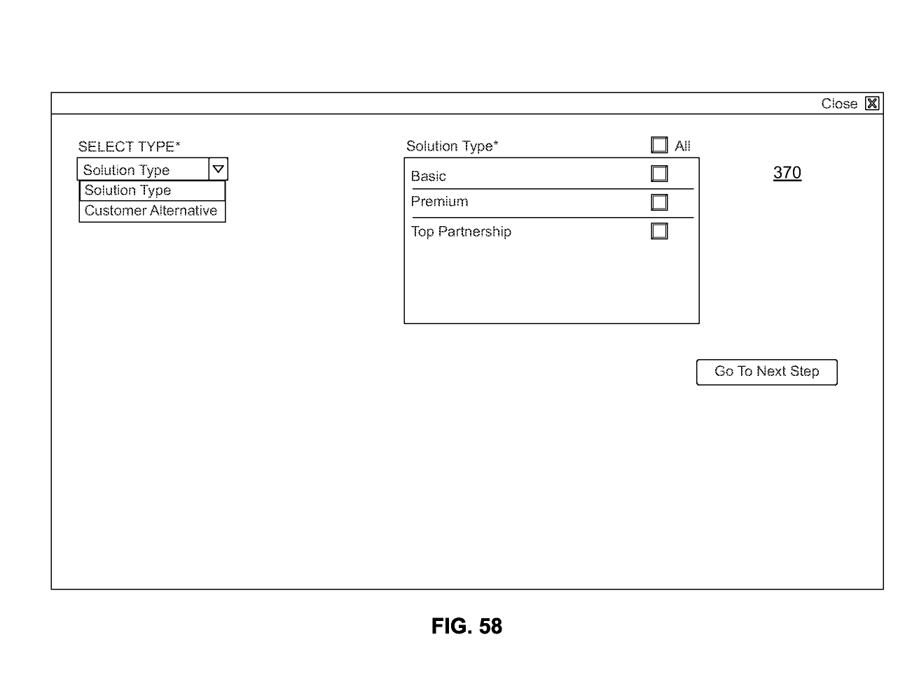

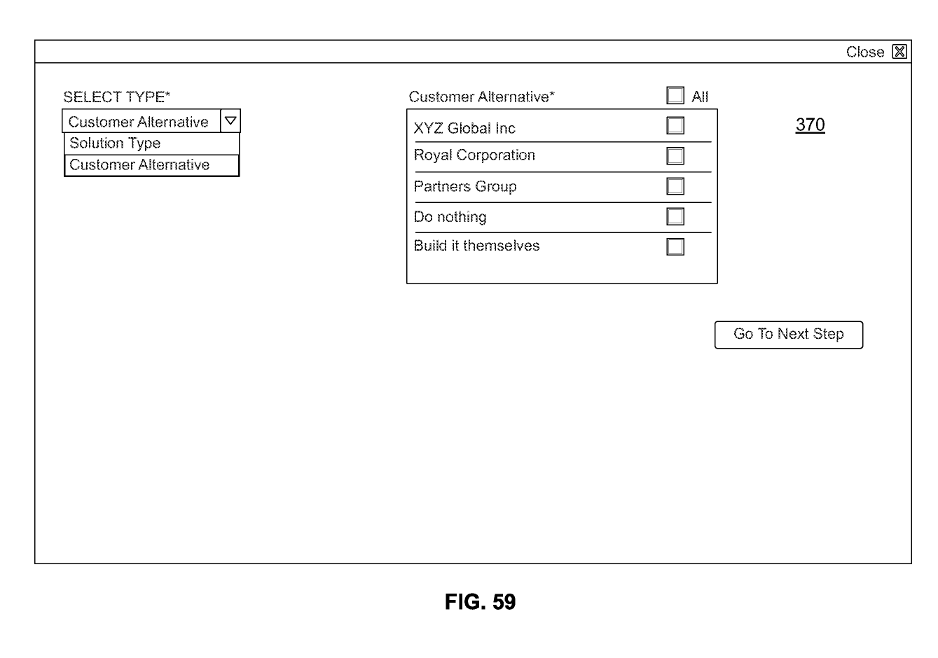

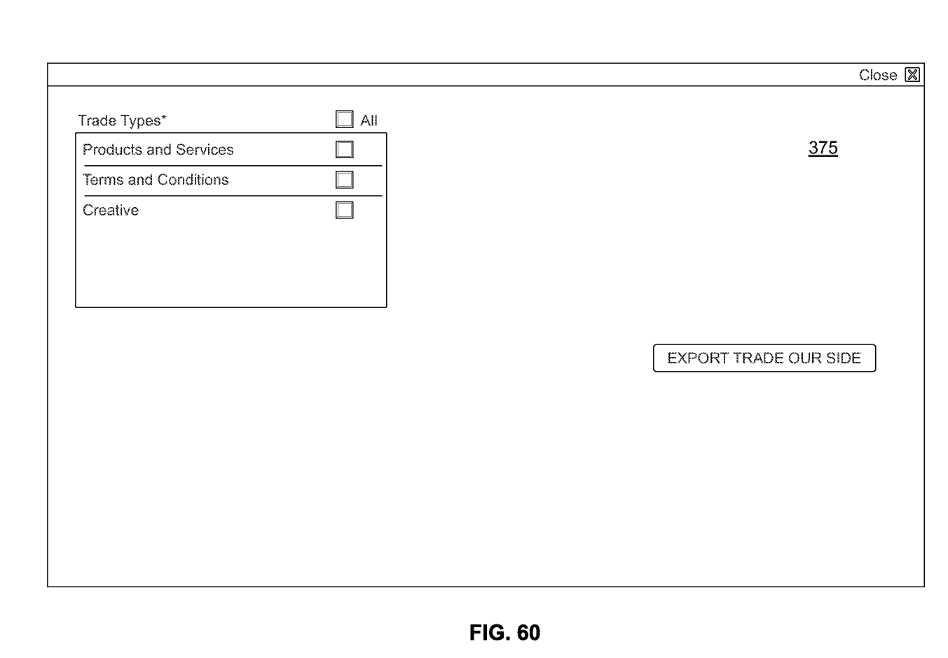

As illustrated within FIG. 57, the trade our side report 365 sets forth a summary of the trade our side information and metadata. Thus, the trade our side report presents trade type, trades and range data, and other information relating to the various opportunities. Clicking on the trade our side report link within the export interface screen 310 of FIG. 41 thus causes the trade our side supplemental interface screen 370 to appear. Within the trade our side supplemental interface screen is a “select type” selection field that allows for the report to be directed to: a solution type; or a customer alternative. FIGS. 58 and 59 thus respectively illustrate the trade our side supplemental interface screen 370 utilizing each foregoing type. FIG. 58, illustrating the selection of “solution type” within the select type selection field, presents a “solutions type” selection field allowing for one or more given solution types (i.e., basic, premium and top partnership) to be selected to further tailor the trade our side report 365. FIG. 59, illustrating the selection of “customer alternative” within the select type selection field, presents a “customer alternative” selection field allowing for one or more given customer alternatives (i.e., competitor 1; competitor 2; competitor 3; do nothing; build it themselves) to be selected to further tailor the trade our side report 365. Of course, the information of the solution types and customer alternatives selection fields comprise CNA our side metadata of the master account 75. Clicking on the “go to next step” button within each of the foregoing interface screens causes the yet another supplemental interface screen to appear, namely, the trade our side secondary supplemental interface screen 375 of FIG. 60. Within the trade our side secondary supplemental interface screen, a “trade types” selection field is provided that allows for the selection of one or more trade types (i.e. products and services; terms and conditions creative) to further tailor the trades our side report 365. Thereafter clicking on the “export trade our side” button within the respective secondary supplemental interface screens causes the respective tailored trade our side reports to be displayed.

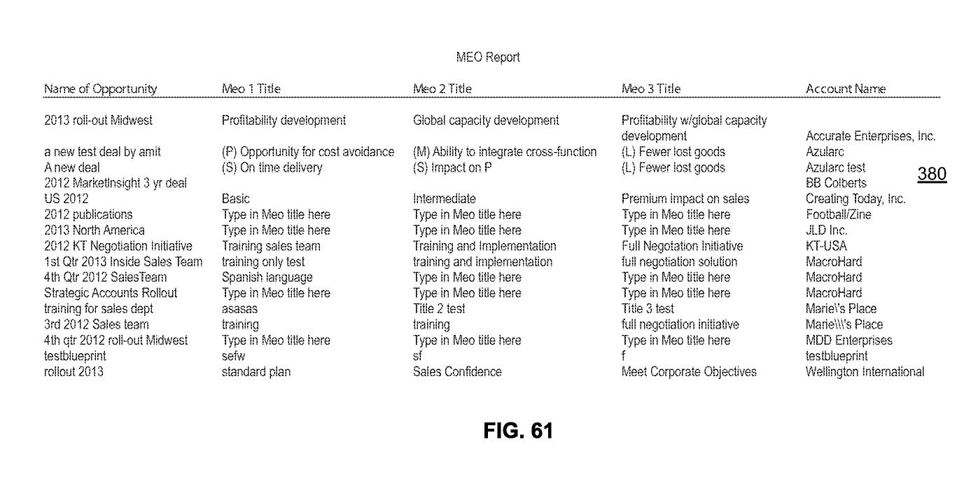

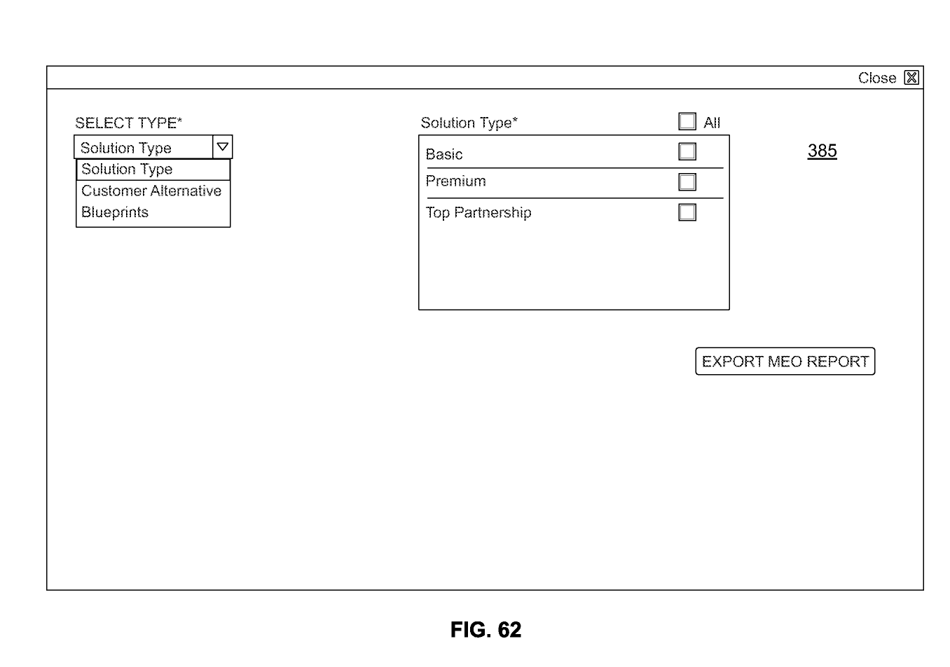

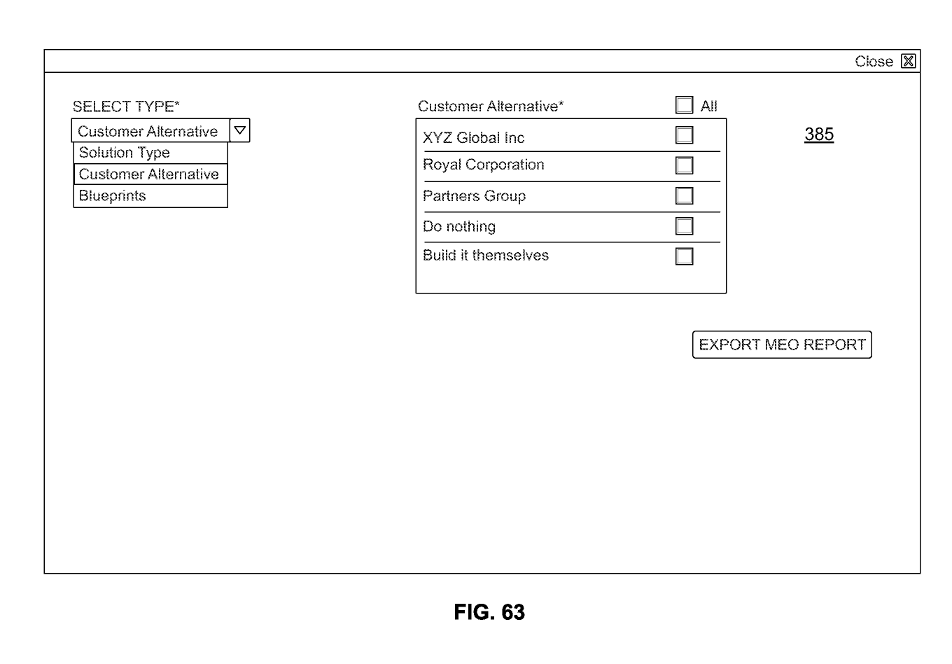

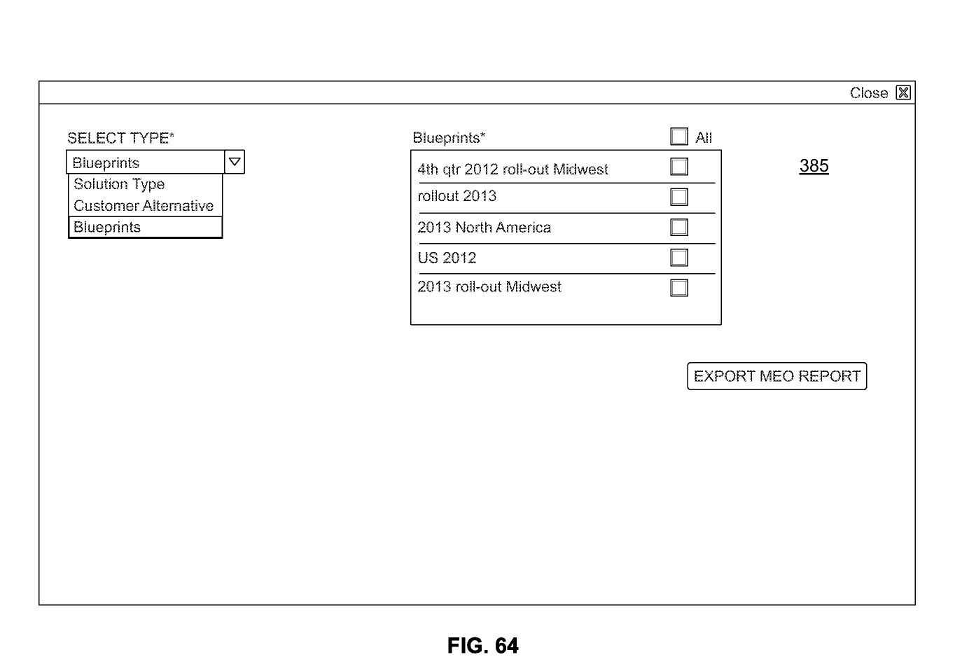

As illustrated within FIG. 61, the MEO report 380 sets forth a summary of the MEO information and metadata. Thus, the MEO report presents MEO data, and other information relating to the various opportunities. Clicking on the MEO report link within the export interface screen 310 of FIG. 41 thus causes the MEO supplemental interface screen 385 to appear. Within the MEO supplemental interface screen is a “select type” selection field that allows for the report to be directed to: a solution type; a customer alternative or blueprints. FIGS. 62, 63 and 64 thus respectively illustrate the MEO supplemental interface screen 385 utilizing each foregoing type. FIG. 62, illustrating the selection of “solution type” within the select type selection field, presents a “solutions type” selection field allowing for one or more given solution types (i.e., basic, premium and top partnership) to be selected to further tailor the MEO report 380. FIG. 63, illustrating the selection of “customer alternative” within the select type selection field, presents a “customer alternative” selection field allowing for one or more given customer alternatives (i.e., competitor 1; competitor 2; competitor 3; do nothing; build it themselves) to be selected to further tailor the MEO report 380. FIG. 64, illustrating the selection of “blueprints” within the select type selection field, presents a “blueprints” selection field allowing for one or more given blueprints (i.e., 4th qtr 2012 roll-out Midwest; rollout 2013; 2013 north America; US 2012; 2012 rollout Midwest) to be selected to further tailor the MEO report 380. Of course, the information of the solution types and customer alternatives selection fields comprise CNA their side metadata of the master account 75. Thereafter clicking on the “export MEO report” button within the respective supplemental interface screens causes the respective tailored MEO reports to be displayed.

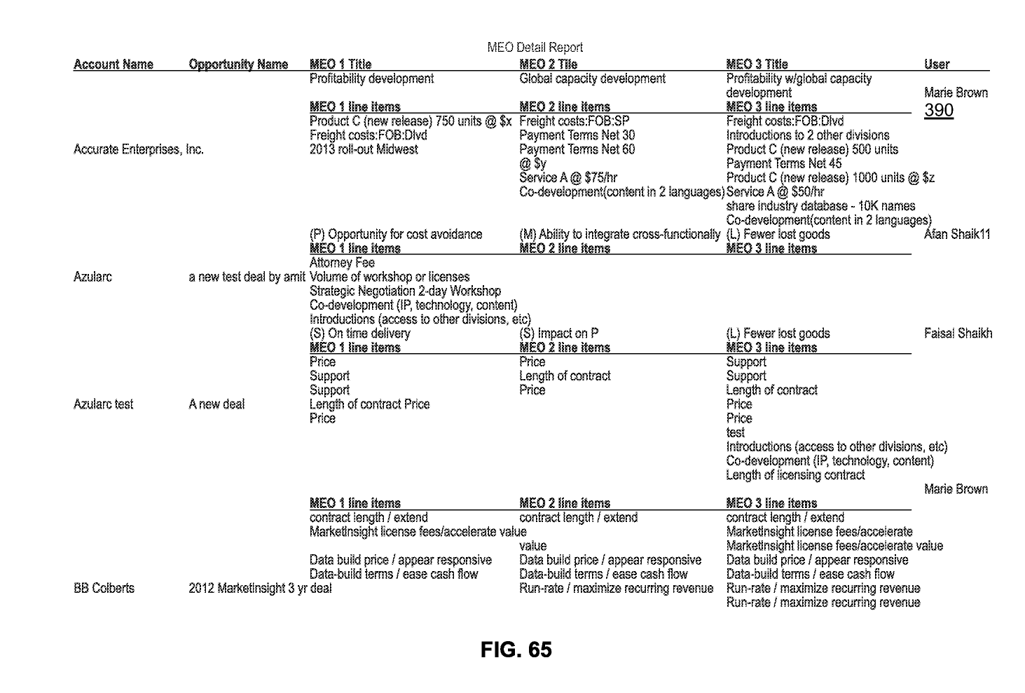

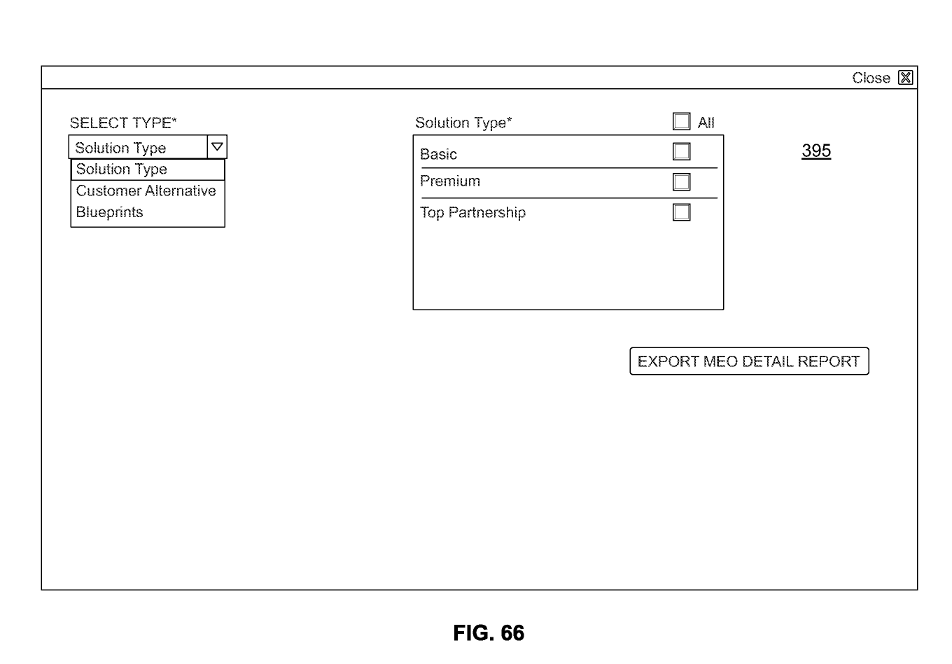

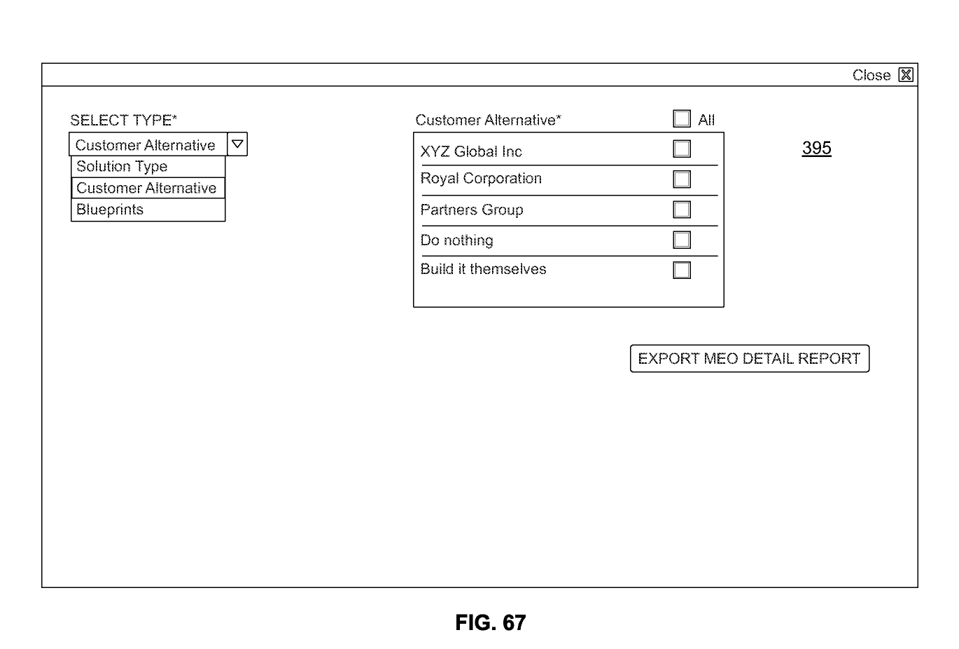

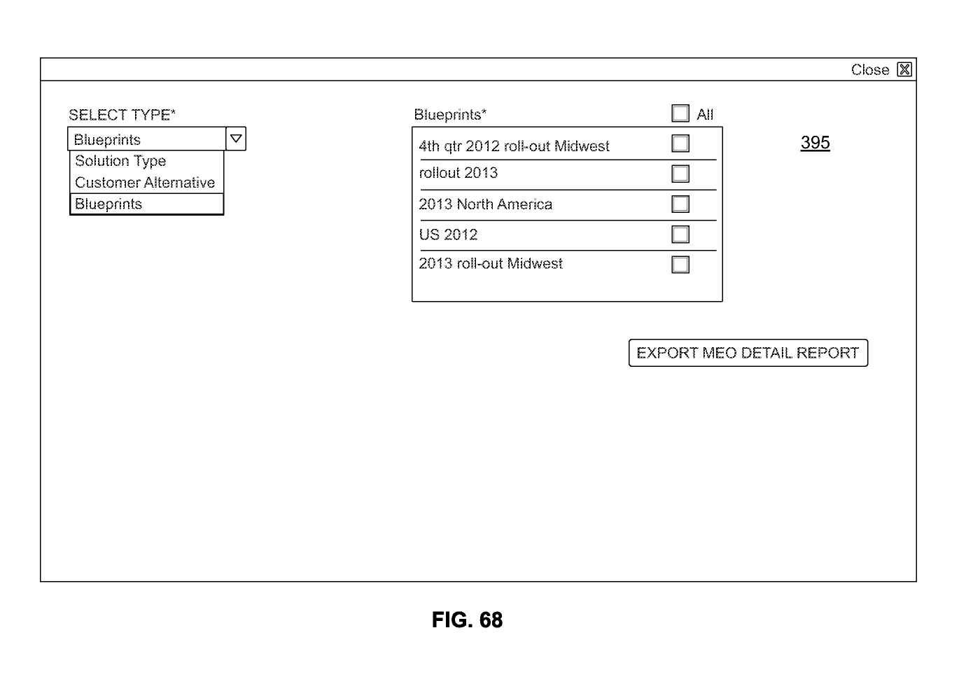

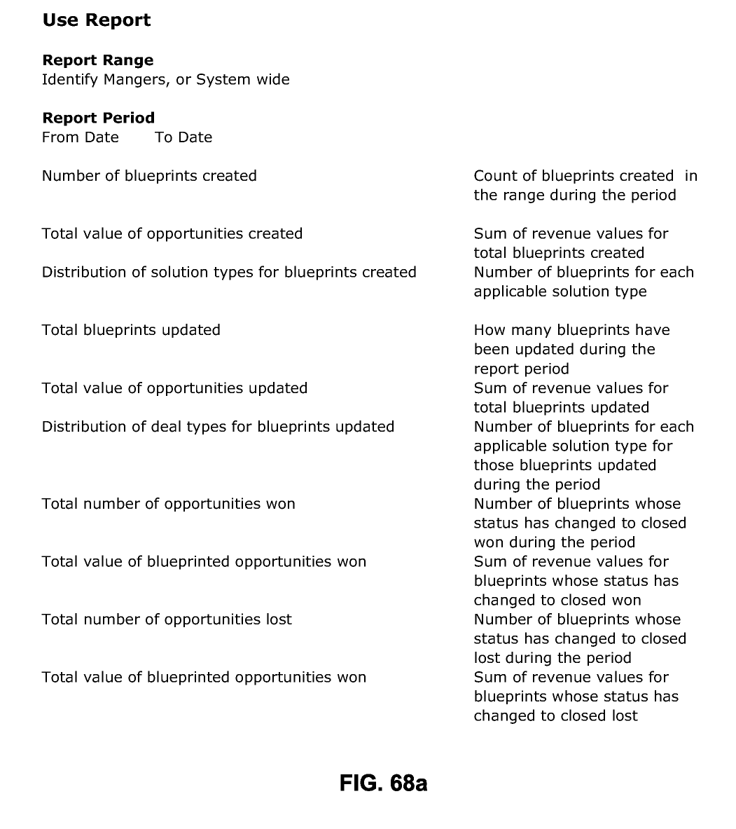

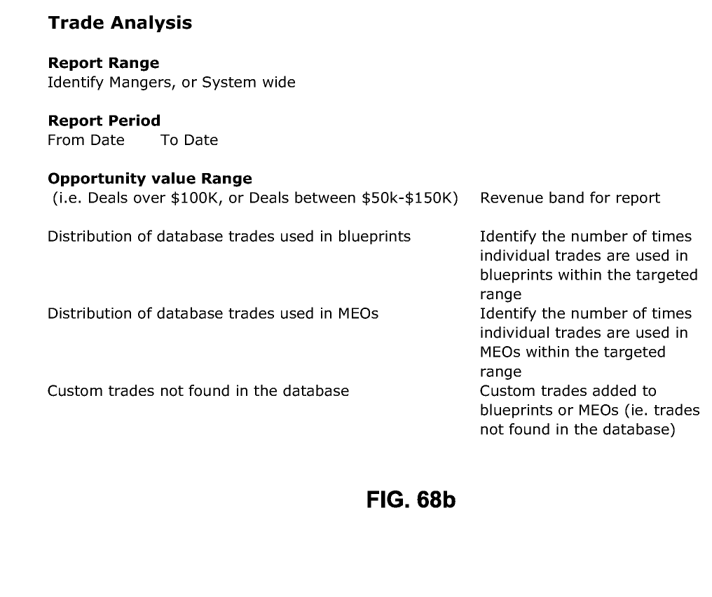

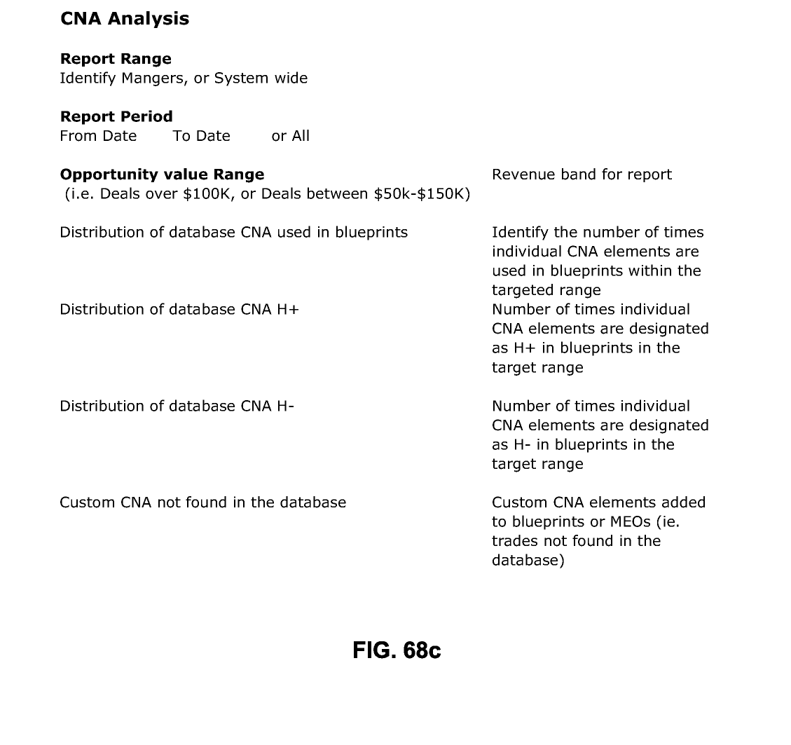

As illustrated within FIG. 65, the MEO detail report 390 sets forth a summary of the MEO information and metadata. Thus, the MEO detail report presents MEO data, and other information relating to the various opportunities. Clicking on the MEO detail report link within the export interface screen 310 of FIG. 41 thus causes the MEO detail supplemental interface screen 395 to appear. Within the MEO supplemental interface screen is a “select type” selection field that allows for the report to be directed to: a solution type; a customer alternative or blueprints. FIGS. 66, 67 and 68 thus respectively illustrate the MEO detail supplemental interface screen 395 utilizing each foregoing type. FIG. 66, illustrating the selection of “solution type” within the select type selection field, presents a “solutions type” selection field allowing for one or more given solution types (i.e., basic, premium and top partnership) to be selected to further tailor the MEO detail report 390. FIG. 67, illustrating the selection of “customer alternative” within the select type selection field, presents a “customer alternative” selection field allowing for one or more given customer alternatives (i.e., competitor 1; competitor 2; competitor 3; do nothing; build it themselves) to be selected to further tailor the MEO detail report 390. FIG. 68, illustrating the selection of “blueprints” within the select type selection field, presents a “blueprints” selection field allowing for one or more given blueprints (i.e., 4th qtr 2012 roll-out Midwest; rollout 2013; 2013 north America; US 2012; 2012 rollout Midwest) to be selected to further tailor the MEO detail report 390. Of course, the information of the solution types and customer alternatives selection fields comprise CNA their side metadata of the master account 75. Thereafter clicking on the “export MEO detail report” button within the respective supplemental interface screens causes the respective tailored MEO detail reports to be displayed.

FIG. 68a illustrates a Use Report setting forth a summary of use information relating to the Blueprint itself. Such use information includes report ranges and periods, number of Blueprints created, total value of opportunities created, as well as information relating to opportunities, won, lost and updated. FIG. 68b illustrates a Trades Analysis report setting forth a summary of trade information. Such trade information includes report ranges and periods, an opportunity value range, as well as the distribution of data base trades used in the Blueprint and in MEOs. FIG. 68c illustrates a CNA Analysis report setting forth a summary of CNA information. Such CNA information includes report ranges and periods, an opportunity value range, the distribution of data base trades used in the Blueprint and in CNA H+ and H−, as well as any custom CNA not found in the database.

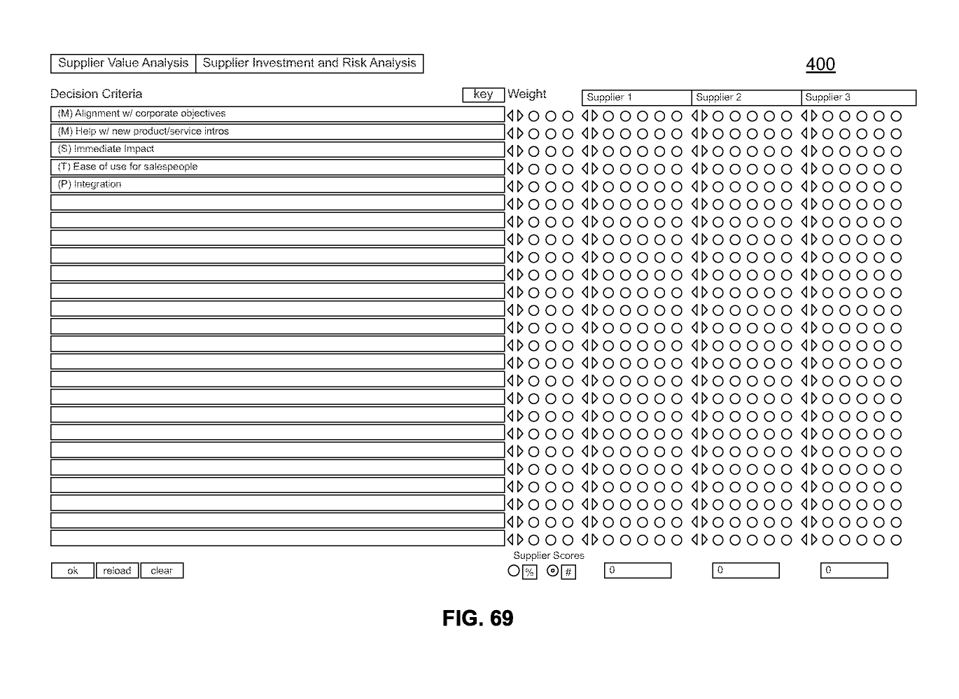

The user account 80 also provides two additional resources for assisting a sales professional in negotiating with a buyer, namely supplier value analysis and supplier investment and risk analysis. Each resource is applicable to a specific buyer blueprint buyer account. Supplier value analysis utilizes criteria information and metadata from the CNA their side analysis while the supplier investment and risk analysis utilizes trades information and metadata from the trades analysis. In another embodiment, the supplier investment and risk analysis utilizes data from the CNA our side analysis. FIG. 69 thus illustrates a screen shot of a supplier value analysis interface screen 400, accessible from within the user account 80. As illustrated within FIG. 69, the supplier value analysis interface screen presents a table listing, by line item, the various decision criteria generated by the CNA their side analysis. The user may edit the list as desired, with such edits remaining independent of the CNA their side source data. For each decision criteria line item, a “weight” column and three supplier columns are presented.

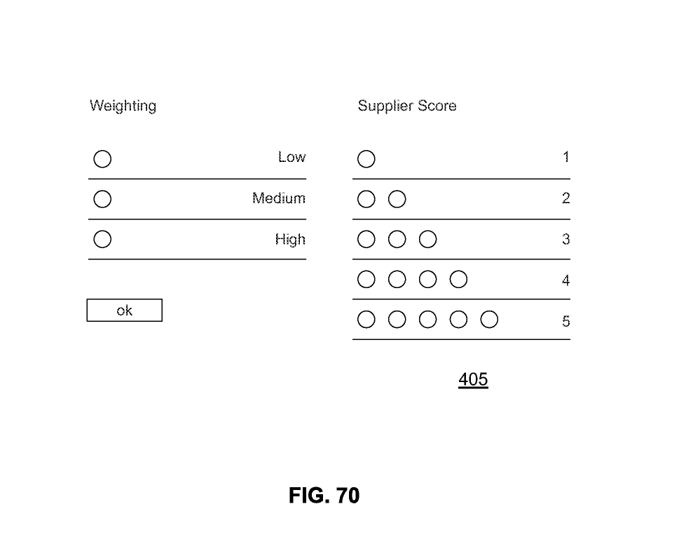

Within the weight column, the user can apply a weight (i.e., low; medium; and high) indicating the importance of each criteria line item in relation to the blueprint for the buyer. Within each of the three supplier columns, the user can apply a score (i.e., from 1 through 5; low through high) scoring how each of the respective three suppliers (i.e., the competitors of the seller competing for the underlying sales contract with the buyer) rates in relation to each criteria. In the embodiment illustrated within the supplier value analysis interface screen 400 of FIG. 69, the weights and scores are graphically represented as indicated by the “key” screen of FIG. 70. The key 400 is accessible by clicking on the key button presented within the supplier value analysis interface screen 400. As weights and scores are applied, each respective supplier's total score, totaled at the bottom of each respective column, will adjust accordingly. The user may choose to base the total scores on either percentage or absolute value by clicking on the respective selection choices located to the left of the total scores. The total scores are thus used by the user of the supplier value analysis to determine the overall strength of the competing suppliers (i.e., competing seller) competing for the buyer's sales opportunity.

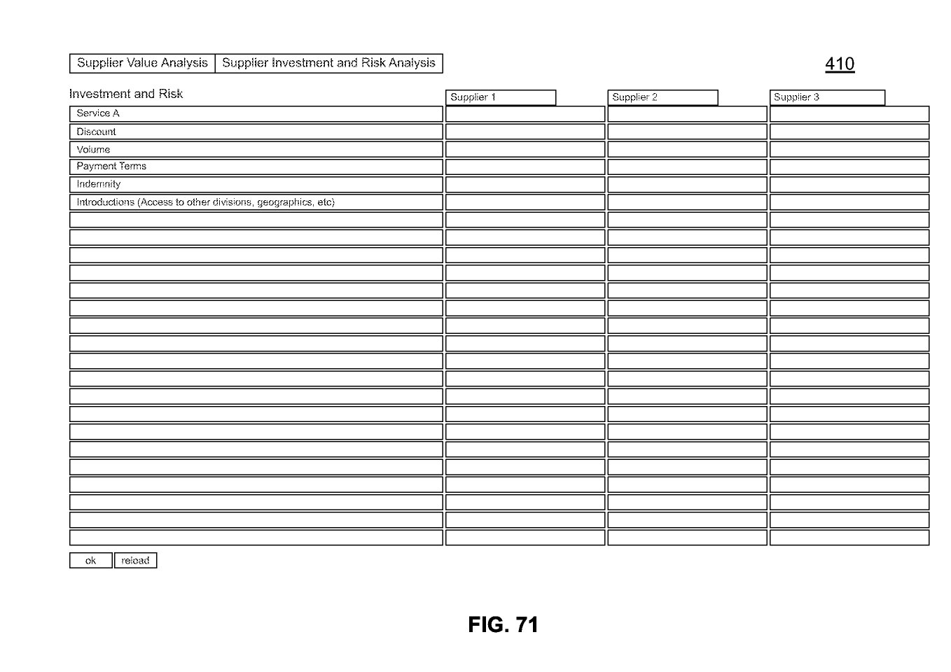

FIG. 71 thus illustrates a screen shot of a supplier investment and risk analysis interface screen 410, also accessible from within the user account 80. As illustrated within FIG. 71, the supplier investment and risk analysis interface screen presents a table listing, by line item, the various decision impacts generated by the trades analysis 20. The user may edit the list as desired, with such edits remaining independent of the trades source data. For each impact line item, three supplier columns are presented. These suppliers loaded are automatically as the same suppliers entered within the supplier value analysis interface screen 400 of FIG. 69. Within each of the three supplier columns, the user click on or enter supplier criteria in relation to each impact. The foregoing allows a user of the supplier investment and risk analysis to determine the overall investment and risk associated with the each of the competing suppliers (i.e., competing seller) competing for the buyer's sales opportunity.

While this foregoing description and accompanying figures are illustrative of the present invention, other variations in structure and method are possible without departing from the invention's spirit and scope.

We claim:

1. A computer implemented method for constructing a negotiation blueprint through a computer network, comprising the steps of:
providing computer processing means and computer readable media, the processing means coupled to a network interface;
providing access to a master account;
allowing an input of negotiation information within the master account, said information stored on the computer readable media and comprising at least CNA analysis information and trades analysis information;
compiling the information with the processing means to establish metadata providing data selection and input parameters of the negotiation blueprint for at least one user account;
providing access to the at least one user account;
allowing an input of negotiation data comprising at least further CNA analysis information, trades analysis information and multiple equal offers information within the data selection and input parameters of the at least one user account, said data stored on the computer readable media;
compiling the data and metadata with the processing means to create the negotiation blueprint; and
displaying the negotiation blueprint to the at least one user.

2. The computerized method of claim 1 wherein the CNA analysis data selection and input parameters define categories and related impacts for a seller, and stakeholders and related criteria and related customer alternatives for a buyer; the trades analysis data selection and input parameters define trades and related trade types and related solution types and related ranges; and the multiple equal offers data define at least three offers populated by the data input within the data selection and input parameters of the trades.

3. The computerized method of claim 1, the input of negotiation information within the master account further comprising notes information and the input of negotiation data within the user account further comprising notes data.

4. The computerized method of claim 2 wherein the trades analysis data selection and input parameters further define an enforcement provision.

5. The computerized method of claim 4 wherein the enforcement provision comprises executing a conditional construct by the processing means.

6. The computerized method of claim 5 wherein the conditional construct applies one of four rules.

7. The computerized method of claim 6 wherein the four rules comprise: do nothing; notify the user; email the manager; and no editing allowed.

8. A system for creating a negotiation blueprint online, comprising:
a processor,
a computer readable memory coupled to the processor;
a network interface coupled to the processor;
software stored on the computer readable memory and executed by the processor, the software having:
means for establishing an online master account;
means for receiving an input of negotiation information within the master account, said information stored on the computer readable memory and comprising at least CNA analysis information and trades analysis information;
means for compiling the information with the processor to establish metadata providing data selection and input parameters of the negotiation blueprint for at least one user account;
means for providing access to the at least one user account;
means for receiving an input of negotiation data comprising at least further CNA analysis information, trades analysis information and multiple equal offers information within the data selection and input parameters of the at least one user account, said data stored on the computer readable media;
means for compiling the data and metadata with the processor to create the negotiation blueprint; and
means for transmitting the negotiation blueprint to at least one user.

9. The system of claim 8, wherein the CNA analysis data selection and input parameters define categories and related impacts for a seller, and stakeholders and related criteria and related customer alternatives for a buyer; the trades analysis data selection and input parameters define trades and related trade types and related solution types and related ranges; and the multiple equal offers data define at least three offers populated by the data input within the data selection and input parameters of the trades.

10. The system of claim 8, the input of negotiation information within the master account further comprising notes information and the input of negotiation data within the user account further comprising notes data.

11. The system of claim 9 wherein the trades analysis data selection and input parameters further define an enforcement provision.

12. The system of claim 11 wherein the enforcement provision comprises a means for executing a conditional construct by the processor.

13. The system of claim 12 wherein the conditional construct applies one of four rules.

14. The system of claim 13 wherein the four rules comprise: do nothing; notify the user; email the manager; and no editing allowed.

15. A computer software product that includes a non-transitory computer readable storage medium readable by a processor, the medium having stored thereon a set of instructions for creating a negotiation blueprint over a computer network, the instructions comprising:
a) a first sequence of instructions which, when executed by the processor, causes the processor to establish an online master account and at least one user account;
b) a second sequence of instructions which, when executed by the processor, causes the processor to receive an input of negotiation information within the master account, said information comprising at least CNA analysis information and trades analysis information;
c) a third sequence of instructions which, when executed by the processor, causes the processor to store the negotiation information on a server accessible by the online master account and user account:
d) a fourth sequence of instructions which, when executed by the processor, causes the processor to compile the negotiation information of the master account to establish metadata providing data selection and input parameters of the negotiation blueprint for the at least one user account;
e) a fifth sequence of instructions which, when executed by the processor, causes the processor to receive an input of negotiation data within the user account comprising at least further CNA analysis information, trades analysis information and multiple equal offers information within the data selection and input parameters of the at least one user account;
f) a sixth sequence of instructions which, when executed by the processor, causes the processor to store the negotiation data on the server accessible by the online master account and online user account;
g) a seventh sequence of instructions which, when executed by the processor, causes the processor to compile the data and metadata to create the negotiation blueprint; and
h) an eighth sequence of instructions which, when executed by the processor, causes the processor to transmit the negotiation blueprint to the at least one user.

16. The computer software product of claim 15 wherein the CNA analysis data selection and input parameters define categories and related impacts for a seller, and stakeholders and related criteria and related customer alternatives for a buyer; the trades analysis data selection and input parameters define trades and related trade types and related solution types and related ranges; and the multiple equal offers data define at least three offers populated by the data input within the data selection and input parameters of the trades.

17. The computer software product of claim 15, the input of negotiation information within the master account further comprising notes information and the input of negotiation data within the user account further comprising notes data.

18. The computer software product of claim 16 wherein the trades analysis data selection and input parameters further define an enforcement provision.

19. The computer software product of claim 18 wherein the enforcement provision comprises a sequence of instructions which, when executed by the processor, causes the processor to execute a conditional construct.

20. The computer software product of claim 19 wherein the conditional construct applies one of four rules.
